(19) United States
(12) Patent Application Publication
(10) Pub. No.: US 2014/0230958 A1
(43) Pub. Date: Aug. 21, 2014

(54) CONTAINER FOR PUMPING FLUID

(71) Applicant: FUEL TRANSFER TECHNOLOGIES INC., New Brunswick (CA)

(72) Inventor: Mark Bonner, Frenchtown, NJ (US)

(73) Assignee: FUEL TRANSFER TECHNOLOGIES, INC., Moncton, NB (CA)

(21) Appl. No.: 14/351,695

(22) PCT Filed: Oct. 15, 2012
(86) PCT No.: PCT/CA2012/000986

§ 371 Date: Apr. 14, 2014

Related U.S. Application Data
(60) Provisional application No. 61/547,371, filed on Oct. 14, 2011.
(60) Provisional application No. 61/611,166, filed on Mar. 15, 2012.
(60) Provisional application No. 61/611,198, filed on Mar. 15, 2012.

(51) Int. Cl. B65B 31/00

(52) U.S. Cl. CPC B67D 7/38
USPC 141/59

(57) ABSTRACT

Systems and apparatuses for fluid delivery. A system may include a container for containing fluid and a pump for pumping fluid from the container. There may be a dispensing outlet valve for mediating fluid flow through a dispensing outlet of the container, wherein the dispensing outlet valve is configured to permit flow from the container out the dispensing outlet when the pump is being pumped, and to automatically inhibit fluid flow from the container through the dispensing outlet when the pump is not being pumped.

### TECHNICAL FIELD

The present disclosure relates to fluid containers for pumping fluids, including containers suitable for pumping liquid fuel and optionally recovering fuel vapor.

### BACKGROUND

Fluid containers, such as portable fluid containers, may be useful for transporting fluid and/or for temporary storage of fluid. Such a container may be useful, for example, to transport a fluid such as a fuel from a fuel reservoir or storage to another fuel reservoir or storage, such as a fuel tank, a larger or smaller fuel container, or some other suitable vessel.

A fluid container, which may be heavy or unwieldy, particularly when relatively full of fluid, may be difficult to handle manually. This may be a challenge when transferring fluid from the container to a destination vessel. For example, pouring fluid directly from a container, particularly when the container is heavy and/or relatively full of fluid, such as by tilting or lifting the container, may be difficult to control, which may lead to undesirable spilling of fluid. A container that is nearly empty of fluid may also be difficult to directly pour from, since the container may have to be tilted or upturned significantly in order to pour out the last bit of fluid. In either situation, transferring fluid from the container to the destination vessel may be difficult for the user and may lead to unintentional spilling of fluid, which may be wasteful and, in some examples, such as where the fluid is volatile liquid (e.g., a fuel), may create pollution or cause environmental damage.

Commercial fluid containers, such as the fuel reservoir at a fuel station, may be equipped with electrically-operated pumps for pumping fluid to the destination vessel. An electrically-operated pump may avoid the need to manipulate the container. However, such pumps may be impractical for a portable fluid container and may be too heavy and/or costly for use in a relatively small fluid container, such as those designed for the broad consumer market.

### SUMMARY

In some example aspects, the present disclosure provides a portable fluid delivery and recovery system, which may include: a container for containing fluid, the container including a dispensing outlet for dispensing fluid out of the container and a recovery inlet for recovering fluid into the container; a pump, the pump being for pumping fluid from the container for pumping recovered fluid into the container; a dispensing outlet valve for mediating fluid flow through the dispensing outlet, wherein the dispensing outlet valve is configured to permit flow from the container out the dispensing outlet when the pump is being pumped, and to automatically inhibit fluid flow from the container through the dispensing outlet when the pump is not being pumped; and a recovery inlet valve for mediating fluid flow through the recovery inlet, wherein the recovery inlet valve is configured to permit flow in to the container through the recovery inlet when the pump is being pumped, and to automatically inhibit fluid flow from the container through the recovery inlet when the pump is not being pumped.

In some examples, the pump may be at least partially within the container.

In some examples, the system, when the pump is not being pumped, may emit or permeate fuel vapors at a rate equal to or less than a regulated rate.

In some examples, where the pump is operated by movement of a piston shaft, the piston shaft defining an axis along its length, the system may include: an actuator coupled to the pump for operating the pump, the actuator, when actuated, effecting a force against the piston shaft to move the piston shaft and effect pumping of the fluid, the actuator being moveable from an unactuated position to a fully actuated position along an actuation path; wherein the actuator contacts the piston shaft during at least a portion of the actuation path of the actuator, and contact between the piston shaft and the actuator, for at least a majority of time when the actuator and the piston shaft are in contact, has a tangent that is substantially perpendicular to the axis of the piston shaft; wherein the force effected by the actuator against the piston shaft is substantially parallel to the axis of the piston shaft.

In some examples, the force effected by the actuator against the piston shaft may be substantially collinear with the axis of the piston shaft.

In some examples, at least one of the dispensing outlet valve and the recovery inlet valve may be a check valve comprising: a valve body including an upstream portion for receiving fluid and a downstream portion for delivering fluid; a plug biased against a seat in the valve body, the plug sealing the valve body against flow of fluid from the upstream portion to the downstream portion when the plug is seated in the seat; the plug including a first frontal area and a second frontal area, the first frontal area being smaller than the second frontal area; wherein, when the plug is seated in, on or against the seat, any fluid pressure in the upstream portion is exerted against the first frontal area; wherein, when the plug is unseated from the seat, any fluid pressure from the upstream portion is exerted against the second frontal area; wherein a first pressure applied to the first frontal area sufficient to unseat the plug from the seat is greater than a second pressure applied to the second frontal area sufficient to maintain the plug unseated from the seat.

In some examples, the system may include a fluid delivery and recovery dispenser in fluid communication with the dispensing outlet and the recovery inlet.

In some examples, the system may include a two-line hose providing fluid communication between the container and the dispenser.

In some examples, the system, when the pump is not being pumped, may emit or permeate fuel vapors at a rate equal to or less than a regulated rate.

In some example aspects, the present disclosure provides a portable pump for pumping fluid, which may include: a pump chamber in fluid communication with a dispensing outlet for dispensing pumped fluid; and wherein fluid flow through the dispensing outlet is mediated by a dispensing outlet valve, wherein the dispensing outlet valve is configured to permit flow from the pump chamber out the dispensing outlet when the pump is being pumped, and to automatically inhibit fluid flow from the pump chamber through the dispensing outlet when the pump is not being pumped.

In some examples, the dispensing outlet valve may be a one-way check valve configured to open when pressure in the pump chamber exceeds a cracking pressure of the dispensing outlet valve.

In some examples, the pump chamber may be further in fluid communication with a recovery inlet for recovering fluid, and fluid flow through the recovery inlet may bes mediated by a recovery inlet valve, wherein the recovery inlet valve may be configured to: permit flow into the pump chamber from the recovery inlet when the pump is being pumped; and automatically inhibit fluid flow from the pump chamber through the recovery inlet when the pump is not being pumped.

In some examples, the recovery inlet valve may be a one-way check valve configured to open due to negative pressure in the pump chamber.

In some examples, the pump may include a piston moveable in the pump chamber between a top of a stroke and a bottom of the stroke, the piston defining the pump chamber into a dispensing portion in fluid communication with the dispensing outlet and a recovery portion in fluid communication with the recovery inlet, wherein: movement of the piston from the top of the stroke to the bottom of the stroke concurrently increases the volume of the recovery portion and decreases the volume of the dispensing portion at substantially equal rates; and movement of the piston from the bottom of the stroke to the top of the stroke concurrently increases the volume of the dispensing portion and decreases the volume of the recovery portion at substantially equal rates.

In some examples, the pump may include a bypass valve for permitting fluid to flow from the dispensing portion to the recovery portion when pressure within the dispensing portion exceeds an operational pressure of the pump.

In some examples, the pump may be configured to be connectable in fluid communication with a portable fluid container, the pump further comprising a dispensing inlet for receiving fluid from the container to be pumped out the dispensing outlet.

In some examples, the pump may be configured to be at least partially contained within the container.

In some examples, the pump chamber may be further in fluid communication with a recovery inlet for recovering fluid, and fluid flow through the recovery inlet may be mediated by a recovery inlet valve, wherein the recovery inlet valve may be configured to: permit flow into the pump chamber from the recovery inlet when the pump is being pumped; and automatically inhibit fluid flow from the pump chamber through the recovery inlet when the pump is not being pumped; and the pump may be further in fluid communication with a recovery outlet for delivering fluid recovered through the recovery inlet to the container.

In some example aspects, the present disclosure provides a fluid dispensing system which may include: a container for containing fluid; any one of the pumps described above, the pump being in fluid communication with the container.

In some examples, the pump may be at least partially within the container.

In some examples, the system may include a dispenser in fluid communication with the dispensing outlet.

In some example aspects, the present disclosure provides a portable container for pumping fluid, which may include: a body for containing the fluid, the body defining a container outlet for fluid communication with at least one of a conduit and a dispenser; a pump in fluid communication with the container outlet, the pump being operational to pump fluid from the body out the container outlet; and at least one outlet valve for mediating fluid flow through the container outlet, wherein the outlet valve is configured to permit flow from the body out the container outlet when the pump is being pumped, and to automatically inhibit fluid flow from the body through the container outlet when the pump is not being pumped.

In some examples, the container, when closed, may emit or permeate vapors at a rate equal to or less than a regulated rate.

In some examples, the pump may be at least partially within the container.

In some examples, the regulated rate may be 0.5 grams/gallon/day.

In some examples, the body may have a volume of 10 gallon or less.

In some examples, the container may include at least one of the conduit and the dispenser coupled to the outlet, the at least one of the conduit and the dispenser including a closeable valve.

In some examples, the container, the conduit and the dispenser, when the respective valves of the container and the dispenser are closed, may emit or permeate vapors at a rate equal to or less than a regulated rate.

In some examples, when the body is filled with fluid, the container, the conduit and the dispenser may have a total weight equal to or less than 50 lbs.

In some examples, the body may be formed from a material that is impermeable to fuel vapors.

In some example aspects, the present disclosure provides a container for pumping fluid, which may include: a body for containing the fluid; a pump in fluid communication with the body, for at least one of pumping fluid into and pumping fluid out of the body, the pump being operated by movement of a piston shaft, the piston shaft defining an axis along its length; an actuator coupled to the pump for operating the pump, the actuator, when actuated, effecting a force against the piston shaft to move the piston shaft and effect pumping of the fluid, the actuator being moveable from an unactuated position to a fully actuated position along an actuation path; wherein the actuator contacts the piston shaft during at least a portion of the actuation path of the actuator, and contact between the piston shaft and the actuator, for at least a majority of time when the actuator and the piston shaft are in contact, has a tangent that is substantially perpendicular to the axis of the piston shaft; wherein the force effected by the actuator against the piston shaft is substantially parallel to the axis of the piston shaft.

In some examples, the force effected by the actuator against the piston shaft may be substantially collinear with the axis of the piston shaft.

In some examples, the container may be manually portable.

In some examples, the actuator may be pivotally coupled to the pump, and the actuation path may be at least partially curved.

In some examples, pivotal motion of the actuator may be translated to substantially linear motion of the piston shaft.

In some examples, the actuator may include a cam surface for contacting the piston shaft, the cam surface including a profile for maintaining the tangent of the contact between the piston shaft and the actuator substantially perpendicular to the axis of the piston shaft.

In some examples, the profile of the cam surface may be at least partially concave to receive the piston shaft.

In some examples, the cam surface may be designed to move the piston shaft at a substantially constant rate.

In some examples, the cam surface may be designed to cause the actuator to exert a slight non-axial force against the piston shaft, to counteract non-axial frictional forces.

In some examples, the actuator may include a foot pedal.

In some examples, the piston shaft may include a curved surface for contacting the actuator.

In some examples, the curved surface of the piston shaft may include a roller.

In some examples, the container may include plastic components.

In some examples, the container may be a fuel container.

In some examples, the container may include at least one opening for at least one of receiving and delivering fluid.

In some examples, at least one of the at least one opening may be connectable to a hose.

In some example aspects, the present disclosure provides a system for dispensing fluid, which may include: any one of the containers described above; and a fluid dispenser connectable to the container for receiving fluid from the container and dispensing fluid.

In some examples, the system may include a conduit for conducting fluid between the dispenser and the container, the conduit being connectable to the container and the dispenser, wherein the dispenser is connectable to the container via the conduit.

In some examples, the system may be a manually portable system.

In some examples, the system may be for dispensing a fuel.

In some example aspects, the present disclosure provides a portable fluid transfer system which may include: a container having an interior for containing fluid; a pump including an inlet and an outlet, wherein the inlet of the pump is in fluid communication with the container; an actuation mechanism for operating the pump, wherein the actuation mechanism is moveable in a reciprocating motion comprising a first direction and a second direction; and a manually operable lever having a cam surface with a concave portion, the lever being coupled to the pump in pivotal relation with respect to the actuation mechanism of the pump to enable the concave portion of the cam surface to engage the actuation mechanism of the pump during movement of the lever, to move the actuation mechanism at least the first direction of the reciprocating motion.

In some examples, the pump may be mounted on the container.

In some examples, the pump may include the actuation mechanism.

In some examples, the actuation mechanism may be biased towards the second direction of the reciprocating motion.

In some example aspects, the present disclosure provides a pumping system for use with a container, the pumping system may include: a pump including an inlet for receiving fluid from the container and an outlet; an actuation mechanism for operating the pump, wherein the actuation mechanism is moveable in a reciprocating motion comprising a first direction and a second direction; and a manually operable lever having a cam surface with a concave portion, the lever being coupled to the pump in pivotal relation with respect to the actuation mechanism of the pump to enable the concave portion of the cam surface to engage the actuation mechanism of the pump during movement of the lever, to move the actuation mechanism in at least the first direction of the reciprocating motion.

In some examples, the pump may be mountable on the container, wherein the inlet of the pump may be in fluid communication with the container when the pump is mounted on the container.

In some examples, the pump may include the actuation mechanism.

In some examples, the actuation mechanism may be biased towards the second direction of the reciprocating motion.

In some example aspects, the present disclosure provides a manually operable lever for engaging the actuation mechanism of a pump in a pumping system, the manually operable lever may include: a main body including a cam surface with a concave portion; wherein the main body is mountable in pivotal relation with respect to the actuation mechanism of the pump to enable the concave portion of the cam surface to engage the actuation mechanism of the pump during movement of the lever, to move the actuation mechanism in at least one direction of reciprocating motion.

In some example aspects, the present disclosure provides an apparatus for driving a reciprocating mechanism, the apparatus may include: a body; an actuation member having a mechanism engaging end and a cam receiving end, and mounted in reciprocating relation on the body for movement along a line of action between an out initial position and a continuum of actuation in positions; a lever member mounted on the body for movement between a rest position and a full actuation position; a cam surface on the lever member; wherein, in use, the cam surface engages the cam receiving end of the actuation member during movement of the lever member between the rest position and the full actuation position at a point of contact between the cam receiving end of the actuation member.

In some examples, the cam surface may include a curved portion.

In some examples, the curved portion of the cam surface may be shaped to include a profile for maintaining the point of contact of the cam receiving end of the actuation member on the cam surface aligned with the line of action of the actuation member.

In some examples, a line that is tangential to the surface of the cam surface at the point of contact between the surface of the cam surface and the axis of the actuation member may be substantially perpendicular to the axis of the actuation member throughout the motion of the actuation member as the actuation member is actuated between the rest position and the full actuation position

In some examples, throughout the motion of the actuation member between the rest position and the full actuation position, the line of action of the actuation member may be substantially linear and a line that is tangential to the profile of the curved portion of the cam surface remains substantially perpendicular to the line of action of the actuation member at the point of contact between the cam receiving end of the actuation member.

In some examples, the curved portion of the cam surface may include a concavely curved portion for receiving the cam receiving end of the actuation member.

In some examples, the lever member may be pivotally mounted on the body for pivotal movement about a lever member axis.

In some examples, the lever member axis may be mounted in offset relation with respect to the line of action of the actuation member.

In some examples, the angle of a line extending between the lever member axis and the point of contact of the cam receiving end of the actuation member, and the line of action of the actuation member, may be acute.

In some examples, the apparatus may include a roller mounted on the cam receiving end of the actuation member for rotation about a first roller pivot axis oriented substantially transversely to the line of action of the actuation member.

In some examples, the roller may be also mounted on the cam receiving end of the actuation member for rotation about a second roller pivot axis oriented substantially transversely to the first roller pivot axis and substantially collinearly with the line of action of the actuation member.

In some examples, the lever member may include a foot pedal.

In some examples, the reciprocating mechanism may include a pump.

In some examples, the body may be part of a fluid container.

In some examples, in use, the line of action of the actuation member may be substantially horizontal and the lever member axis is displaced vertically above the line of action of the actuation member.

In some example aspects, the present disclosure provides a check valve for a fluid pump which may include: a valve body including an upstream portion for receiving fluid and a downstream portion for delivering fluid; a plug biased against a seat in the valve body, the plug sealing the valve body against flow of fluid from the upstream portion to the downstream portion when the plug is seated in the seat; the plug including a first frontal area and a second frontal area, the first frontal area being smaller than the second frontal area; wherein, when the plug is seated in, on or against the seat, any fluid pressure in the upstream portion is exerted against the first frontal area; wherein, when the plug is unseated from the seat, any fluid pressure from the upstream portion is exerted against the second frontal area; wherein a first pressure applied to the first frontal area sufficient to unseat the plug from the seat is greater than a second pressure applied to-the second frontal area sufficient to maintain the plug unseated from the seat.

In some examples, the check valve may include a first seal about the first frontal area for sealing the plug against the seat when the plug is seated against the seat.

In some examples, the first frontal area may be 50% or smaller of the second frontal area.

In some examples, the first pressure may be twice of or greater than the second pressure.

In some examples, the first pressure may be in the range of about 7 to 13 pounds per square inch.

In some examples, the first pressure may be at least 13 pounds per square inch.

In some examples, the check valve may include a plug receiving portion defined in the valve body, wherein a volume is defined by the plug and at least one wall of the plug receiving portion, and wherein when the plug is received in the plug receiving portion a negative fluid pressure is created relative to the fluid pressure from the upstream portion, the negative fluid pressure acting against biasing of the plug towards the seat.

In some examples, at least one orifice may be defined in a wall of the plug receiving portion, the orifice being sealed against inflow of fluid into the plug receiving portion by a one-way valve, wherein when the plug is received in the plug receiving portion, fluid is ejected from the orifice and the one-way valve.

In some examples, the plug may include a bleed opening allowing fluid flow from the upstream portion into the plug receiving portion.

In some examples, the plug may include a second seal for sealing the plug with the at least one wall of the plug receiving portion to define the volume.

In some examples, the plug may be biased by a plug biasing member.

In some examples, the plug biasing member may be a coil spring.

In some examples, the upstream portion of the check valve may be attachable to a fluid outlet of a fluid pump.

In some examples, the downstream portion of the check valve may be attachable to a fluid dispenser or a fluid hose.

In some examples, the valve body may include at least two matable portions.

In some example aspects, the present disclosure provides a fluid pump which may include: a pump chamber including a fluid inlet for receiving fluid and a fluid outlet for pumping out fluid; any one of the check valves described above in fluid communication with the pump chamber, wherein pumping of fluid from the fluid pump is inhibited when the check valve is in a closed configuration defined when the plug of the check valve is seated in the seat of the check valve.

In some examples, the check valve may be integral to the fluid pump.

In some examples, the check valve may be removably attachable to the fluid pump.

In some example aspects, the present disclosure provides a check valve for a fluid pump which may include: a valve body including an upstream portion for receiving fluid and a downstream portion for conveying fluid; a plug biased against a seat in the valve body, the plug sealing the valve body against flow of fluid from the upstream portion to the downstream portion when the plug is seated in the seat; the plug including a first frontal area and a second frontal area, the first frontal area being smaller than the second frontal area; wherein, when the plug is seated in, on or against the seat, any fluid pressure in the upstream portion is exerted against the first frontal area; wherein, when the plug is unseated from the seat, any fluid pressure from the upstream portion is exerted against the second frontal area; wherein a first pressure applied to the first frontal area sufficient to unseat the plug from the seat is greater than the pressure required on the second frontal area to maintain the plug unseated from the seat.

The check valve of claim 93 further comprising a plug receiving portion defined in the valve body, wherein a volume is defined by the plug and at least one wall of the plug receiving portion, and wherein when the plug is received in the plug receiving portion a negative fluid pressure is created, the negative fluid pressure acting against biasing of the plug towards the seat.

In some examples, the plug may include a bleed opening allowing fluid flow into the plug receiving portion.

In some example aspects, the present disclosure provides a fluid dispenser for dispensing fluid and recovering fluid, the dispenser may include: a fluid delivery passage for delivering fluid to be dispensed via the dispenser; a fluid recovery passage for recovering fluid recovered via the dispenser; and a piston housed in the fluid recovery passage, the piston including a plurality of ribs on an exterior surface of the piston, the plurality of ribs cooperating with an interior wall of the fluid recovery passage to define a plurality of fluid channels about the piston and along a path traveled by recovered fluid in the fluid recovery passage; wherein each fluid channel is dimensioned with a gap to length ratio sized to inhibit propagation of a flame along the fluid channel.

In some examples, the dispenser may include an actuator coupled via a linkage to operate a valve in the fluid delivery passage, the valve being operable to permit or inhibit dispensing of fluid, wherein the piston is moveable in the fluid recovery passage between an initial position in which the linkage is configured to enable operation of the valve by the actuator and a deactivation position in which the linkage is configured to disable operation of the valve by the actuator.

In some examples, the piston may be moved to the deactivation position in response to a change in a fluid condition of the fluid recovery passage.

In some examples, the fluid condition may be a pressure wave caused by presence of flame in the fluid recovery passage.

In some examples, the piston may include a first magnetic member, and when the piston is in the deactivation position, the first magnetic member may repel a second magnetic member of the linkage to cause the linkage to move to a configuration to disable operation of the valve by the actuator.

In some examples, a flame arrester receiving portion may be defined in the fluid recovery passage for receiving a flame arrester along the path traveled by recovered fluid in the fluid recovery passage.

### BRIEF DESCRIPTION OF THE DRAWINGS

Reference is made to the drawings, which show by way of example embodiments of the present disclosure, and in which:

FIG. 1 is a schematic of an example system for pumping fluid to a destination vessel;

FIG. 2 is an isometric view of an example container for pumping fluid;

FIG. 3 is a side sectional view of the container of FIG. 2;

FIG. 4 is a detailed sectional view of an example actuator of the container of FIG. 2, in which the actuator is in an unactuated position;

FIG. 5 is a detailed sectional view of the example actuator of the container of FIG. 2, in which the actuator is in an actuated position;

FIG. 6A is a schematic showing operation of a conventional cam actuator and piston shaft or actuation mechanism;

FIG. 6B is a schematic showing operation of an example actuator and piston shaft suitable for the container of FIG. 2;

FIGS. 7A and 7B are charts illustrating example axial and non-axial displacement for a piston shaft of the container of FIG. 2;

FIG. 8 is an isometric view of an example fluid pump;

FIG. 9 is a cross-sectional view of the fluid pump of FIG. 8 in which an example check valve is closed;

FIG. 10 is a cross-sectional view of the fluid pump of FIG. 9 in which the check valve is opened;

FIG. 11 is a partial cross-sectional view of the fluid pump of FIG. 9 in which the check valve is closed;

FIG. 12 is a partial cross-sectional view of the fluid pump of FIG. 9 in which the check valve is opened;

FIG. 13 is an isometric view of an example plug suitable for the check valve of the fluid pump of FIG. 8;

FIG. 14 is a cross-sectional view of the plug of FIG. 13;

FIG. 15 is a cross-sectional view of another example check valve for a fluid pump, in which the check valve is closed;

FIG. 16 is a cross-sectional view of the check valve of FIG. 15, in which the check valve is opened;

FIG. 17 is an isometric exploded view of the check valve of FIG. 15;

FIG. 18 is a cross-sectional view of another example check valve for a fluid pump, in which the check valve is closed;

FIG. 19 is a cross-sectional view of the check valve of FIG. 18, in which the check valve is opened;

FIG. 20 is an isometric exploded view of the check valve of FIG. 18;

FIG. 21 is a cross-sectional view of the check valve of FIG. 9, with a second seal in an alternate position, when the check valve is closed;

FIG. 22 is a cross-sectional view of the check valve of FIG. 21, when the check valve is opened;

FIGS. 23-24 are cross-sectional views of another example fluid pump;

FIGS. 25-29 are cross-sectional views of an example dispenser;

FIGS. 30-37 illustrate another example dispenser; and

FIGS. 38-44 illustrate an example dispenser and example deactivation piston having a flame arresting feature.

Throughout the appended drawings, like features are identified by like reference numerals.

### DETAILED DESCRIPTION

The present disclosure provides systems for dispensing a fluid, such as fuel. In some examples, the system may be a portable dispensing system that may be used to refuel equipment (e.g., gasoline-powered off-road equipment). The example system may be used in place of conventional portable fluid containers (e.g., portable fuel containers).

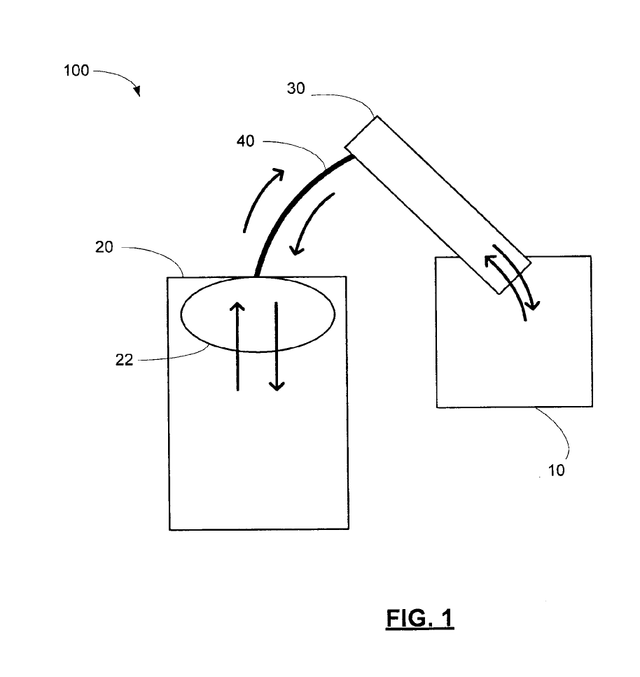

FIG. 1 shows an example system 100 for pumping fluid to a destination vessel 10. The example system 100 includes a fluid source 20 and a fluid dispenser 30 (e.g., a nozzle or a spout). Fluid delivered to vessel 10 may, for example, include a fuel, and fluid source 20 may be a fuel storage tank. In such examples, a source 20 may include a portable fuel container, such as a portable gas can, a fuel tank of a fuel-powered device, such as the fuel tank of a gas-powered lawn mower or boat, a fuel reservoir, or any other fuel storage enclosure. In such examples, the fluid may be a liquid or a gas or a mixture thereof (e.g., a liquid fuel having fuel vapors).

A fluid source 20 may include one or more pumps 22 (one is shown in FIG. 1) for pumping fluid from the source 20 and/or to recover fluid from the destination vessel 10 back into the source 20. As illustrated by the arrows in FIG. 1, fluid may be pumped by the pump(s) 22 from the source 20 through the dispenser 30 to the vessel 10. Alternatively or additionally, excess fluid from the vessel 10 may also be pumped by pump(s) 22 from the vessel 10 through the dispenser 30 back to the source 20. In some examples, pump(s) 22 may be integral to or part of the fluid source 20. In some examples, a system 100 may include separate pumps 22 for delivering fluid and recovering fluid, respectively. In some examples, a system 100 may include one or more pumps 22 that may each simultaneously and/or selectively serve to deliver and recover fluid. The pump(s) 22 and/or dispenser 30 may be any suitable configuration including, for example, the pumps and dispensers described in U.S. Pat. Nos. 8,201,587 and 8,201,588, the entireties of which are hereby incorporated by reference, for example the pump(s) 22 may be a rotary pump, an electric pump or any other suitable pumping device.

To facilitate delivery of fluid from and/or return of excess fluid to a fluid source 20, a dispenser 30 may be in fluid communication with the fluid source 20, for example via one or more conduits, such as one or more hoses 40. In some examples where a system 100 includes two or more pumps 22, a conduit, such as hose 40, may include two or more passages independently coupled to a respective pump. Alternatively, such as where a system 100 includes a pump 22 that may serve to both deliver and recover fluid, the passages may be integrated into a single conduit structure, for example in a co-axial or concentric configuration. The hose 40 may serve to communicate fluid from the source 20 to the dispenser 30, and optionally communicate any recovered fluid from the dispenser 30 to the source (e.g., where the dispenser 30 has fluid recovery capabilities).

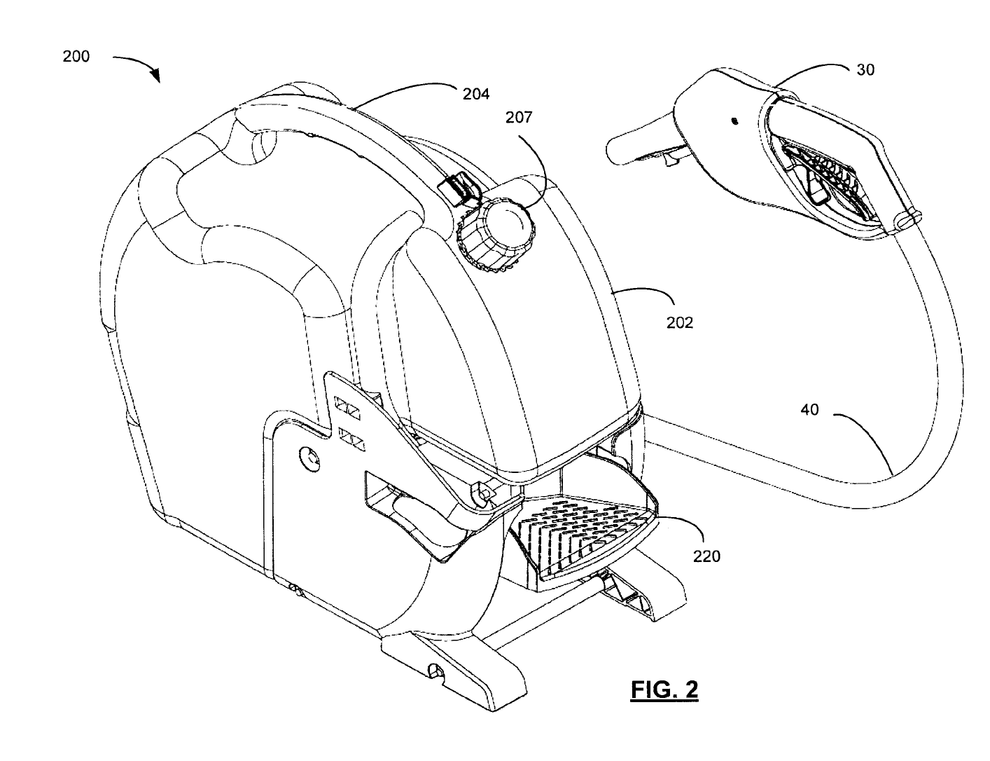

In the present disclosure, a fluid source 20 may be a fluid container, which may be in the nature of a fluid container 200, which may be portable, for example as shown in FIGS. 2-5. The container 200 in this example may be sized to enable portability, for example sized to house no more than about 10 gallons of fluid, or about 20 L nominal capacity. In the example shown, the container 200, 20 may include a pump 22, which may be a manually-operated pump 210 (e.g., physically operated by a user, such as by hand or by foot), or may be a self-operated pump (e.g., automated by an electric motor). Although in this example the container 200, 20 is shown as having one pump 210, 22, it should be understood that in other examples, the container 200, 20 may have more than one pump 210, 22, which may be operable simultaneously and/or selectively, for example with a single manual actuation.

The container 200, 20 may include a body 202 for containing a fluid. The body 202 may include one or more handles 204, one or more openings 206 for receiving and/or delivering fluid, one or more wheels (not shown), and/or any other suitable feature. The opening(s) 206 may include an opening 206a (shown sealed by a container cap 207) for receiving fluid, for example for filling the container 200 from another fluid source, such as a gas pump or larger gas can. Such opening(s) 206 may be closeable, for example with a cap 207 or lid. Such opening(s) 206 may also be connectable to a conduit, such as a hose 40. The cap 207 may be a non-venting cap and may include one or more safety features, such as a child-proof lock. Because the cap 207 is non-venting, the container 200, when not in use (and when valves, described below, are closed), may be a closed and/or sealed system that contains both liquid and any vapor (e.g., fuel vapors) from the liquid. The container 200 may be thus able to maintain an internal pressure (e.g., due to evaporation of liquid within the container 200 and/or diurnal temperature effects). The opening(s) 206 may also include an outlet opening 206b on the pump 210, 22, which may be connectable to a hose 40 for delivering fluid. The hose 40, in turn may be connectable to a fluid dispenser 30, for example a nozzle or a spout.

The container 200, 20 may be sealed to prevent or inhibit fluid loss when not in use. For example, an opening 206a for receiving fluid may be provided with a non-venting cap 207. One or more openings 206b connectable to a hose (e.g., two such openings 206b where separate hoses are used for fluid delivery and fluid recovery, or one such opening 206b where the hose is a two-line or coaxial hose) may be sealed by connection to a hose 40 and/or the opening(s) 206b may be automatically closed when not in use, for example by valve(s) that are biased in the closed position. Such valve(s) may be provided by a pump 210, 22 within the container 200, 20, for example as described below.

The container 200, 20 may include one or more manually-operated pumps 210, 22. One or more of the manually-operated pump(s) 210, 22 may be operable to deliver fluid from the container 200, 20 to the destination vessel 10, to recover fluid from the destination vessel 10 to the container 200, 20, or both. In some examples, one or more of the manually-operated pump(s) 210, 22 may be operable to simultaneously deliver and recover fluid (e.g., recover vapor and/or excess or overflow fluid). In the example shown, the container 200, 20 may include a single manually-operated pump 210, 22, which may be operable to concurrently deliver and recover fluid.

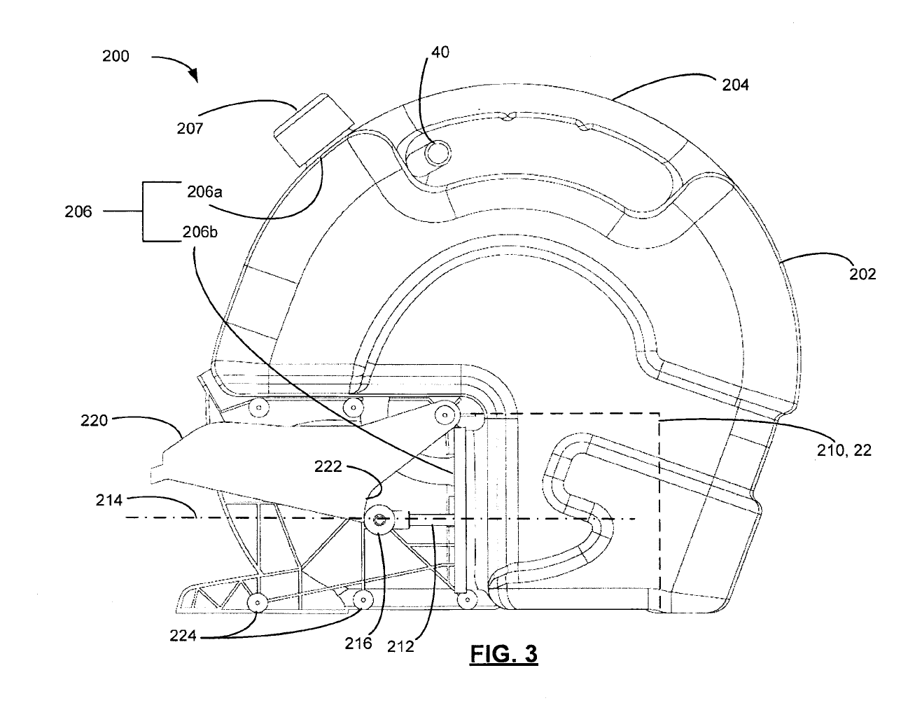

In some examples, a pump 210, 22 may be a reciprocating pump. For example, the pump 210, 22 may operate through movement of at least one piston. In this example, the pump 210, 22 may include one piston operated by shaft 212 or other suitable actuation mechanism (or actuation member). A piston axis 214 may be defined along the length of the piston shaft 212 (e.g., as shown in FIGS. 3-5) and may be substantially parallel to a surface on which a container 200, 20 rests (e.g., when the piston shaft 212 is oriented substantially parallel to the surface on which the container 200, 20 rests). The piston may move within a pump chamber (not shown) of the pump 210, 22. Movement of the piston shaft 212 may include an outflow stroke, wherein the piston shaft 212-moves the piston in a first direction of a reciprocating motion within the pump chamber to enable the pump 210, 22 to expel fluid from the pump chamber. Movement of the piston shaft 212 may also include an intake stroke, wherein the piston shaft 212 moves the piston in a second direction of reciprocating motion (e.g., at least partly opposite to the outflow stroke) within the pump chamber to enable the pump 210, 22 to intake fluid into the pump chamber. In some examples, the intake stroke and the outflow stroke of the piston shaft 212 may be along substantially the same path, such as along the axis 214 of the piston shaft 212.

In some examples, a piston shaft 212 may be biased to the second direction of reciprocating motion where the piston shaft 212 is retracted or extended from the pump chamber such that application of an external force, for example a manual force, to the piston shaft 212 causes the piston shaft 212 to move along its outflow stroke, which may facilitate pumping of fluid from the pump 210, 22; and release of the force may allow the piston shaft 212 to move along its intake stroke, which may facilitate intake of fluid into the pump 210, 22. In some examples, a piston shaft 212 may not be biased, and an external force, such as a manual force, may be required to move the piston 212 along its intake stroke as well as its outflow stroke.

The container 200, 20 may also include at least one actuator 220 (e.g., a manually-operated lever or lever member) for operating the pump 210, 22. In the example shown, the container 200, 20 may include one actuator 220, although in other examples there may be more than one actuator 220; for example, where there are two or more pumps 210, 22 there may be a respective actuator 220 for each pump. The actuator 220 may be operatively mounted or coupled, directly or indirectly, to the body 202 of the container 200, 20 or the pump 210, 22. For example, an actuator 220 may be pivotally coupled to the body 202 or pivotally coupled to the pump 210, 22. The actuator 220 may be configured for manual operation, for example an actuator 220 may be configured to be operated by a foot or a hand of a user. For example, an actuator 220 may be configured to receive a foot of a user when the container 200, 20 is placed on a surface.

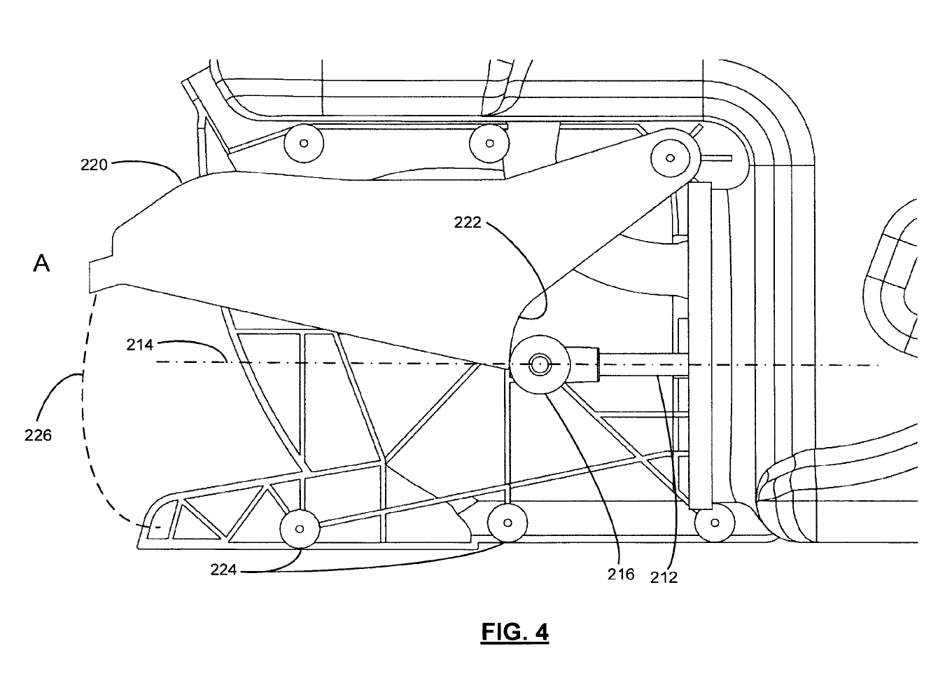

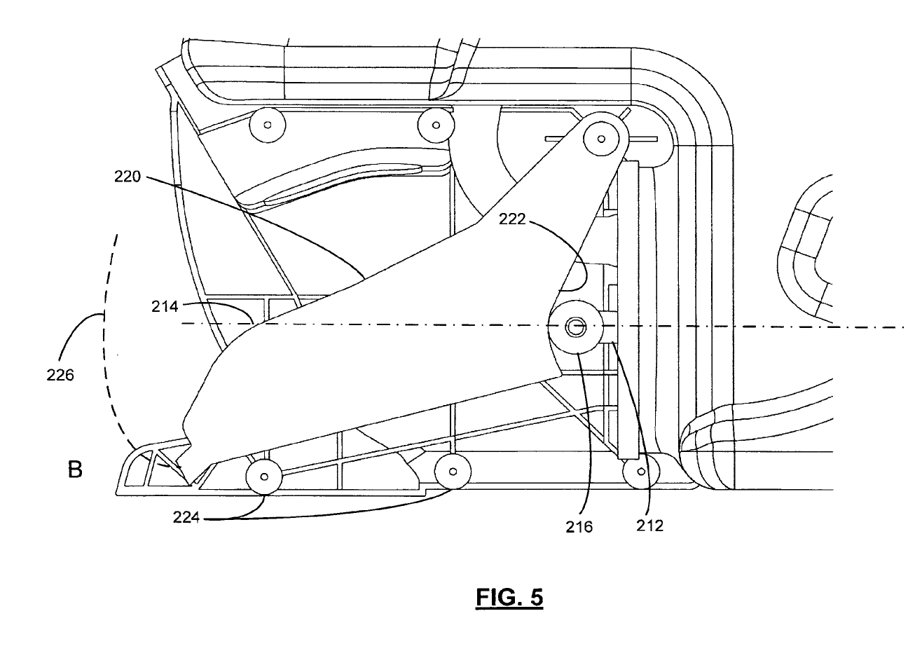

Actuation of the actuator 220, for example by a foot pressing against the actuator, may move the actuator 220 from an unactuated position A, as shown in FIG. 4, to a fully actuated position B, as shown in FIG. 5. The unactuated position A may be defined as the resting position of the actuator 220, for example an actuator 220 may be biased towards its unactuated position A. In some examples, an actuator 220 may be biased towards its fully actuated position B or an intermediate position, or an actuator 220 may not be biased towards either position. In any of these cases, manual operation of an actuator 220 may move the actuator 220 between its unactuated position A and its fully actuated position B, or any intermediate position, as suitable.

The fully actuated position B may be defined as the furthest extent to which an actuator 220 may be moved (e.g., manually) from its unactuated position A. Movement of an actuator 220 from its unactuated position A to its fully actuated position B may define an actuation path 226 of the actuator 220. In some examples, movement of an actuator 220 from its fully actuated position B to its unactuated position A may be along the same actuation path 226, although in some examples a different path may be traveled. In some examples, a container 200, 20 may include a feature, such as one or more stoppers 224, that may limit the extent(s) to which an actuator 220 may be moved. Additionally or alternatively, when the container 200, 20 is placed on a surface, motion of an actuator 220 may be limited by the actuator 220 coming into contact with the surface. Although the actuation path 226 is shown as an arc, it should be understood that in other examples the actuation path 226 may include curves of varying radii or other non-arcuate paths, for example.

An actuator 220 may directly or indirectly engage, or otherwise be directly or indirectly coupled to a piston shaft 212. Actuation of an actuator 220 may cause the actuator 220 to exert a force against the piston shaft 212 to move the piston shaft 212 and effect pumping of fluid by the pump 210, 22. For example, an actuator 220 may be in contact with the piston shaft 212 for at least a portion of the actuation path 226. In some examples, the actuator 220 may be in direct contact with the piston shaft 212, while in other examples, the actuator 220 may be in indirect contact (e.g., via one or more linking members) with the piston shaft 212.

The actuator 220 may exert a force against the piston shaft 212 along at least a portion of the actuation path 226, for example at least the portion of the actuation path 226 along which the actuator 220 is in contact with the piston shaft 212. In the example shown, when the actuator 220 is in the unactuated position A, the piston shaft 212 may experience little or no force exerted by the actuator 220. In some examples, the piston shaft 212 may be at least slightly biased against the actuator 220, even when the actuator is in the unactuated position A. When the actuator 220 is moved towards the fully actuated position B, the piston shaft 212 may be pressed by the actuator 220 such that the piston shaft 212 moves along its outflow stroke. When the actuator 220 is moved back towards the unactuated position A, the force against the piston shaft 212 may be reduced, which may, in examples where the piston shaft 212 is biased to retract from the pump 210, allow the piston shaft 212 to move along its intake stroke. In other examples, such as where the piston shaft 212 is not biased to retract from the pump 210, movement of the actuator 220 back to the unactuated position A may effect a force on the piston shaft 212 to cause the piston shaft 212 to move along its intake stroke.

Although in FIGS. 4 and 5, an actuator 220 is shown as moving from its unactuated position A to its fully actuation position B along the full length of its actuation path 226, it should be understood that an actuator 220 may also effect operation of the pump 210, 22 by moving along only a portion of the actuation path 226. For example, an actuator 220 may move between its unactuated position A and an intermediate position, between an intermediate position and its fully actuated position B, or between two intermediate positions, while still effecting at least partial operation of the pump 210, 22.

The piston shaft 212 may include a surface feature, for example a curved surface, such as a roller 216, for contacting the actuator 220. Any other surface feature, such as a point or other narrowing of a piston shaft 212, may also be used to contact an actuator 220. In the example shown, the piston shaft 212 includes a roller 216 as an example curved surface. A curved surface, such as a roller 216, may help to reduce friction between a piston shaft 212 and an actuator 220, which may eliminate, reduce or avoid any non-axial force (or lateral forces) applied or imposed by the actuation of an actuator 220 to a piston shaft 212. In the present disclosure, “non-axial” may refer to any direction that is not substantially parallel to, in particular any direction that is not substantially collinear with, the axis 214 of the piston shaft 212. Similarly, “axial” may refer to any direction that is substantially parallel to or substantially collinear with the axis 214 of the piston shaft 212. It should be understood that a direction that is substantially parallel to the axis 214 need not be strictly parallel, and similarly a direction that is substantially collinear with the axis need not be strictly collinear, only that deviation from strictly parallel or strictly collinear would be negligible or acceptable.

A curved surface may help to ensure that contact between an actuator 220 and a piston shaft 212 is substantially a point contact. Although a roller 216 is shown, in other examples a curved surface may include a cylindrical wheel, a roller-ball or any other suitable feature including a curved surface, which may be integral to a piston shaft 212 or may be a separate component. Where a piston shaft 212 includes a roller 216, the roller 216 may be rotatable (e.g., about an axis that is perpendicular to the axis 214 of the piston shaft 212 and that is parallel to a surface on which a container 200, 20 rests), which may help to avoid any skew in contact between the roller 216 and an actuator 220. In some examples, contact between a piston shaft 212 and an actuator 220 may be sufficiently low in friction (e.g., the contact area may be relatively small) such that a curved surface is not used.

Contact between an actuator 220 and a piston shaft 212, for at least a majority of the contact time, may have a tangent that is substantially perpendicular to the axis 214 of the piston shaft 212. This may help to ensure that the force exerted by the actuator 220 upon the piston shaft 212 is substantially parallel to or substantially collinear with the axis 214 of the piston shaft 212.

Although the present examples show an actuation path 226 of an actuator 220 as being in a plane (which may include the axis 214) perpendicular to a surface on which a container 200, 20 rests, it should be understood that any orientation of the actuation path 226 and/or the piston shaft 212 may be suitable, provided that contact between the actuator 220 and the piston shaft 212 maintains a tangent that is substantially perpendicular to the axis 214 of the piston shaft 212. For example, the actuation path 226 may be in a skewed plane with respect to the container 200, 20 or the actuation path 226 may not fall strictly within a plane.

Where the force exerted by an actuator 220 upon a piston shaft 212 is substantially parallel to or substantially collinear with the axis 214 of the piston shaft 212, manual operation of the actuator 220 may be relatively efficiently translated into operation of the pump 210, 22. This may help to avoid or reduce the application of any non-axial forces upon the piston shaft 212, which may otherwise decrease the useful life of the pump 210, 22 by causing fatigue, wear and/or damage to the components, for example over repeated pumping cycles. This may also allow the pump components to be made of less robust material, which may be less costly, easier to manufacture and/or lighter, since it may not be necessary for the pump components to be designed to withstand substantial non-axial forces.

In this example, an actuator 220 may include a cam surface 222 for contacting a piston shaft 212. A suitable cam surface 222 may include a profile designed to help ensure that contact between a piston shaft 212 and the cam surface 222 is substantially perpendicular to the axis 214 of the piston shaft 212 for at least a majority of the contact time. For example, at least a portion of the profile of the cam surface 222 may be generally concave towards the piston shaft 212.

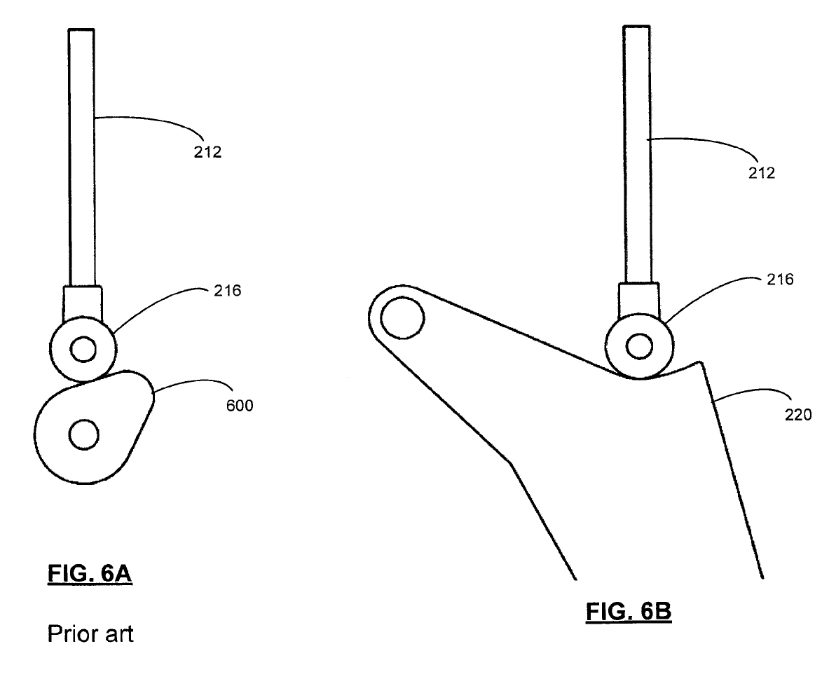

FIGS. 6A and 6B show illustrations comparing operation of an example actuator 220 and piston shaft 212 of the present disclosure (FIG. 6B) and operation of a conventional cam actuator 600 and a piston shaft 212 (FIG. 6A). To assist in understanding, the axis 214 of the piston shaft 212 has been illustrated vertically. As illustrated in FIG. 6A, in a conventional cam actuator 600, the cam surface has a profile that is substantially concave for receiving the piston shaft 212, with the result that as the cam actuator 600 rotates, non-axial forces are exerted upon the piston shaft 212. As illustrated in FIG. 6B, an example actuator 220 and piston shaft 212 of the present disclosure, may provide an unconventional cam, which may be referred to as an inverse-cam design, where a cam surface 222 of the actuator 220 may be configured such that the cam surface has a profile that is substantially concave towards the piston shaft 212, for receiving the piston shaft 212, and contact between the actuator 220 and the piston shaft 212 may be maintained with a tangent substantially perpendicular to the axis 214. The effect may be referred to as a “self-centering” of the piston shaft 212 against the cam surface 222. This may reduce or eliminate non-axial forces exerted against or imposed on the piston shaft 212.

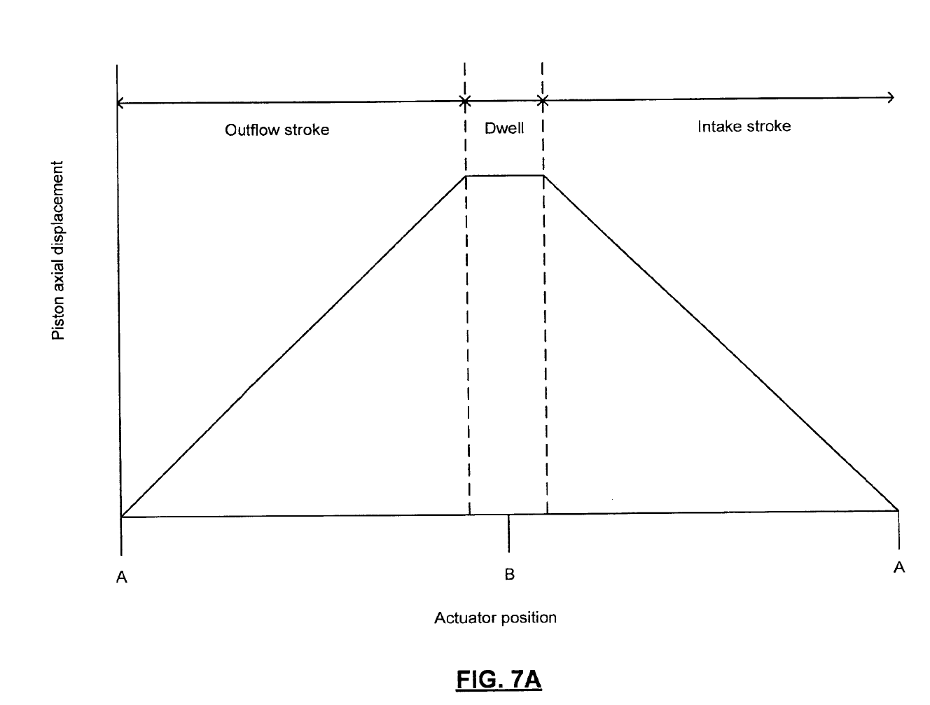

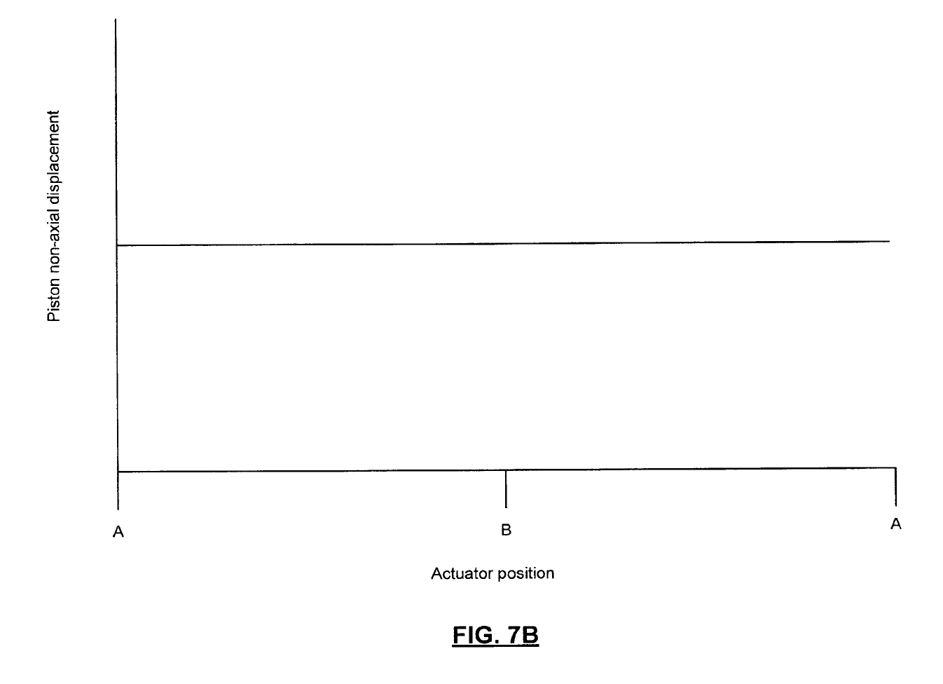

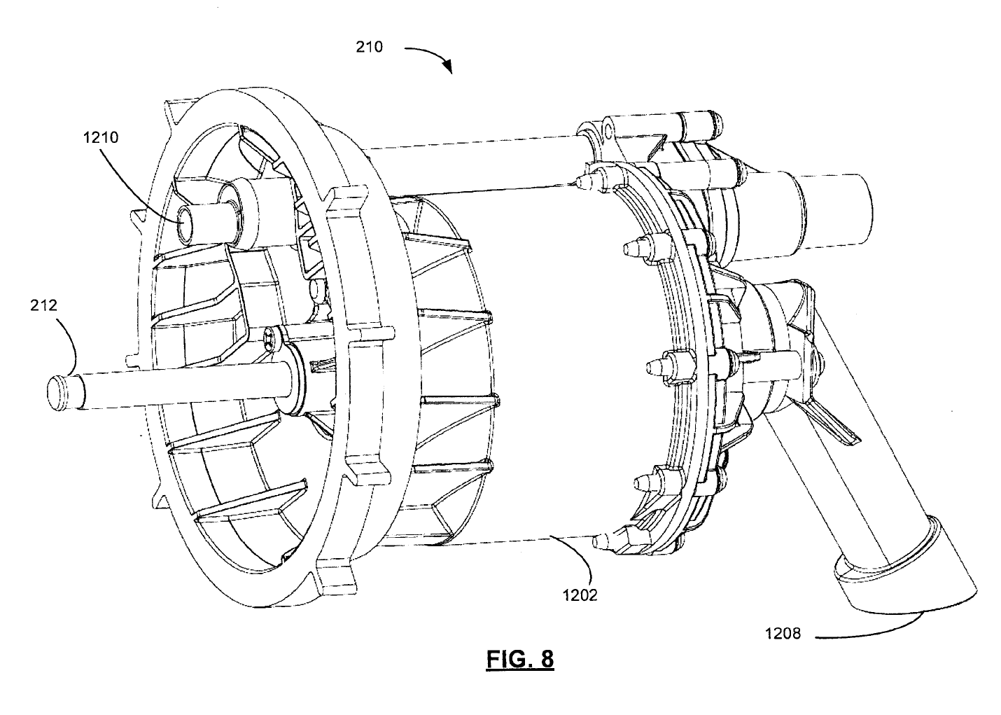

FIGS. 7A and 7B show example displacement diagrams for a cam surface 222 of an actuator 220. In these example diagrams, the displacement of a piston shaft 212 is shown along the y-axis while the position of an actuator 220 is shown along the x-axis. The example diagrams indicate the axial movement (FIG. 7A) and lateral-axial displacement (FIG. 7B) of the piston shaft 212 as the actuator 220 is moved from its unactuated position A, to its fully actuated position B, and back to its unactuated position A.

As shown in this example, as an actuator 220 moves (e.g., at a relatively constant rate) from its unactuated position A to its fully actuated position B (e.g., by application of a manual force, such as a foot stepping on the actuator 220), the piston shaft 212 may move axially in its outflow stroke, for example at a substantially constant rate (i.e., relationship between the movement of the pedal and movement of the shaft may not be linear). As the actuator 220 is returned to its unactuated position A (e.g., by release of a manual force, such as release of a foot from the actuator 220), the piston shaft 212 may move axially in its intake stroke, for example at a substantially constant rate. The axial displacement of the piston shaft 212 throughout this process may be eliminated or minimized. Although not shown, in some examples the piston shaft 212 may move at a variable rate along its outflow stroke and/or its intake stroke, even as the actuator 220 moves at a relatively constant rate.

In the example shown, motion of a piston shaft 212 may include dwell period during which the piston shaft 212 does not move even as the actuator 220 continues to move. The dwell period may be provided at the end of the outflow stroke, for example, to help ensure that fluid is fully or mostly expelled from the pump chamber. In some examples, motion of a piston shaft 212 may not include a dwell period. A cam surface 222 may be designed as suitable to provide a constant or variable rate of piston motion, to provide a dwell period, and/or any other suitable feature of piston motion.

In some examples, it may be useful for a cam surface 222 to be designed such that when an actuator 220 is actuated, a slight non-axial force is exerted on a piston shaft 212 sufficient to compensate for any non-axial forces between the piston shaft 212 and the actuator 220, with the result that the net force between the piston shaft 212 and the actuator 220 is still substantially parallel to or substantially collinear with the axis 214. Such a slight non-axial force may be useful to help counteract any non-axial friction forces, such as any frictional forces, between the piston shaft 212 and the actuator 220. In some examples, where friction between a piston shaft 212 and an actuator 220 is relatively small, such as where the contact between the piston shaft 212 and the actuator 220 is a point contact, such a design may not be necessary.

The use of a cam surface 222 may facilitate even and axial exertion of forces on the piston shaft 212 throughout an entire actuation cycle, reducing or eliminating non-axial (e.g., transverse) forces on the shaft 212. This may help to improve the useful life of components of the pump 210 (e.g., the shaft 212 and/or seals between the shaft 212 and the pump body). This configuration may be relatively simple, and may avoid the need for complex arrangement of parts (e.g., multiple linking components), which may help to reduce the costs of manufacture as well as reducing the possible sources of failure.

Features of an example pump 210, 22 are now described.

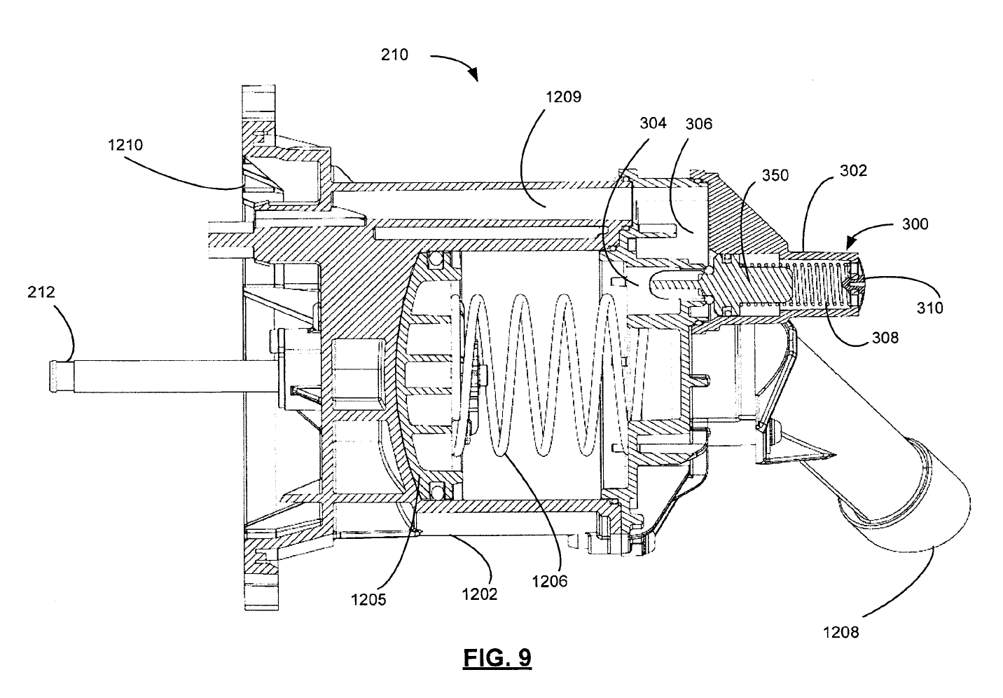

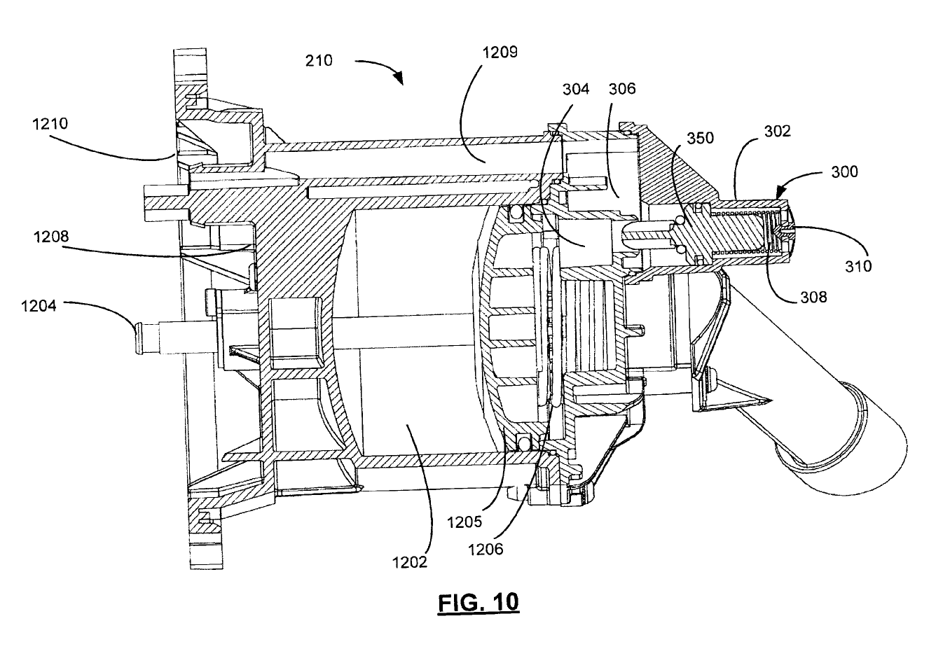

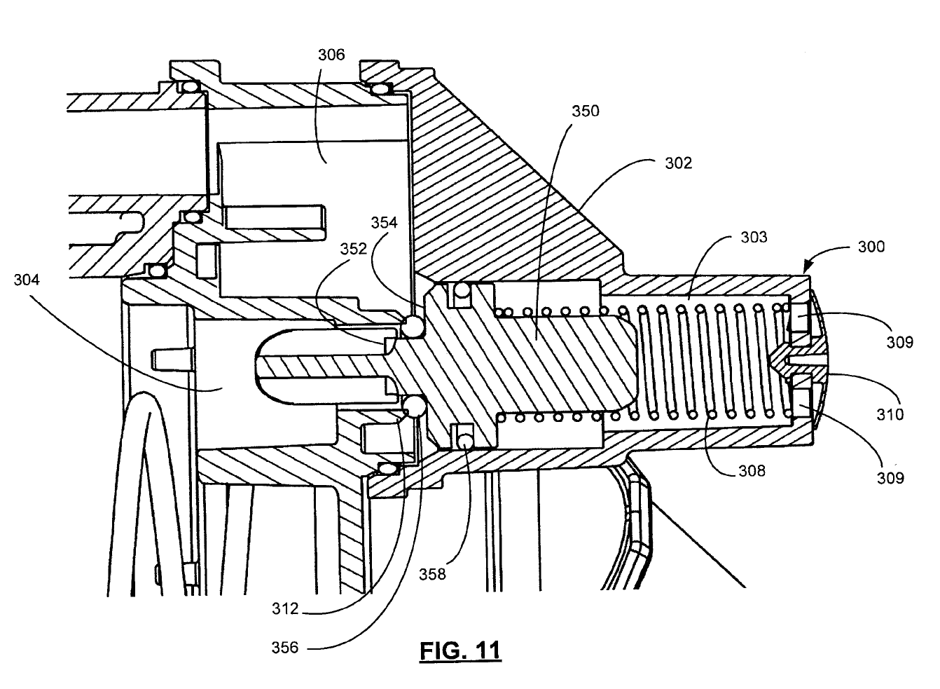

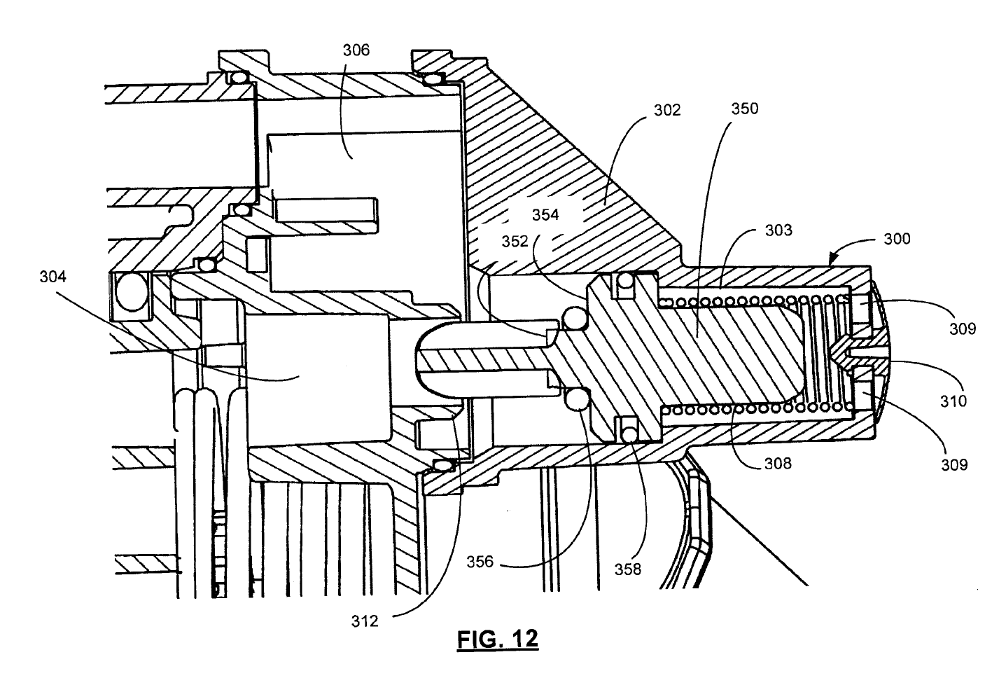

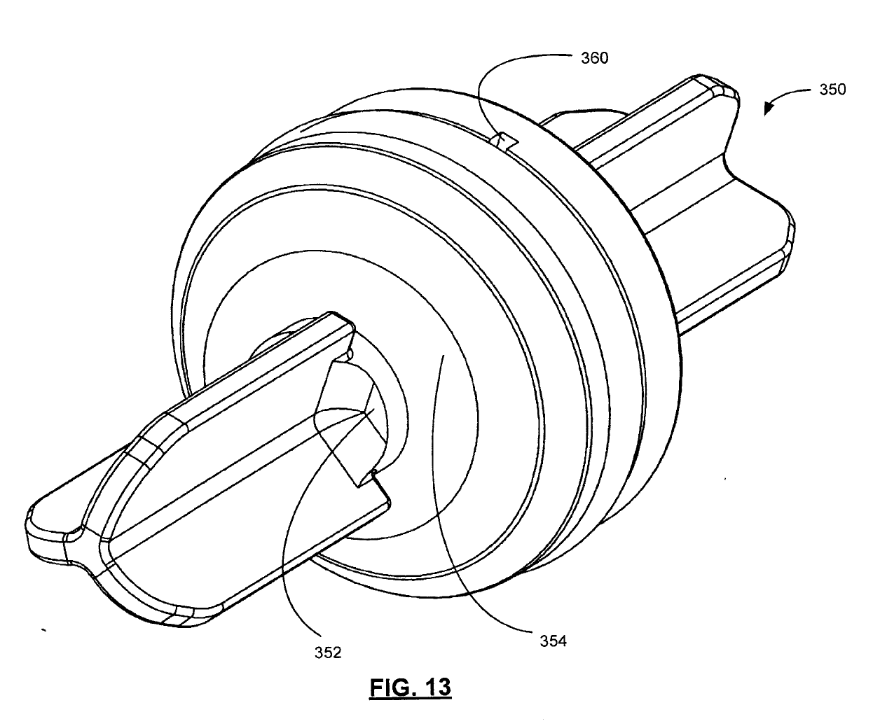

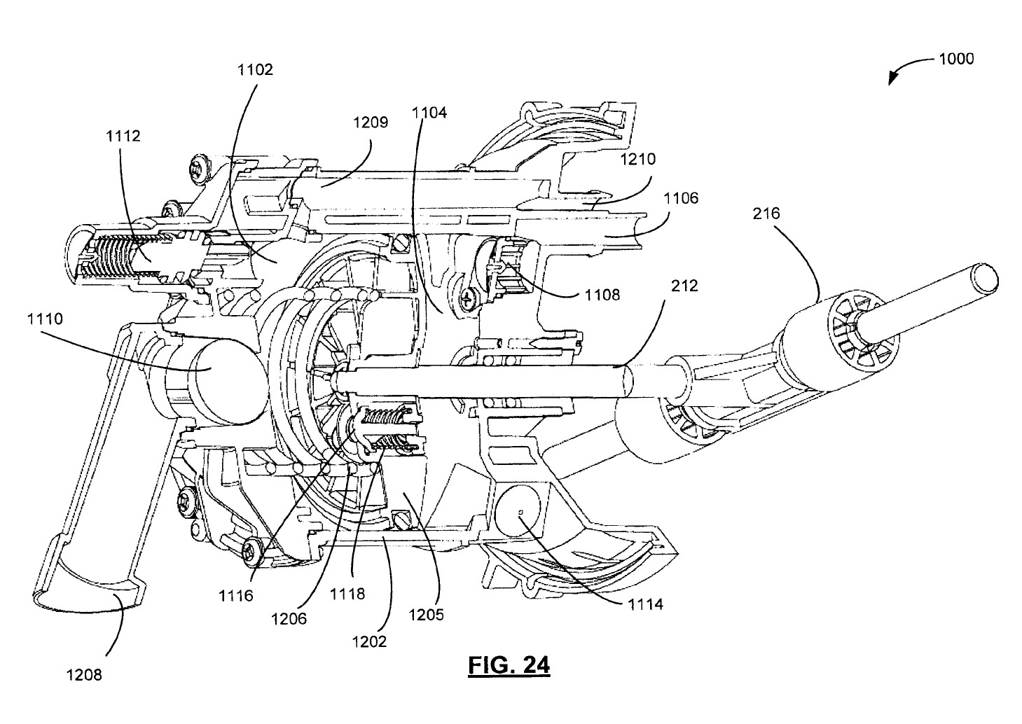

FIGS. 8-10 show an example fluid pump 210, which may be suitable for use as a fluid pump 22 of a fluid source 20 (e.g., the pump 210 may be at least partially or entirely contained within or otherwise in fluid communication with the fluid source 20, which may be the container 200). The pump 210 may include a pump chamber 1202 which may receive fluid from the fluid source 20 to be pumped out. Pump 210 may be a reciprocating pump, and may be pumped by motion of a piston shaft 212. When the piston shaft 212 is retracted from the pump chamber 1202, as shown in FIG. 9, the piston 1205 may be moved to the top of the stroke, where the top of the stroke may be defined as the recovery position (in the case of a fluid recovery pump), (e.g., as shown in FIGS. 9 and 11) where fluid may be received into the pump chamber 1202 through a dispensing inlet 1208 (which may be a fluid inlet for receiving fluid into the pump 210 to be dispensed). When the piston shaft 212 is inserted into the pump chamber 1202, the piston 1205 may be moved to the bottom of the stroke, where the bottom of the stroke may be defined as the dispensing position, (e.g., as shown in FIGS. 10 and 12) where fluid may be pumped out through a dispensing channel 1209 to a dispensing outlet 1210 (which may be a fluid outlet for dispensing fluid from the pump 210) (e.g., as shown in FIG. 10, and further described with reference to FIGS. 23 and 24 below). The piston 1205 may be biased to retract from the pump chamber 1202, for example by a piston biasing member 1206. In some examples, the piston 1205 may not be biased, in which case movement of the piston shaft 212 into and out of the pump chamber 1202 may be facilitated through the application of a force external to the pump 210 (e.g., a manual force).

In some examples, a check valve may be used to regulate the direction of fluid flow in a fluid pump (e.g., the pump 210, 22). In some cases, a pump may employ one or more check valves that have a cracking pressure (typically a predetermined amount of pressure) that must be exceeded in order to open the check valve to allow fluid to flow. For example, for the fluid container 200, 20, a check valve that has a cracking pressure may be used to help ensure that in the event the fluid dispenser 30 is disconnected, fluid will not be undesirably siphoned out of the container 200, 20. This may be a concern where unintentional siphoning of fluid from the fluid container 200, 20 may lead to costly loss of fluid and/or where the fluid may be a dangerous, hazardous and/or contaminating substance.

For example, safety bodies may place regulations on fuel storage and dispensing containers (e.g., portable fuel containers), requiring that the loss of a dispenser (e.g., a fuel-dispensing nozzle) from the container (e.g., due to damage or unintentional disconnection) will not lead to the free flow of fuel from the container. In some cases, where the fluid is a volatile fluid (e.g., fuel), it may be necessary for the check valve to be able to remain closed against relatively high pressure (e.g., due to the vapor pressure of the fluid) within the container. In some instances, pressures inside a conventional portable fuel container may reach up to about 7 to 13 pounds of pressure per square inch, for example due to relatively high ambient temperatures (e.g., about 25-40 degrees Celsius). A particular scenario may be where fuel is inputted into the container in the wintertime when the fuel is produced to have a higher vapor pressure. If this fuel was kept in that container throughout the winter and into the summer months when ambient temperatures may be above 30 degrees Celsius, the pressures within that container may reach pressures of 7 to 13 pounds of pressure per square inch.

To help ensure that unwanted free flow or siphoning of fluid does not occur under such circumstances (e.g., when the dispenser is opened, removed, damaged or unintentionally disconnected), a check valve may be designed to require a relatively high cracking pressure (e.g., greater than 13 pounds of pressure per square inch) to open. In cases where the fluid pump is a manually-operated pump, such as in the example pump 210, 22, this may require a manual pumping force sufficient to exert a pressure greater than the cracking pressure in order to operate the pump. This may result in a pumping pressure that is higher than the pressure required to pump the fluid from the container. This cracking pressure may produce added stresses and strains on the pump components and/or the actuator, and/or may cause the pump to be more strenuous and tiring for a user to operate.

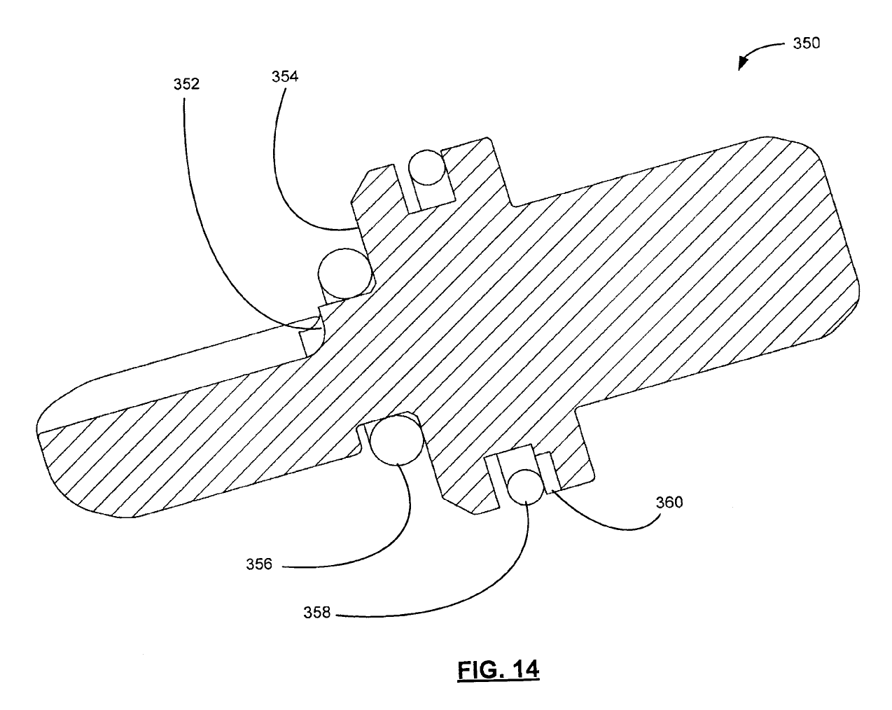

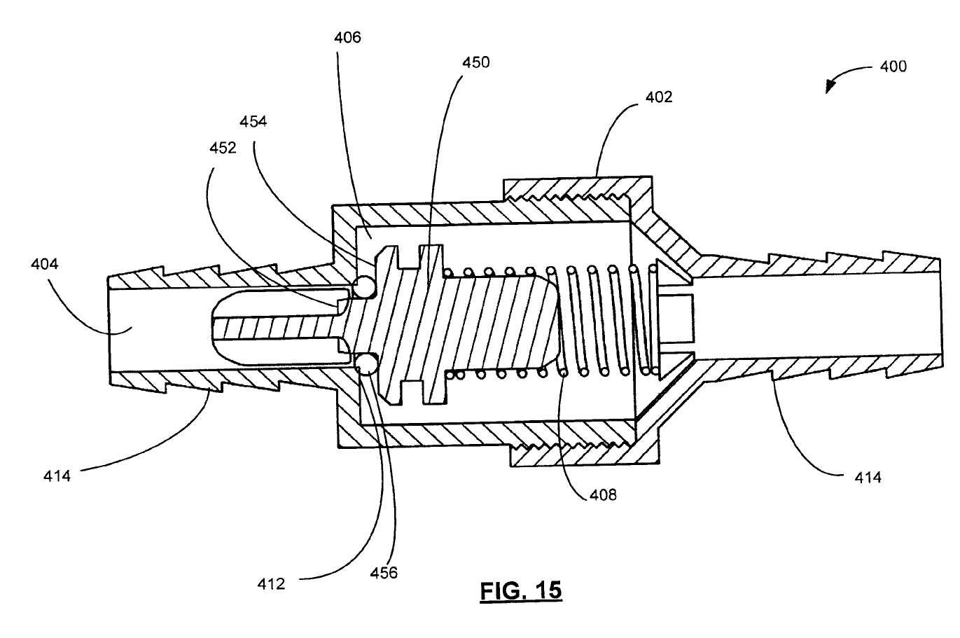

As shown in FIGS. 9 and 10, and more clearly in FIGS. 11 and 12, a fluid pump 210 may include a check valve 300. In some examples, a check valve 300 may be integral to the pump 200, while in other examples, a check valve 300 may be a separate component (e.g., a separate component that may be inserted into or otherwise coupled to a pump 210). In the example shown, the check valve 300 may be integral to the pump 210. The check valve 300 may include a valve body 302 (which may include two or more separate parts or components) defining an upstream portion 304 of the check valve 300 and a downstream portion 306 of the check valve 300. In the example shown, the upstream and downstream portions 304, 306 may be provided by the valve cover and the back cover of the pump, respectively. The upstream portion 304 may be in fluid communication with the pump chamber 1202, for example the upstream portion 304 may be part of the pump chamber 1202. The downstream portion 306 may be in fluid communication with the dispensing outlet 1210. The check valve 300 may include a plug 350 that is configured to seal the check valve 300 and separate the upstream portion 304 and the downstream portion 306, when the check valve 300 is in a closed configuration. The plug 350 may be seen more clearly in FIGS. 13 and 14. The upstream portion 304 may experience fluid and/or vapor pressure from the container 20 and pump chamber 1202, such as vapor pressure and or pumping pressure when the pump 210 is in operation.

The plug 350 may be biased (e.g., by a plug biasing member 308, such as a coil spring) against a seat 312 defined in the valve body 302. A first seal, such as a first O-ring seal 356, may be provided on the plug 350 in order to help seal the plug 350 against the seat 312. Other types of seals may be used including, for example, radial seals or any other suitable seal type. In some examples, a separate first seal may not be provided, for example where a plug 350 itself forms a sufficient seal against a seat 312. When the plug 350 is seated against the seat 312 (e.g., as shown in FIG. 11), the check valve 300 may define a closed position in which fluid may be inhibited or prevented from flowing from the upstream portion 304 to the downstream portion 306. When the plug 350 is unseated from the seat 312 (e.g., as shown in FIG. 12), the check valve 300 may define an opened position in which fluid may flow from the upstream portion 304 to the downstream portion 306.

The plug 350 may include a first frontal area 352 and a second frontal area 354. It will be understood that “frontal area” may refer to the projected cross-sectional area of an object that is acted against by a fluid, and may be useful in calculating forces applied to the object by the fluid, for example in calculating drag and pressure. In this example, the first frontal area 352 of the plug 350 may be smaller than the second frontal area 354.

When the plug 350 is seating against the seat 312, only the first frontal area 352 may be exposed to the upstream portion 304. For example, a first frontal area 352 may be defined by the size of an opening in a seat 312 in which a plug 350 is seated. Fluid pressure from the upstream portion 304 may act against only the first frontal area 352 when the plug 350 is seated against the seat 312 and the check valve 300 is in the closed configuration. A larger second frontal area 354 may not be subjected to fluid pressure from the upstream portion 304 when the plug 350 is seated against the seat 312. When the plug 350 is unseated from the seat 312 and the check valve 300 is in the opened configuration, a second frontal area 354 may be exposed to the upstream portion 304, and fluid pressure from the upstream portion 304 may act against the second frontal area 354.

In order to open the check valve 300, it may be necessary for fluid pressure from the upstream portion 304 (e.g., pressure generated from manual operation of a manually-operated pump 200) to overcome the force biasing the plug 350 against the seat 312 (e.g., the force exerted by the plug biasing member 308). Thus, the fluid pressure required to unseat a plug 350 from a seat 312 may be calculated as P=F/A, where P is the fluid pressure required to unseat the plug 350, F is the force biasing the plug 350 against the seat 312 and A is the frontal area acted upon by the fluid pressure.

When the plug 350 is seated, the frontal area acted upon by the fluid pressure from the upstream portion 304 may be a first frontal area 352. The first frontal area 352 and/or the biasing force may be designed to ensure that a first pressure P1 required to open the check valve (which may also be referred to as the cracking pressure) is higher than a desired threshold (e.g., about 13 pounds per square inch or higher, or any other suitable threshold pressure). Once the plug 350 has been unseated, a second frontal area 354 may be exposed, and the frontal area acted upon by the fluid pressure from the upstream portion 304 may be the second frontal area 354. Since the second frontal area 354 may be larger than the first frontal area 352, and since the biasing force may remain relatively unchanged or increase only slightly (e.g., when the biasing force is provided by the same plug biasing member 308, the biasing force may vary slightly at most), a second pressure P2 required to maintain the plug 350 unseated from the seat 312 may be less than the first pressure P1.

This may be useful in order to ensure that the first cracking pressure required to open the check valve 300 is sufficiently high to avoid unintentional opening of the check valve 300 by build-up of vapor pressure in the pump 210, while avoiding the need for subsequent high pumping pressures. The reduced pumping pressure may help to reduce or avoid stress on the pump and/or the actuator, and/or help to reduce or avoid tiring the user of a manually-operated pump.

In some examples, the plug 350 may be sufficiently biased against the seat 312 (e.g., using a heavy-duty plug biasing member 308) such that the plug 350 quickly reseals itself against the seat 312, in order to avoid or reduce unintentional leak of fluid (e.g., due to build up of pressure in the pump chamber 1202. This may help to avoid unintentional dispensing of fluid at the time that actuation of the pump 210 is ended, for example. The plug biasing member 308 may provide sufficient biasing force to overcome any negative pressure (for example, as described below) that may delay reseating of the plug 350.

In some examples, it may be useful to dampen or slow reseating of a plug 350. For example, for a reciprocating pump having relatively slow pumping action (e.g., manual pumping), after a plug 350 has been unseated by a first pumping action, biasing of a plug biasing member 308 may be such that the plug 350 reseats too quickly, before a subsequent pumping action. This may negate or reduce any benefit provided by the larger second frontal area 354. In such cases, a check valve 300 may also include a plug receiving portion 303 defined in the valve body 302 which may receive the plug and may additionally serve to slow or dampen reseating of a plug 350.

At least a portion of a plug 350 may be received in a plug receiving portion 303 when the plug 350 is unseated from a seat 312. For example, at least a back half of the plug 350 opposing the second frontal area 354 may be received in the plug receiving portion 303. The plug receiving portion 303 may also house a plug biasing member 308 for biasing the plug 350 against the seat 312. The plug 350 may be provided with a second seal, such as a second O-ring seal 358, that may form a seal between the plug 350 and the wall(s) of the plug receiving portion 303. The second seal may be any suitable seal, such as a radial seal. Thus, the plug 350, together with the walls of the plug receiving portion 303, may define a volume of the plug receiving portion 303 when the plug 350 is received in the plug receiving portion 303. The defined volume of the plug receiving portion 303 may decrease when the plug 350 is being received into the plug receiving portion 303. There may be one or more orifices 309 defined in one or more walls of the plug receiving portion 303. The orifice(s) 309 may be sealed by one or more one-way valves 310 (e.g., umbrella valves) to permit fluid to exit the plug receiving portion 303 via the orifice(s) 309 but inhibit fluid from entering the plug receiving portion 303 via the orifice(s) 309. In some examples, the second seal 358 may also serve to inhibit fluid in the upstream portion 304 from flowing around or past the plug 350 and through the orifice(s) 309 when the plug 350 is unseated from its seat 312.

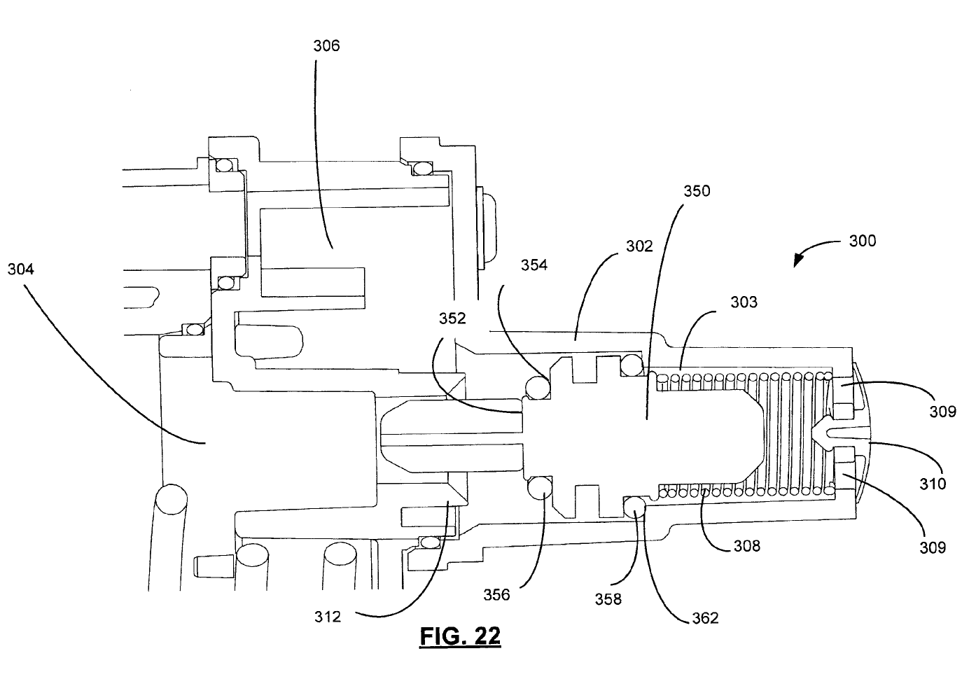

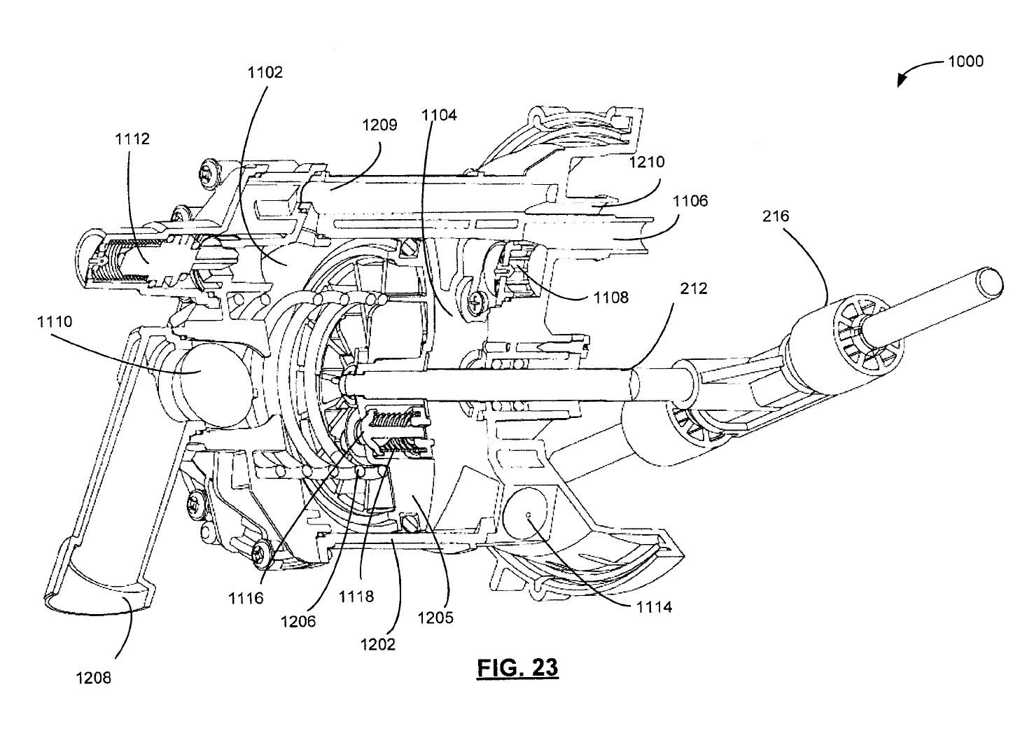

FIGS. 21 and 22 show an example of the check valve 300 where the second seal 358 is positioned such that the second seal 358 does not form a seal between the plug 350 and the wall(s) of the plug receiving portion 303 when the plug 350 moves between the closed and opened positions of the valve 300. There may thus be a gap between the plug 350 and the wall(s) of the plug receiving portion 303, allowing fluid to flow around the plug 350 and equalize pressure in the plug receiving portion 303, to allow the plug biasing member 308 to reseat the plug 350 quickly. Rather, the second seal 358 may be positioned such that the plug 350 is sealed against a second seat 362 defined in the plug receiving portion 303 when the plug 350 is moved to the fully opened position of the valve 300. This may prevent or inhibit fluid from flowing past the plug 350 and into the plug receiving portion 303 when the plug 350 is moved to the open position of the valve 300.

In some examples, the second seal 358 may serve to both seal the plug 350 against the wall(s) of the plug receiving portion 303 as well as to seal the plug 350 against the second seat 362. For example, there may be two seal seals 358 provided in different locations on the plug 350.

In some examples, a second seal may not be provided, such as where the plug 350 itself forms a sufficient seal with the walls of the plug receiving portion 303.

When the plug 350 is unseated from the seat 312 and received into the plug receiving portion 303, fluid may be ejected from the plug receiving portion 303 via the orifice(s) 309. Fluid may be inhibited or prevented from entering the defined volume of the plug receiving portion 303 by the second seal and the one-way valve(s) 310. Hence, when the plug biasing member 308 biases the plug 350 back towards the seat 312, a negative pressure (e.g., relative to the upstream portion 304) may be generated within the defined volume of the plug receiving portion 303 relative to the pressure in the rest of the valve body 302. This relative negative pressure may serve to dampen or slow the reseating of the plug 350. In some examples, a plug 350 may include one or more relatively small bleed openings 360, which may allow relatively slow flow of fluid into the defined volume of the plug receiving portion 303 (e.g., fluid may flow past the second O-ring seal 358), allowing the pressure in the defined volume of the plug receiving portion 303 to eventually equalize with the pressure of the upstream portion 304. This may allow the plug 350 to eventually reseat against the seat 312. The size of bleed opening(s) 360 may be designed to provide a desired amount of slowing or damping of the reseating of the plug 350. In some examples, one or more bleed openings 360 may be provided in other positions, such as in one or more walls of the plug receiving portion 303. In some examples, instead of or in addition to bleed opening(s) 360, one-way valve(s) 310 may form an imperfect seal, such that gradual flow of fluid into the defined volume of the plug receiving portion 303 may be permitted through the one-way valve(s) 310.

Such damping of the plug 350 may be useful to prevent the plug 350 from quickly reseating against the seat 312. This may be useful where, after a first pumping action unseats the plug 350, subsequent pumping actions are relatively slow (e.g., in the case of manual pumping action). In this way a user manually actuating the pump 210 may only experience the higher pressure needed to overcome the cracking pressure once when dispensing fluid. With the plug 350 kept from reseating against its seat 312, subsequent actuation stokes on the pump 210 may require less effort because the user would no longer be working against the cracking pressure of the check valve 300.

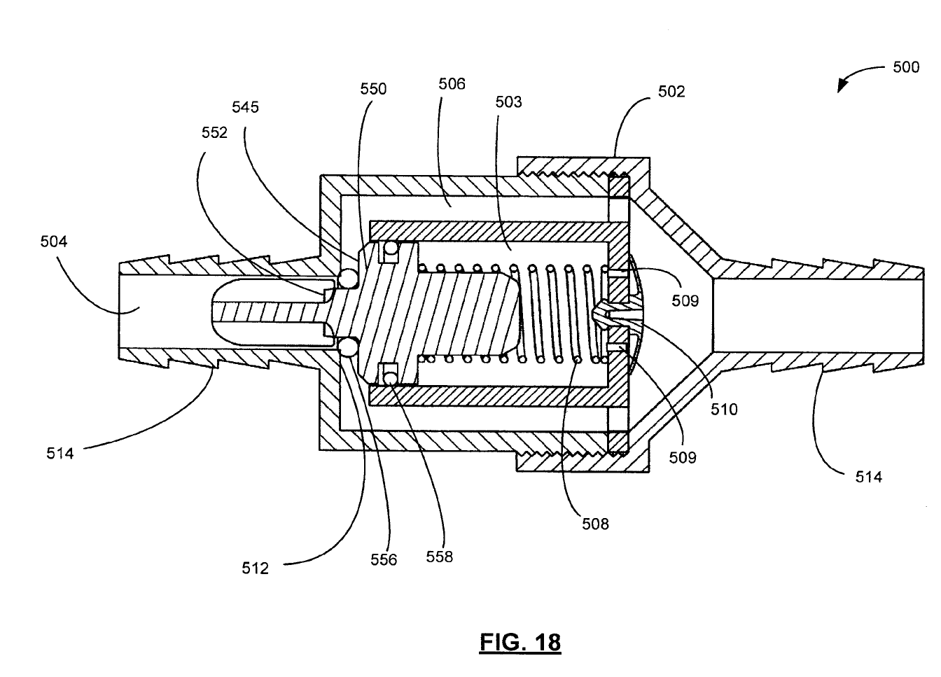

FIGS. 15-17 show another example check valve 400 that may be suitable for a fluid pump 22, such as the pump 210. In this example, the check valve 400 may be a separate component from a fluid pump 22. For example, the check valve 400 may be inserted in the fluid pump 22, or between a fluid pump 22 and a fluid dispenser 30 or fluid conduit (e.g., as a connector).

The check valve 400 may include a valve body 402. In this example, a valve body 402 may be manufactured as two or more separate pieces, which may be matable and may be assembled (e.g., snapped together or threaded together) to form a valve body 402. Such a design may help to simplify and/or speed up the manufacturing of the check valve 400 and/or may help to reduce the costs of check valve 400. The valve body 402 may define an upstream portion 404 and a downstream portion 406. In some examples, the check valve 400 may be provided as a separate component from a pump 22. The check valve 400 may be removably or permanently attachable to a fluid pump 22 and/or a fluid dispenser 30 or fluid conduit (e.g., hose 40). For example, the upstream portion 404 and/or the downstream portion 406 may be attachable to the fluid pump 22 and/or the fluid dispenser 30 or fluid conduit, respectively. The check valve 400 may include attachment members, such as one or more barbs 414, threads, grooves, etc., to facilitate attachment to a pump 22 and/or a dispenser 30 or conduit.

Operation of the check valve 400 may be similar to operation of the check valve 300 described above, for example.

The check valve 400 may include a plug 450 that is configured to seal the check valve 400 and separate the upstream portion 404 and the downstream portion 406, when the check valve 400 is closed. The upstream portion 404 may experience fluid and/or vapor pressure from the pump 22, such as pumping pressure when the pump 22 is in operation and/or from vapor pressures of the fluid.

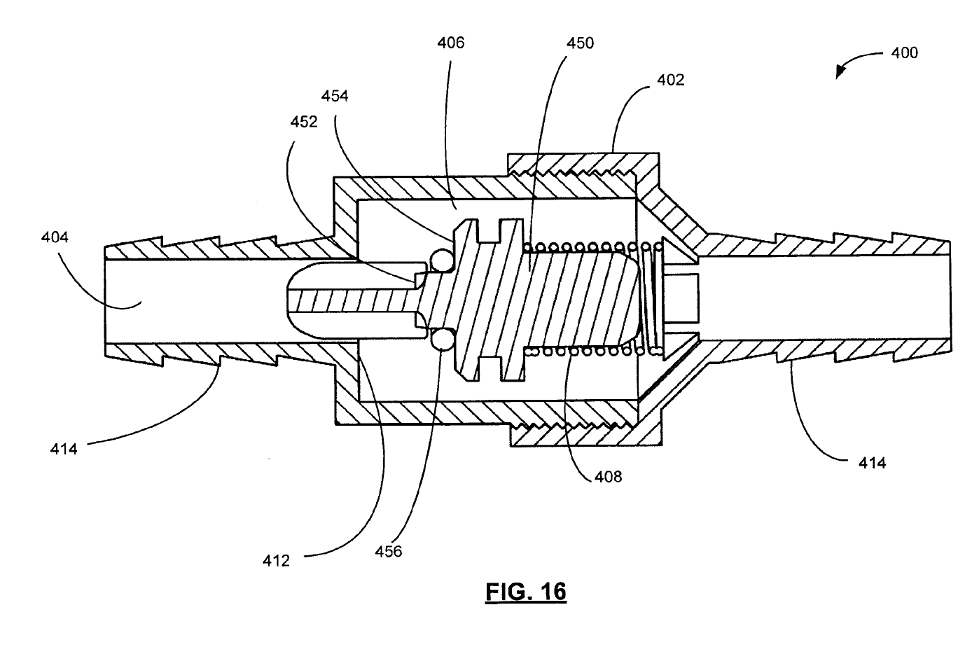

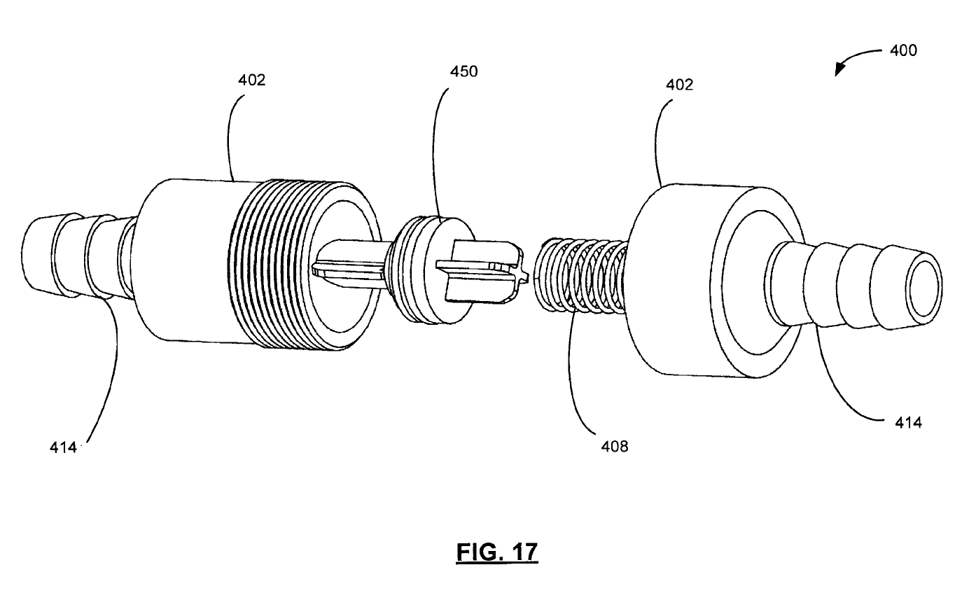

The plug 450 may be biased (e.g., by a plug biasing member 408, such as a coil spring) against a seat 412 defined in the valve body 402. A first seal, such as a first O-ring seal 456, may be provided on the plug 450 in order to help seal the plug 450 against the seat 412. Other types of seals may be used including, for example, radial seals or any other suitable seal type. In some examples, a separate first seal may not be provided, for example where a plug 450 itself forms a sufficient seal against a seat 412. When the plug 450 is seated against the seat 412 (e.g., as shown in FIG. 15), the check valve 400 may define a closed position in which fluid may be inhibited or prevented from flowing from the upstream portion 404 to the downstream portion 406. When the plug 450 is unseated from the seat 412 (e.g., as shown in FIG. 16), the check valve 400 may define an opened position in which fluid may flow from the upstream portion 404 to the downstream portion 406.

The plug 450 may include a first frontal area 452 and a second frontal area 454. In this example, the first frontal area 452 of the plug 450 may be smaller than the second frontal area 454. When the plug 450 is seating against the seat 412, only a first frontal area 452 may be exposed to the upstream portion 404. For example, a first frontal area 452 may be defined by the size of an opening in a seat 412 in which a plug 450 is seated. Fluid pressure from the upstream portion 404 may act against only the first frontal area 452 when the plug 450 is seated against the seat 412 and the check valve 400 is in the closed configuration. A larger second frontal area 454 may not be subjected to fluid pressure from the upstream portion 404 when the plug 450 is seated against the seat 412. When the plug 450 is unseated from the seat 412 and the check valve 400 is in the opened configuration, a second frontal area 454 may be exposed to the upstream portion 404, and fluid pressure from the upstream portion 404 may act against the second frontal area 454.

In order to open the check valve 400, it may be necessary for fluid pressure from the upstream portion 404 (e.g., pressure generated from a non-manual pump or manual operation of a manually-operated pump 210) to overcome the force biasing the plug 450 against the seat 412 (e.g., the force exerted by the plug biasing member 408). When the plug 450 is seated, the frontal area acted upon by the fluid pressure from the upstream portion 404 may be the first frontal area 452. The first frontal area 452 and/or the biasing force may be designed to ensure that a first pressure required to open the check valve (which may also be referred to as the cracking pressure) is higher than a desired threshold (e.g., about 13 pounds per square inch or higher, or any other suitable threshold pressure). Once the plug 450 has been unseated, the second frontal area 454 may be exposed, and the frontal area acted upon by the fluid pressure from the upstream portion 404 may be the second frontal area 454. Since the second frontal area 454 may be larger than the first frontal area 452, and since the biasing force may remain relatively unchanged or increase only slightly (e.g., when provided by the same plug biasing member 408, the biasing force may vary only slightly at most), a second pressure required to maintain the plug 450 unseated from the seat 412 may be less than the first pressure.

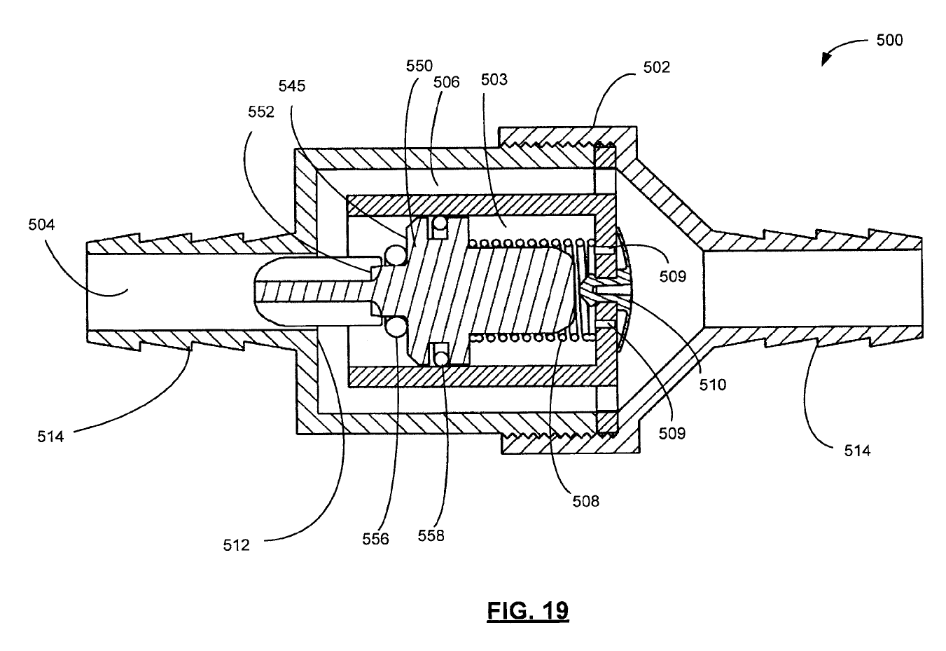

FIGS. 18-120 show another example check valve 500 for a fluid pump 22, such as the pump 210. The check valve 500 may be a separate component from a fluid pump 22. For example, the check valve 500 may be inserted in a fluid pump 22 or between the fluid pump 22 and the fluid dispenser 30 or fluid conduit (e.g., as a connector).

The check valve 500 may include a valve body 502. In this example, the valve body 502 may be manufactured as two or more separate pieces, which may be matable and may be assembled (e.g., snapped together or threaded together) to form a valve body 502. Such a design may help to simplify and/or speed up the manufacturing of a check valve 500 and/or may help to reduce the costs of a check valve 500. The valve body 502 may define an upstream portion 504 and a downstream portion 506. In some examples, the check valve 500 may be provided as a separate component from a pump 22. The check valve 500 may be removably or permanently attachable to a fluid pump 22 and/or a fluid dispenser 30 or fluid conduit (e.g., hose 40). For example, the upstream portion 504 and/or the downstream portion 506 of the may be attachable to a fluid pump 22 and/or a fluid dispenser 30 or fluid conduit, respectively. The check valve 500 may include attachment members, such as one or more barbs 514, threads, grooves, etc., to facilitate attachment to a pump 22 and/or a dispenser 30 or conduit.

Operation of the check valve 500 may be similar to operation of the check valves 300 and 400 described above, for example.

The check valve 500 may include a plug 550 that is configured to seal the check valve 500 and separate the upstream portion 504 and the downstream portion 506, when the check valve 500 is closed. The upstream portion 504 may experience fluid and/or vapor pressure from the pump 22, such as pumping pressure when the pump 22 is in operation and/or from vapor pressures of the fluid.

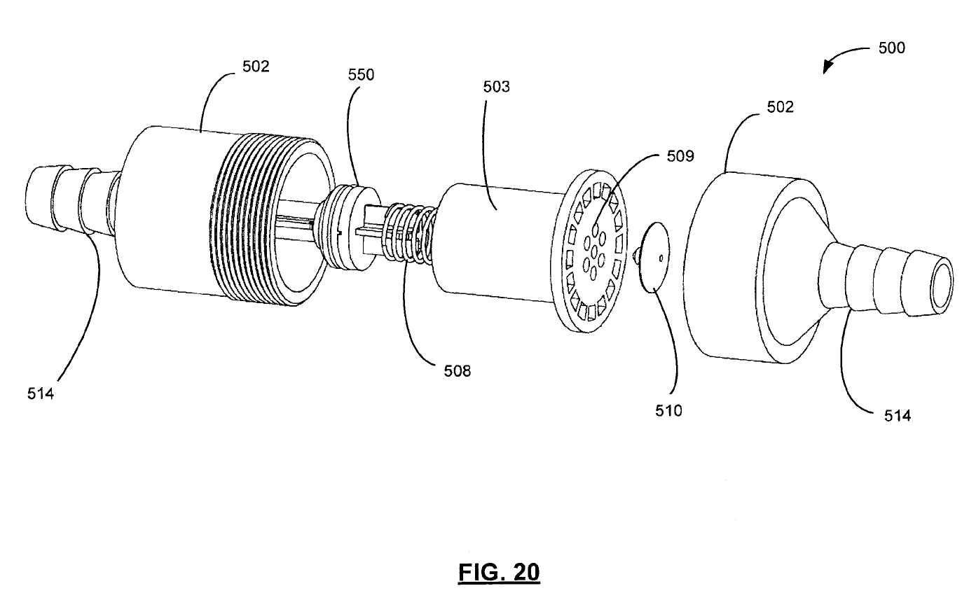

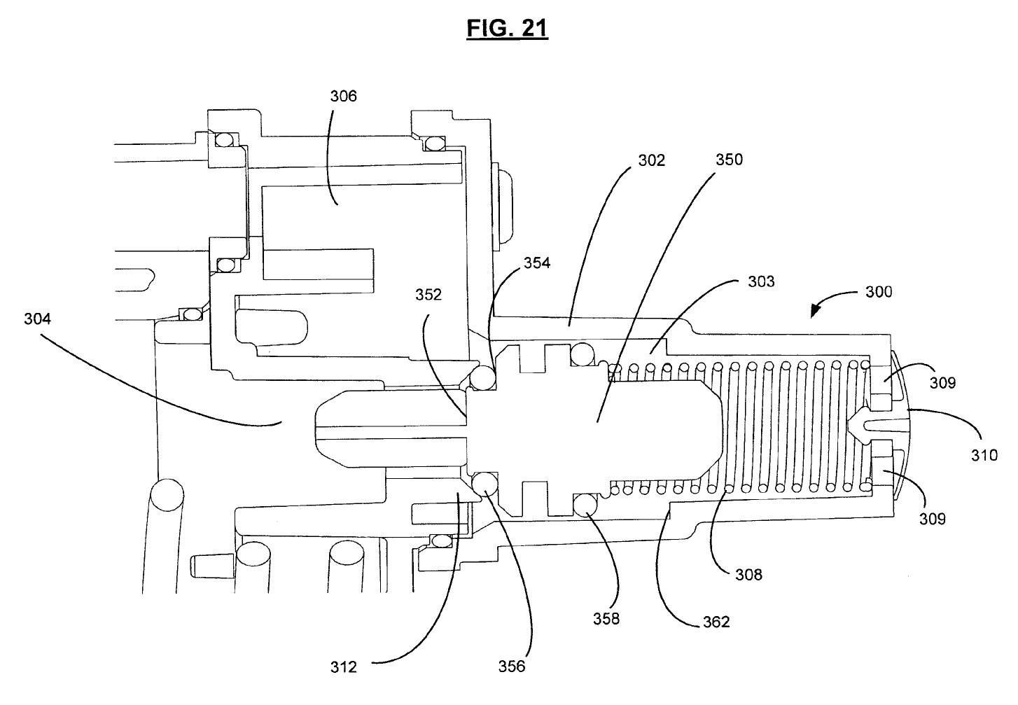

The plug 550 may be biased (e.g., by a plug biasing member 508, such as a coil spring) against a seat 512 defined in the valve body 502. A first seal, such as a first O-ring seal 556, may be provided on the plug 550 in order to help seal the plug 550 against the seat 512. Other types of seals may be used including, for example, radial seals or any other suitable seal type. In some examples, a separate first seal may not be provided, for example where the plug 550 itself forms a sufficient seal against the seat 512. When the plug 550 is seated against the seat 512 (e.g., as shown in FIG. 18), the check valve 500 may define a closed position in which fluid may be inhibited or prevented from flowing from the upstream portion 504 to the downstream portion 506. When the plug 550 is unseated from the seat 512 (e.g., as shown in FIG. 19), the check valve 500 may define an opened position in which fluid may flow from the upstream portion 504 to the downstream portion 506.

The plug 550 may include a first frontal area 552 and a second frontal area 554. In this example, the first frontal area 552 of the plug 550 may be smaller than the second frontal area 554.

When the plug 550 is seating against the seat 512, only the first frontal area 552 may be exposed to the upstream portion 504. For example, a first frontal area 552 may be defined by the size of an opening in a seat 512 in which a plug 550 is seated. Fluid pressure from the upstream portion 504 may act against only the first frontal area 552 when the plug 550 is seated against the seat 512 and the check valve 500 is in the closed configuration. A larger second frontal area 554 may not be subjected to fluid pressure from the upstream portion 504 when the plug 550 is seated against the seat 512. When the plug 550 is unseated from the seat 512 and the check valve 500 is in the opened configuration, the second frontal area 554 may be exposed to the upstream portion 504, and fluid pressure from the upstream portion 504 may act against the second frontal area 554.

In order to open the check valve 500, it may be necessary for fluid pressure from the upstream portion 504 (e.g., pressure generated from a non-manual pump or the manual operation of a manually-operated pump 210) to overcome the force biasing the plug 550 against the seat 512 (e.g., the force exerted by the plug biasing member 508). When the plug 550 is seated, the frontal area acted upon by the fluid pressure from the upstream portion 504 may be the first frontal area 552. The first frontal area 552 and/or the biasing force may be designed to ensure that a first pressure required to open the check valve (which may also be referred to as the cracking pressure) is higher than a desired threshold (e.g., about 13 pounds per square inch or higher, or any other suitable threshold pressure). Once the plug 550 has been unseated, the second frontal area 554 may be exposed, and the frontal area acted upon by the fluid pressure from the upstream portion 504 may be the second frontal area 554. Since the second frontal area 554 may be larger than the first frontal area 552, and the biasing force may remain relatively unchanged or increase only slightly (e.g., when provided by the same plug biasing member 508, the biasing force may vary only slightly at most), a second pressure required to maintain the plug 550 unseated from the seat 512 may be less than the first pressure.

The check valve 500 may also include a plug receiving portion 503, which may operate similar to the plug receiving portion 303 described above.

At least a portion of the plug 550 may be received in the plug receiving portion 503 when the plug 550 is unseated from the seat 512. For example, at least a back half of the plug 550 opposing the second frontal area 554 may be received in the plug receiving portion 503. The plug receiving portion 503 may also house a plug biasing member 508 for biasing the plug 550 against the seat 512. The plug 550 may be provided with a second seal, such as a second O-ring seal 558, that may form a seal between the plug 550 and the walls of the plug receiving portion 503. The second seal may be any suitable seal, such as a radial seal. In some examples, a second seal may not be provided, such as where the plug 550 itself forms a sufficient seal with the walls of the plug receiving portion 503. Thus, the plug 550, together with the walls of the plug receiving portion 503, may define a volume of the plug receiving portion 503 when the plug 550 is received in the plug receiving portion 503. The defined volume of the plug receiving portion 503 may decrease when the plug 550 is being received into the plug receiving portion 503. There may be one or more orifices 509 defined in one or more walls of the plug receiving portion 503. The orifice(s) 509 may be sealed by one or more one-way valves 510 (e.g., umbrella valves) to permit fluid to exit the plug receiving portion 503 via the orifice(s) 509 but inhibit fluid from entering the plug receiving portion 503 via the orifice(s) 509.

When the plug 550 is unseated from the seat 512 and received into the plug receiving portion 303, fluid may be ejected from the plug receiving portion 503 via the orifice(s) 509. Fluid may be inhibited or prevented from entering the defined volume of the plug receiving portion 503 by the second seal and the one-way valve(s) 510. Hence, when the plug biasing member 508 biases the plug 550 back towards the seat 512, a negative pressure (e.g., relative to the upstream portion 504) may be generated within the defined volume of the plug receiving portion 503 relative to the pressure in the rest of the valve body 502. This relative negative pressure may serve to dampen or slow the reseating of the plug 550. In some examples, a plug 550 may include one or more relatively small bleed openings (not shown), which may allow relatively slow flow of fluid into the defined volume of the plug receiving portion 503 (e.g., fluid may flow past the second O-ring seal 558), allowing the pressure in the defined volume of the plug receiving portion 503 to eventually equalize with the pressure of the rest of the valve body 502. This may allow the plug 550 to eventually reseat against the seat 512. The size of the bleed opening(s) may be designed to provide a desired amount of slowing or damping of the reseating of the plug 550. In some examples, one or more bleed openings may be provided in other positions, such as in one or more walls of the plug receiving portion 503. In some examples, instead of or in addition to bleed opening(s), one-way valve(s) 510 may form an imperfect seal, such that gradual flow of fluid into the defined volume of the plug receiving portion 503 may be permitted through the one-way valve(s) 510.

The first frontal area 352, 452, 552 may be significantly smaller than the second frontal area 354, 454, 554. For example, the first frontal area 352, 452, 552 may be 50% or less of the second frontal area 354, 454, 554, with the result that the required cracking pressure may be twice that of the operational pressure of subsequent pumping action. Other ratios between the first frontal area 352, 452, 552 and the second frontal area 354, 454, 554 may be suitable, in order to achieve a desired ratio between the cracking pressure and subsequent operational pressures.

The check valve 300, 400, 500 described herein may be useful for an intermittent pump (e.g., a reciprocating pump, such as a manually-operated reciprocating pump) in which a relatively high cracking pressure but relatively low subsequent pumping pressure are desirable.

Check valve 300, 400, 500 may be included as part of a pump 22, 200 or may be a separate component that may be retrofitted to a conventional pump 22. For example, a check valve (e.g., check valve 400, 500) may be a separate component that may be removably or permanently attachable to a dispensing outlet of a pump 22. In other examples, a check valve (e.g., check valve 300) may be integral to a pump 22, 210.

Although the check valve 300, 400, 500 has been shown with plug 350, 450, 550 having relatively cylindrical bodies, relatively circular first frontal area 352, 452, 552 and relatively circular second frontal area 354, 454, 554, it should be understood that any other suitable geometry may be used including, for example, geometries having other regular cross-sections (e.g., rectangular or triangular) or irregular geometries.

In some examples, a check valve 300, 400, 500 may include plastic components, for example a major portion or all of a check valve 300, 400, 500 may be made of a plastic material. This may be useful to reduce the cost and/or weight of a check valve 300, 400, 500, such as where a check valve 300, 400, 500 is intended for use by a broad consumer market, such as for portable pumps. This may also allow a check valve 300, 400, 500 to be manufactured relatively quickly and/or inexpensively. It should be understood that a check valve 300, 400, 500 may be manufacturing using a wide variety of materials including, for example, plastics, metals or any other suitable materials. The selection of suitable materials, based on such factors as desired durability, corrosion resistance, tolerances, fluid absorbance, etc., may be determined, in accordance with the present disclosure.

General operation of an example fluid pump 1000 is now described with reference to FIGS. 23 and 24. The pump 1000 may serve as the pump 22 for the fluid source 20 (e.g., the pump 1000 may be at least partially or entirely contained within or otherwise in fluid communication with the fluid source 20, such as the container 200). The pump 1000 may be actuated by an actuator 220 (e.g., a foot pedal or other manual actuator) with a cam surface 222, for example as described above. The pump 1000 may include a check valve 300, 400, 500, for example as described above. The pump 1000 may be configured to concurrently dispense and recover substantially equal volumes of fluid (e.g., liquid and/or vapors), as described below. The pump 1000 may be positioned at least partially within or entirely within the fluid source 20 (e.g., the container 200), and may be permanently (e.g., welded during manufacture) or removably coupled to the fluid source 20.

In this example, the pump 1000 may include a pump chamber 1202 which may receive fluid from the fluid source 20 to be pumped out. Pump 210 may be a reciprocating pump, and may be pumped by motion of a piston shaft 212, which may in turn be actuated by actuation of the actuator 220. The pump chamber 1202 may be divided into a dispensing portion 1102 and a recovery portion 1104 by a piston 1205. The total volume of the dispensing portion 1102 and the recovery portion 1104 may be a constant volume, equal to the total volume of the pump chamber 1202. Thus, as the piston 1205 moves in the pump chamber 1202, the volume of the dispensing portion 1102 may be increased while the volume of the recovery portion 1104 is accordingly decreased, and vice versa, as described below.

FIGS. 23 and 24 show the example pump 1000 at a mid-stroke position. When the piston shaft 212 is retracted from the pump chamber 1202 (e.g., when the actuator 220 is in the unactuated position A), the piston 1205 may be moved to the top of the stroke (which may also be referred to as the recovery position), where the volume of the dispensing portion 1102 is at its maximum and the volume of the recovery portion 1104 is at its minimum. Fluid may thus be received into the dispensing portion 1102 of the pump chamber 1202 through a dispensing inlet 1208 (which may be a fluid inlet for receiving fluid into the pump 210 to be dispensed), and any fluid in the recovery portion 1104 of the pump chamber 1202 may be pumped out from the pump chamber 1202 back into the fluid source 20. When the piston shaft 212 is inserted into the pump chamber 1202 (e.g., when the actuator 220 is in the fully actuated position B), the piston 1205 may be moved to the bottom of the stroke (which may also be referred to as the dispensing position), where the volume of the dispensing portion 1102 is at its minimum and the volume of the recovery portion 1104 is at its maximum. Fluid may thus be pumped out from the dispensing portion 1102 through a dispensing channel 1209 to a dispensing outlet 1210 (which may be a fluid outlet for dispensing fluid from the pump 210), and fluid (e.g., vapors) may be recovered from the destination vessel 10 through a recovery channel 1106 into the recovery portion 1104 of the pump chamber 1202.

The piston 1205 may be biased to retract from the pump chamber 1202, for example by a piston biasing member 1206. In some examples, the piston 1205 may not be biased, in which case movement of the piston shaft 212 both into and out of the pump chamber 1202 may be facilitated through the application of a force external to the pump 210 (e.g., a manual force at the actuator 220).

The pump 1000 may pump both liquid and vapors (e.g., liquid fuel and fuel vapors) concurrently over each pumping cycle. That is, the pump 1000 may alternate between: i) concurrently pumping liquid out of and vapor in to the pump chamber 1202, and ii) concurrently pumping liquid in to and vapor out of the pump chamber 1202. The pump 1000 may be a self-priming pump.

In greater detail, when the piston 1205 is moved on the down stroke (e.g., when the actuator 220 is moved to its fully actuated position B), the volume of the dispensing portion 1102 is decreased, thus pumping fluid out of the dispensing portion, through a dispensing outlet valve 1112, such as a check valve (e.g., the check valve 300, 400, 500), and through the dispensing channel 1209 (e.g., and subsequently out to the dispenser 30, for example via a conduit such as the hose 40). During this time, a dispensing inlet valve 1110 (e.g., a one-way check valve, such as a ball valve) may be closed (e.g., as shown in FIG. 23) to prevent or inhibit fluid from re-entering the fluid source 20. The decrease in volume of the dispensing portion 1102 may increase the pressure in the dispensing portion 1102 sufficiently to overcome a cracking pressure of the dispensing outlet valve 1112 (e.g., as described above with respect to the check valve 300, 400, 500) to cause the dispensing outlet valve 1112 to open (e.g., as shown in FIG. 23). At the same time, the volume of the recovery portion 1104 is increased, thus drawing fluid (e.g., recovered vapor and/or liquid) through the recovery channel 1106 (e.g., from a vapor recovery dispenser 30, for example via a conduit such as the hose 40, which may be a two-channel hose), past a recovery inlet valve 1108 (e.g., a one-way check valve, such as an umbrella valve) into the recovery portion 1104 of the pump chamber 1202. The increase in volume of the recovery portion 1104 may create a negative pressure (or decrease in pressure) in the recovery portion 1104 sufficient to overcome a cracking pressure of the recovery inlet valve 1108 to cause the recovery inlet valve 1108 to open. A recovery outlet valve 1114 (e.g., a one-way check valve, such as an umbrella valve) may remain closed. When the piston 1205 reaches the bottom of its stroke, the dispensing outlet valve 1112 and/or the recovery inlet valve 1108 may be automatically closed (e.g., due to biasing forces on these valves).

When the piston 1205 is moved on the up stroke (e.g., when the actuator 220 is moved to its unactuated position A and/or when the piston 1205 is biased away by the piston biasing member 1206), the volume of the dispensing portion 1102 is increased, thus drawing fluid (e.g., liquid from the fluid source 20) into the dispensing inlet 1208, past the dispensing inlet valve 1110 into the dispensing portion 1102 of the pump chamber 1202. The dispensing outlet valve 1112 may remain closed (e.g., as shown in FIG. 24). The increase in volume of the dispensing portion 1102 may create a negative pressure (or decrease in pressure) in the dispensing portion 1102 sufficient to open the dispensing inlet valve 1110 (e.g., as shown in FIG. 24). At the same time, the volume of the recovery portion 1104 is decreased, thus pumping fluid out of the recovering portion 1104, through the recovery outlet valve 1114, out of the pump chamber 1202 into the fluid source 20. During this time, the recovery inlet valve 1108 may be closed, to prevent or inhibit fluid from re-entering the recovery channel 1106 from the recovery portion 1104 of the pump chamber 1202. The decrease in volume of the recovery portion 1104 may increase the pressure in the recovery portion 1104 sufficiently to cause the recovery outlet valve 1114 to open. When the piston 1205 reaches the top of its stroke, the recovery outlet valve 1114 and/or the dispensing inlet valve 1110 may be automatically closed (e.g., due to biasing forces on these valves).

The presence of dispensing outlet valve 1112 and recovery inlet valve 1108 may serve to close the pump 1000 and the fluid source 20 from the outside environment when not in use (e.g., between actuation of the actuator 220). Further, the container 200 may not include any vents (e.g., the cap of the container may not include any vents or openings), thus no vapor may be lost to the environment, and the pressure within the container 200 may be maintained. The fluid source 20 may thus provide primary containment of fluid contents. For example, in the event that the dispenser 30 and/or the hose 40 is severed or otherwise opened to the environment, the container 200 may still fully enclose or retain the fluid (including any vapors) and prevent free flow of fluid from the container 200 and/or emission of vapors into the environment. This may provide a safety mechanism against unwanted free flow of fluid from the fluid source 20 should the dispenser 30 and/or the hose 40 become damaged. This safety mechanism may not require a user's manual intervention (e.g., the valves 1112, 1108 may be biased in their respective closed positions), so that a user's neglect to manually engage a safety mechanism (e.g., a manually closed valve) will not result in a risk of unintentional free flow of fluid. Such a safety mechanism may be useful for portable dispensing systems, which may be roughly handled, and which are typically used and maintained by users (e.g., end consumers) who may not be trained in proper usage and safety procedures for such systems.

In some examples, should the dispensing outlet valve 1112 or other valve that mediates dispensing of fluid (e.g., one or more valves of the dispenser 30 and/or hose 40) be closed, such that fluid cannot be dispensed, movement of the piston 1205 to the bottom of the stroke may result in a build-up of pressure in the dispensing portion 1102. For example, failure to engage one or more safety mechanisms in the dispenser 30 may result in valve(s) in the dispenser 30 being closed, or a kink or compression of the hose 40 may result in fluid being inhibited or prevented from reaching the dispenser 30. In such situations, fluid may be inhibited or prevented from being dispensed despite pumping of the piston 1205. Similarly, when the piston 1205 is moved too rapidly (e.g., via too rapid actuation of the actuator 220 such that the flow of fluid past the dispensing outlet valve 1112 is not sufficiently fast to respond to the motion of the piston 1205) or when the pump 1000 is otherwise improperly operated, there may be a build-up of pressure in the dispensing portion 1102. This build-up may cause damage to the pump 1000 or unintentional leakage of fluid from the pump 1000, unless relieved. The piston 1205 may include a bypass valve 1116 that may, when sufficient pressure is built up in the dispensing portion 1102, allow fluid flow from the dispensing portion 1102 directly to the recovery portion 1104. For example, the bypass valve 1116 may be biased (e.g., by a bypass biasing member 1118) towards a closed position. The bypass valve 1116 may be biased sufficiently that the bypass valve 1116 remains closed at normal operating pressures within the dispensing portion 1102. When pressure is built up in the dispensing portion 1102 beyond normal operating pressures, the pressure may be sufficient to overcome the biasing force on the bypass valve 1116, opening the bypass valve 1116 and permitting fluid to flow from the dispensing portion 1102 through the piston 1205 directly into the recovery portion 1104, thereby relieving the excess pressure in the dispensing portion 1102. Any fluid thus bypassed into the recovery portion 1104 may be recovered back into the container 200, for as described above. The pump 1000 may still dispense and recover substantially equal volumes of fluid even when the bypass valve 1116 is engaged. The bypass valve 1116 may thus help to prevent unintentional leakage of fluid from the pump 1000 and damage to the pump 1000 and/or other components of the dispensing system.

The bypass valve 1116 may be designed to be opened at pressures above a certain bypass pressure, which pressure may be selected to avoid damage to components of the pump 1000. For example, where the pump 1000 includes plastic components, normal operating pressure may be in the range of 20-40 psi, and pressures above this range (e.g., pressure above about 32 psi) may cause the bypass valve 1116 to open. Where the affected components are able to withstand greater pressures (e.g., are made of stronger polymers or metal), the cracking pressure to open the bypass valve 1116 may be higher. In some examples, the affected components may be made to withstand very high pressures or forces (e.g., components may be made of metal) and the pump 1000 may not include a bypass valve 1116.

The dispensing outlet valve 1112 may be designed to have a cracking pressure (e.g., about 8-20 psi) that is lower than the cracking pressure of the bypass valve 1116, such that in normal operation fluid may be pumped out through the dispensing outlet valve 1112 and the bypass valve 1116 may remain closed.

The dispensing outlet valve 1112 and the recovery inlet valve 1108 may permit flow from and to the container 200 when the pump 1000 is being pumped. Unintentional flow of fluid from the container 200 (e.g., due to build up of pressure within the container 200 caused by vapor pressure of the contained fluid, such as during hot days) may be prevented by the dispensing outlet valve 1112 and the recovery inlet valve 1108.

The dispenser 30 may be any suitable dispenser, for example any suitable vapor-recovery dispenser. For example, the dispenser described in U.S. provisional patent applications Nos. 61/147,761 filed Jan. 28, 2009 and 61/454,656 filed Mar. 21, 2012; and U.S. patent applications Ser. No. 12/696,030 filed Jan. 28, 2010; Ser. No. 12/696,041 filed Jan. 28, 2010 and Ser. No. 12/696,045 filed Jan. 28, 2010, the entireties of which are hereby incorporated by reference, may be suitable.

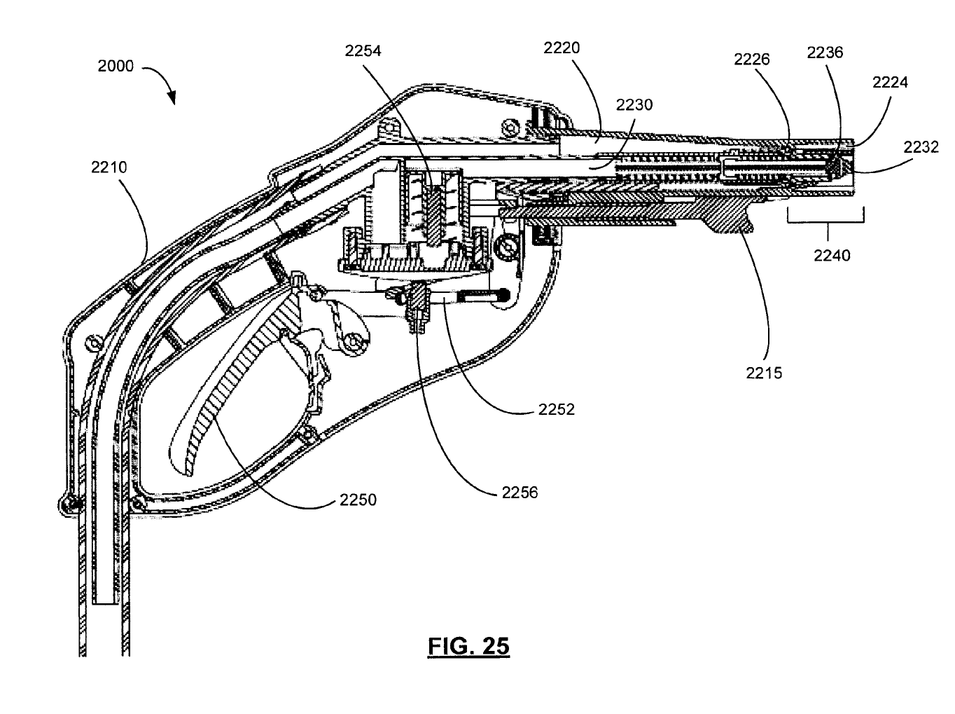

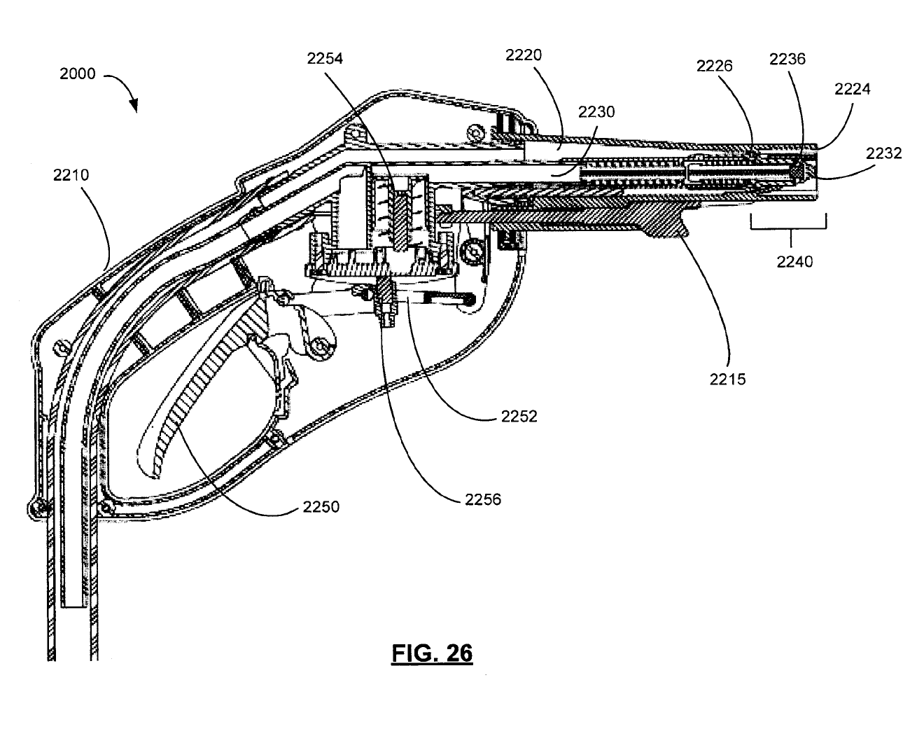

FIGS. 25-29 show sectional views of an example dispenser 2000, which may serve as the dispenser 30. The dispenser 2000 may be a vapor recovery dispenser 2000, in which liquid (e.g., liquid fuel) may be delivered concurrently with recovery of fluid (e.g., vapors such as fuel vapors and/or liquids such as liquid fuel).

A dispenser 2000 may, for example, include a housing 2210 having at least one each of a fluid delivery passage 2220 and a fluid recovery passage 2230. In some examples, the fluid delivery passage 2220 and the fluid recovery passage 2230 may also be referred to as fluid carrying conduits. One or more fluid delivery passages 2220 may be in fluid communication with the source 20, 200 via the hose 30 and the fluid pump 210, 1000, 22. A fluid delivery passage 2220 may have at least one fluid delivery inlet for receiving fluid from the source 20, 200 and at least one fluid delivery outlet 2224 for delivering fluid to the destination vessel 10. A fluid recovery passage 2230 may also be in fluid communication with source 20, 200 via hose 30 and the fluid pump 210, 1000, 22. A fluid recovery passage 2230 may have at least one fluid recovery inlet 2232 for receiving excess fluid from the destination vessel 10 and a fluid recovery outlet for delivering excess fluid to the source 20, 200. The fluid delivery outlet 2224 and fluid recovery inlet 2232 may be positioned at or near the end of a spout 2240, the spout 2240 being at or near a distal end of the dispenser 2000, and may be configured to be insertable into an inlet of the destination vessel 10. The dispenser 2000 may also include an actuator 2250 (e.g., a manually-operated trigger) for controlling fluid delivery and/or recovery.

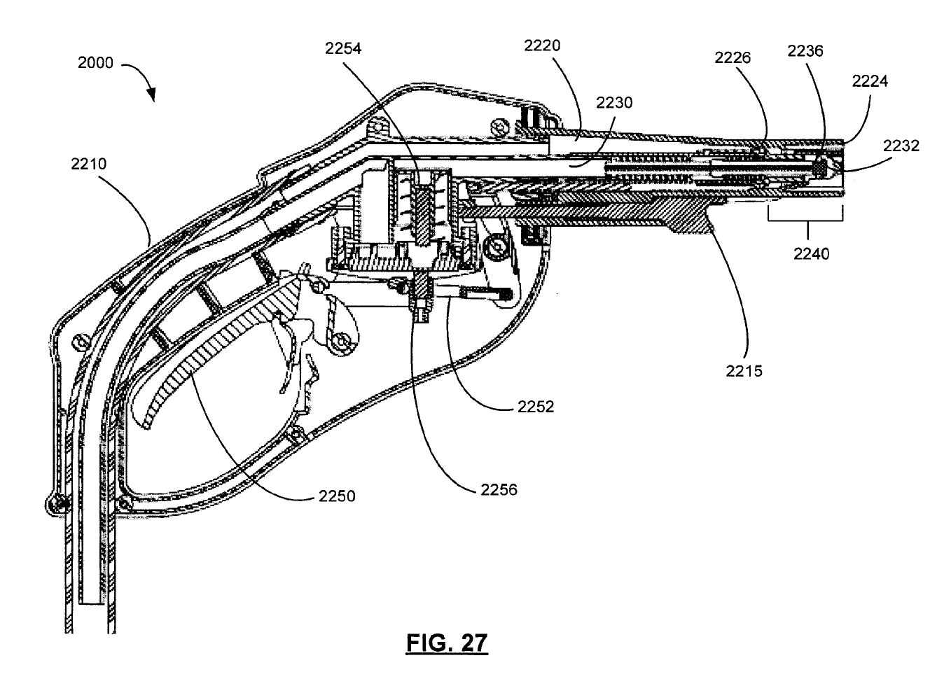

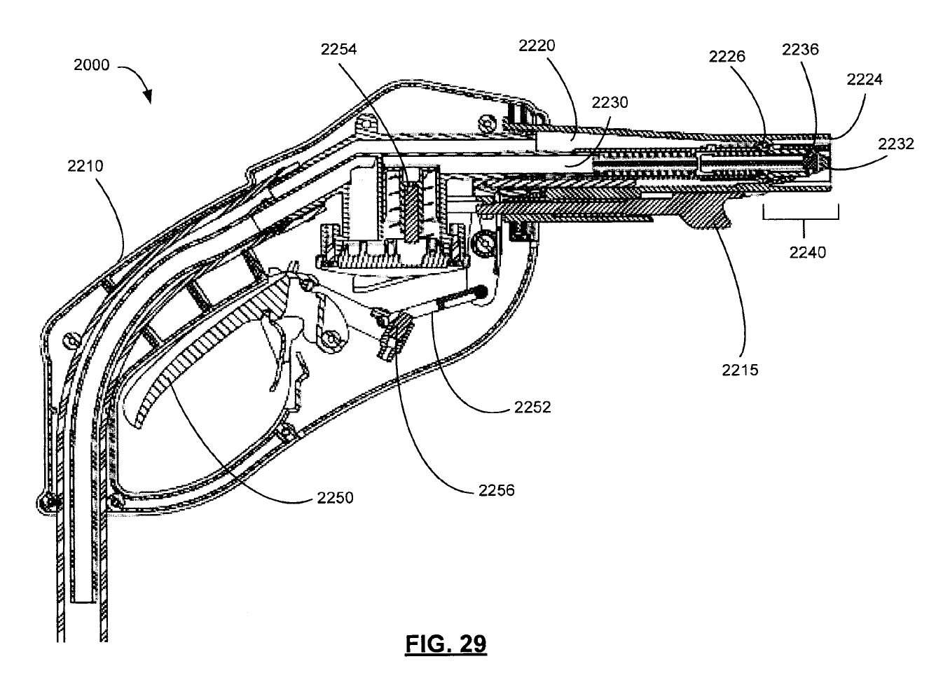

The dispenser 2000 may also include a safety trigger 2215 (e.g., in the form of a safety hook) that may help to ensure that fluid is delivered only when the spout 2240 is sufficiently inserted into a destination vessel 10. The safety trigger 2215 may be biased towards the distal end of the spout 2240 in its unactuated position and may be actuated away from the distal end of the spout 2240. The safety trigger 2215 may be coupled to a linkage 2252 (e.g., formed of one or more linkage members) of the dispenser 2000 that may be moveable to facilitate or inhibit flow of fluid through the dispenser 2000. The linkage 2252 may be configured in an enabling configuration (e.g., as shown in FIG. 26) to facilitate actuation of one or more valves (described below) by the actuator 2250, or may be configured in a disabling configuration (e.g., as shown in FIG. 28) to inhibit actuation of the valve(s) by the actuator 2250. In this way, the safety trigger 2215 may serve to prevent unintentional dispensing of fluid from the dispenser 2000 when the dispenser 2000 is not properly inserted into a destination vessel 10, and may also help to ensure that the valve(s) of the dispenser 2000 are properly closed, to prevent dispensing of fluid, when the dispenser 2000 is removed from the destination vessel 10.

Fluid delivery passage(s) 2220 and fluid recovery passage(s) 2230 may be disposed in any suitable relationship with respect to each other. For example, they may be disposed in a co-axial or concentric arrangement, so that one or more of the first type is disposed inside one or more of the other. For example, as shown in FIGS. 25-29, the fluid recovery passage 3230 may be provided concentrically inside the fluid delivery passage 2220. In other examples, the fluid delivery passage 2220 may be provided inside the fluid recovery passage 2230. In other examples, a plurality of one type of passage 2220, 2230, may be disposed inside the other, with a general co-axial or concentric arrangement (not shown). In other examples, one or more of one type of passage 2220, 2230, may be disposed inside the other, in an off-center or irregular configuration. Providing one or more of passages 2220, 2230 within the other may allow the outer passage (e.g., the fluid delivery passage 2220) to provide structural support to the inner passage (e.g., the fluid recovery passage 2230). This may allow the inner passage to be relatively less robust (e.g., made of less rigid material and/or having thinner passage walls), which may be useful for reducing the total weight of the dispenser 2000 and/or for reducing the cost of manufacturing the dispenser 2000. Concentric arrangement of passages 2220, 2230 may result in further efficiencies, through the use, for example, of one or more common passage walls. In some examples, the delivery and recovery passages 2220, 2230 may have separate and distinct pathways and there may be no fluid communication between the two, or slight fluid leakage between the two may be allowed.

In other examples, the fluid delivery passage 2220 and the fluid recovery passage 2230 may be separate from each other. For example, one or more fluid delivery passages 2220 and fluid recovery passages 2230 may be adjacent to each other, such as in a bundled or other tangential configuration. In some examples, the walls of one or more fluid delivery passages 2220 and fluid recovery passages 2230 may not be in contact with the walls of the other passages 2220, 2230.

The fluid delivery passage 2220 may be provided with a first valve 2226 for mediating or controlling flow of fluid through the fluid delivery passage 2220. The first valve 2226 may have an opened configuration permitting flow of fluid through the fluid delivery passage 2220 (e.g., permitting flow of fluid out of the fluid delivery outlet 2224) and a closed configuration inhibiting flow of fluid through the fluid delivery passage 2220 (e.g., inhibiting flow of fluid out of the fluid delivery outlet 2224). The first valve 2226 may be biased in the closed configuration, for example by a biasing member, to inhibit flow of fluid out of the fluid delivery outlet 2224. The first valve 2226 may be user releasable from its closed configuration to its opened configuration. The first valve 2226 may be directly or indirectly released by a user, including, for example, via mechanical (e.g., via the actuator 2250) or electrical mechanisms.

The fluid recovery passage 2230 may be provided with a second valve 2236 for mediating or controlling flow of fluid through the fluid recovery passage 2230. The second valve 2236 may have an opened configuration permitting flow of fluid through the fluid recovery passage 2230 (e.g., permitting flow of excess fluid into the fluid recovery inlet 2232) and a closed configuration inhibiting flow of excess fluid through the fluid recovery passage 2230 (e.g., inhibiting flow of excess fluid into the fluid recovery inlet 2232). The second valve 2236 may be biased in the closed position, for example by a biasing member, to inhibit flow of excess fluid into the fluid recovery inlet 2232. The second valve 2236 may be user releasable from its closed configuration to its opened configuration. The second valve 2236 may be directly or indirectly released by a user, including, for example, via mechanical (e.g., via the actuator 2250) or electrical mechanisms.

Although other positions are possible for the first valve 2226 and the second valve 2236, it may be desirable to position the first valve 2226 and the second valve 2236 relatively distal, near or at the dispensing end of the spout 2240, to help reduce the amount of potentially lost fuel that may be trapped between the closed first and second valves 2226, 2236 and the end of the spout 2240.

The actuator 2250 (e.g., a manually-operated trigger) may be operatively coupled to a first valve 2226 and a second valve 2236 (e.g., via the linkage 2252) to move the first valve 2226 and the second valve 2236 from their respective closed configurations to their respective opened configurations. When both the first valve 2226 and the second valve 2236 are in their respective closed configurations, a closed configuration for the dispenser 2000 may be defined. When both the first valve 2226 and the second valve 2236 are in their respective opened configurations, an opened configuration for the dispenser 2000 may be defined. The dispenser 2000 may also include intermediate configurations, for example where one of the first and second valves 2226, 2236 is opened and the other is closed. Such intermediate configurations may be transitory, for example as the actuator 2250 is being actuated.

Although the dispenser 2000 is described as having first and second valves 2226, 2236, in some examples there may be more or less valves (e.g., corresponding to more or less fluid conduits in the dispenser 2000). The valve(s) may close off the dispenser 2000 from the outside environment, when not in use. In this way, the dispenser 2000 may provide secondary containment of fluid contents within the dispensing system. As described in WO 2010/085884 and PCT/CA2012/000261, for example, the dispenser 2000 may include one or more safety mechanisms, such as the safety trigger 2215, and one or more deactivation mechanism, such as a linkage system 2252 responsive to overflow of the destination vessel 10.

A fluid dispensing system may include the container 200 with the pump 210, 1000, the dispenser 2000 and the hose 40. FIG. 25 illustrates an example of the dispenser 2000 when it is not in use. The safety trigger 2215 is biased towards the spout 2240, which position may cause the linkage 2252 to be in a disabling configuration, in which operation of the actuator 2250 may not open up the valve(s) 2226, 2236. This may prevent accidental dispensing of fluid when the dispenser 2000 is not fully inserted into the destination vessel 10, for example.

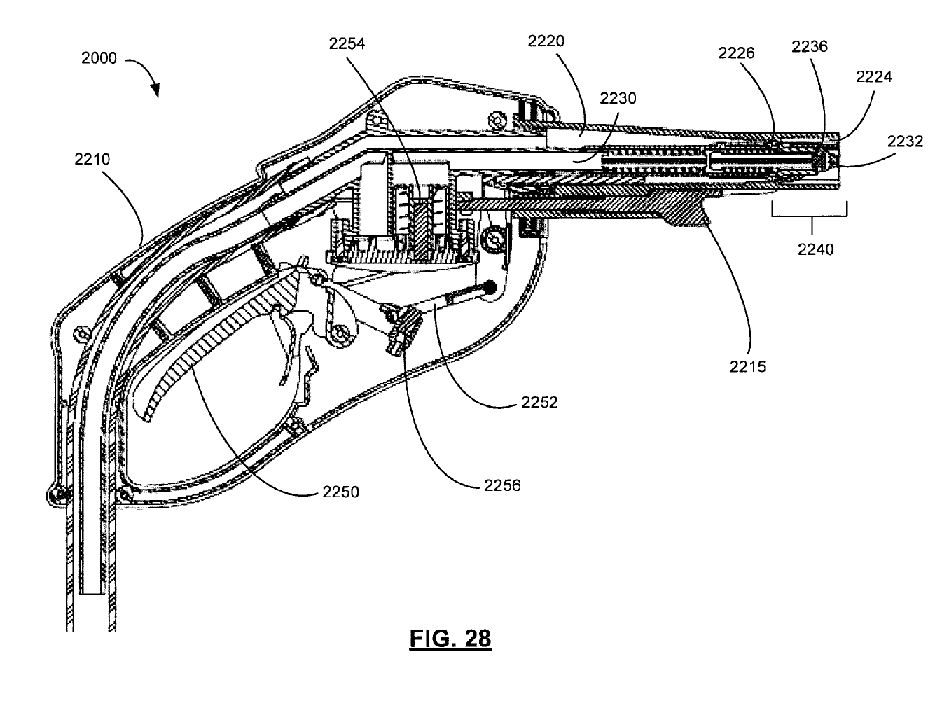

In use, a user may insert the spout 2240 of the dispenser 2000 into an inlet of a destination vessel 10 to a sufficient depth to fully depress the safety trigger 2215 of the dispenser 2000 (e.g., as shown in FIG. 26), causing the linkage 2252 to be configured to an enabling configuration, in which actuation (e.g., manually squeezed by a user) of the actuator 2250 may open the valve(s) 2226, 2236 (e.g., as shown in FIG. 27). The user may then actuate the actuator 220 of the pump 210, 1000 to cause fluid to be pumped from the container 200 and dispensed into the destination vessel 10. Fluid (e.g., liquid fuel) may then be dispensed from the fluid delivery outlet 2224 via the fluid delivery passage 2220, and fluid (e.g., fuel vapors) may be recovered into the fluid recovery inlet 2232 back into the container 200.

During pumping of the pump 210, 1000, the volume of fluid dispensed from the container 200 may be substantially equal to the volume of fluid recovered into the container 200. Should liquid level in the destination vessel 10 reach the spout 2240, the liquid may be recovered by the dispenser 2000 back into the container 200 at substantially the same rate as fluid being dispensed from the dispenser 2000, thereby preventing overflow of the destination vessel 10. When the user stops actuating the actuator 220, the piston 1205 may be biased back to the top of its stroke, and the dispensing outlet valve 1112 and the recover inlet valve 1108 may close, stopping fluid flow to the dispenser 30. Release of the dispenser actuator may also close the dispenser valve.

The dispenser 2000 may also include an auto-deactivation mechanism, by which dispensing of fluid is inhibited when fluid in the destination vessel 10 reaches a certain level, for example, when fluid in the destination vessel 10 reaches a level that allows liquid to enter and/or block the fluid recovery inlet 2232. A deactivation piston 2254 may be responsive to the blockage of the fluid recovery inlet 2232. For example, blockage of the fluid recovery inlet 2232 may lead to a change in pressure within the fluid recovery passage 2230 that the deactivation piston 2254 may be responsive to. The deactivation piston 2254 may then move into a deactivation position (e.g., towards the linkage 2252), causing the linkage 2252 to move or be configured to a disabling configuration (e.g., as shown in FIG. 28). For example, the deactivation piston 2254 may include a magnet that opposes a magnetic member 2256 in the linkage 2252, such that when the deactivation piston 2254 moves to the deactivation position, the magnetic member 2256 is repelled and the linkage 2252 is moved to the disabling configuration. The valve(s) 2226, 2236 may thus be able to return to their respective closed positions (e.g., due to biasing forces on the valve(s) 2226, 2236) and dispensing of fluid from the dispenser 2000 may be stopped. This may help to prevent overflowing of fluid from the destination vessel 10. The deactivation piston 2254 may be able to return to its initial position (e.g., due to a biasing force on the piston 2254). Releasing the actuator 2250 may enable the linkage 2252 to return to its enabling configuration.

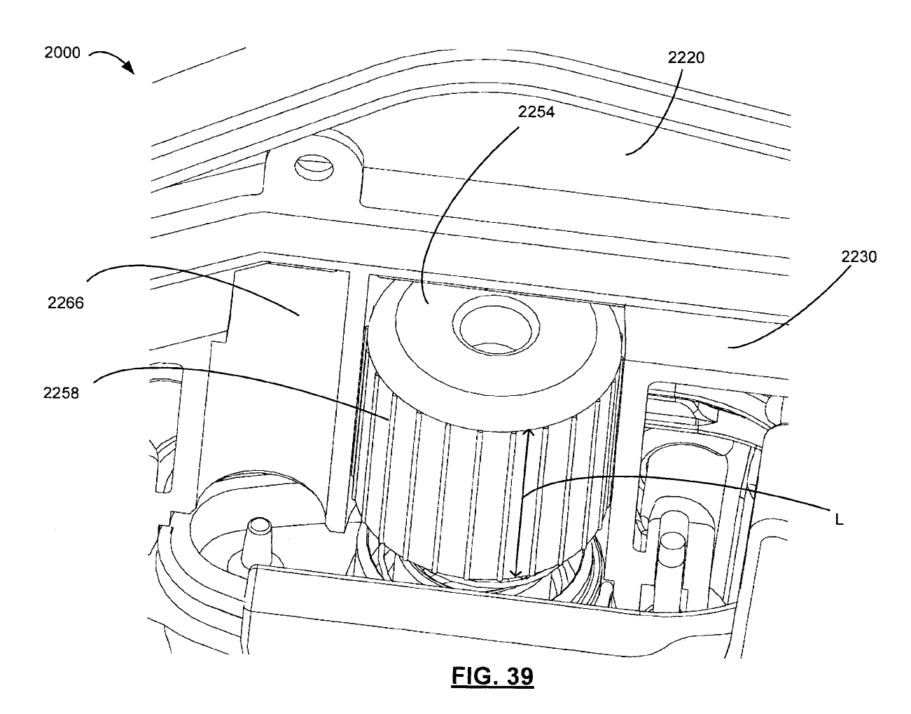

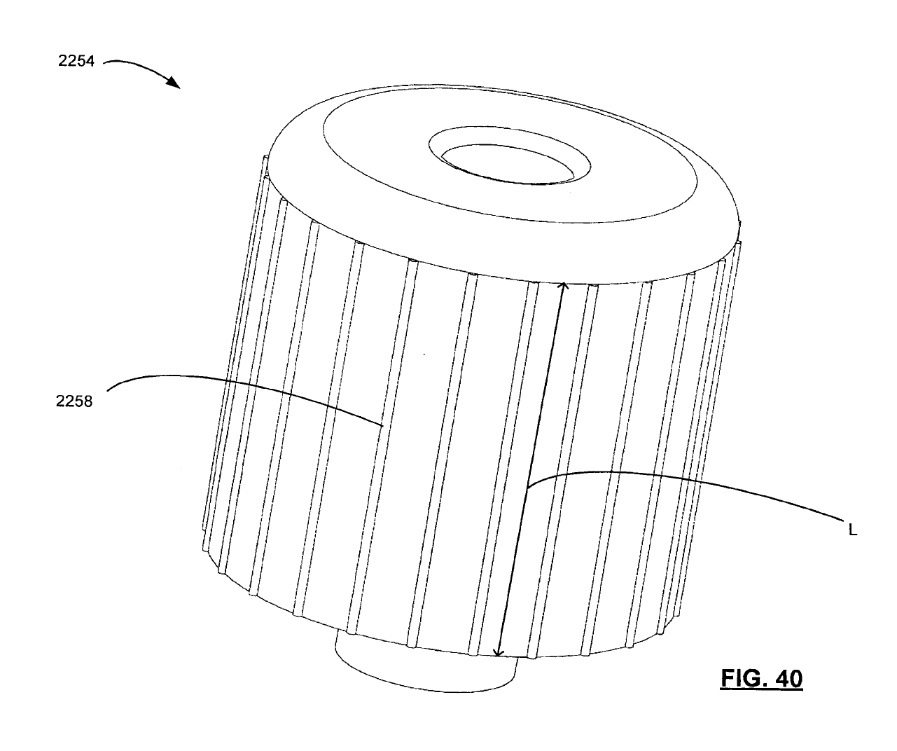

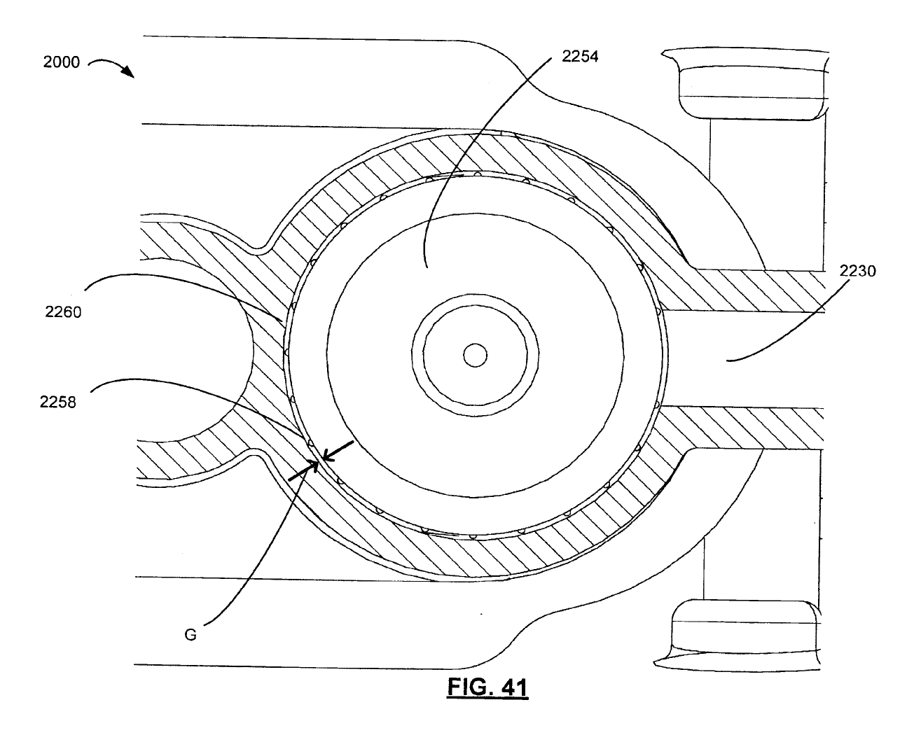

The auto-deactivation mechanism may help to prevent unintentional overflow of the destination vessel 10, by stopping fluid flow from the dispenser 2000 when liquid in the destination vessel 10 reaches a certain level. The auto-deactivation mechanism may also serve as a flame arrester. Further description of the auto-deactivation mechanism will make reference to FIGS. 38-44.

The inclusion of a flame arrester feature in the dispenser 2000 may help to prevent a flame from advancing further down the fluid recovery passage 2230, thus preventing the flame from entering the pump 210, 1000, 22 and the container 200, 20 where there might be a risk of an explosion. This may be less of a concern for the fluid delivery passage 2220, which is typically filled with liquid fuel, since a flame requires a mixture of fuel and air to advance that thus should not advance through liquid fuel.

A flame arrester may work by limiting the air channel that a flame may propagate through. In the example dispenser 2000, the deactivation piston 2254 may be designed to fit in the fluid recovery passage 2230 and cooperate with the fluid recovery passage 2230 to define one or more channels between the exterior surface of the deactivation piston 2254 and the interior wall of the fluid recovery passage 2230.

The deactivation piston 2254 may include one or more ribs 2258 protruding about the exterior surface of the deactivation piston 2254 and along the longitudinal axis of the piston 2254. When the deactivation piston 2254 is fitted into the fluid recovery passage 2230, the ribs 2258 may abut the wall of the fluid recovery passage 2230 (e.g., to provide a slip fit), such that one or more fluid channels 2260 are defined between the deactivation piston 2254 and the wall of the fluid recovery passage 2230. The rib(s) 2258 may be evenly spaced, to create fluid channel(s) 2260 that are substantially equal in width, depth and/or length, and evenly spaced about the deactivation piston 2254. The fluid channel(s) 2260 may be dimensioned to enable fluid recovery through the fluid recovery passage 2230 while inhibiting propagation of a flame. The ratio of the gap G between the deactivation piston 2254 and the fluid recovery passage 2230 to the length L of the fluid channel(s) 2260 may be selected to inhibit propagation of a flame. The gap G may also be referred to as the depth of the channel(s) 2260. The gap G of the channel(s) 2260 may be determined by the amount by which the rib(s) 2258 protrude from the exterior surface of the deactivation piston 2254. The dimensions selected to inhibit propagation of a flame may be dependent on the type of fluid (e.g., the type of fuel, such as propane, methane, and gasoline, among others), potential pressure front generated by an advancing flame, expected flame speed, expected flame temperature and/or time duration that the flame arrested is expected to be exposed to the flame source. There may also be regulations and/or industry guidelines governing the design, for example the Maximum Experimental Safe Gap (MESG) may be an industry-recognized value of the smallest gap of a channel in order to support a flame for a given gas or gas mixture. The gap G of the fluid channel(s) 2260 may be designed to be equal to or smaller than the MESG for a given fuel. For example, in the case of gasoline, the MESG may be about 90 mm (0.035″) and the fluid channel(s) 2260 may be designed to have a gap G of about 50 mm (0.019″). The selection of the length L may be based on the same or other factors. For example, the length L of the fluid channel(s) 2260 may be about 1.0″. Other dimensions may be used, as appropriate.

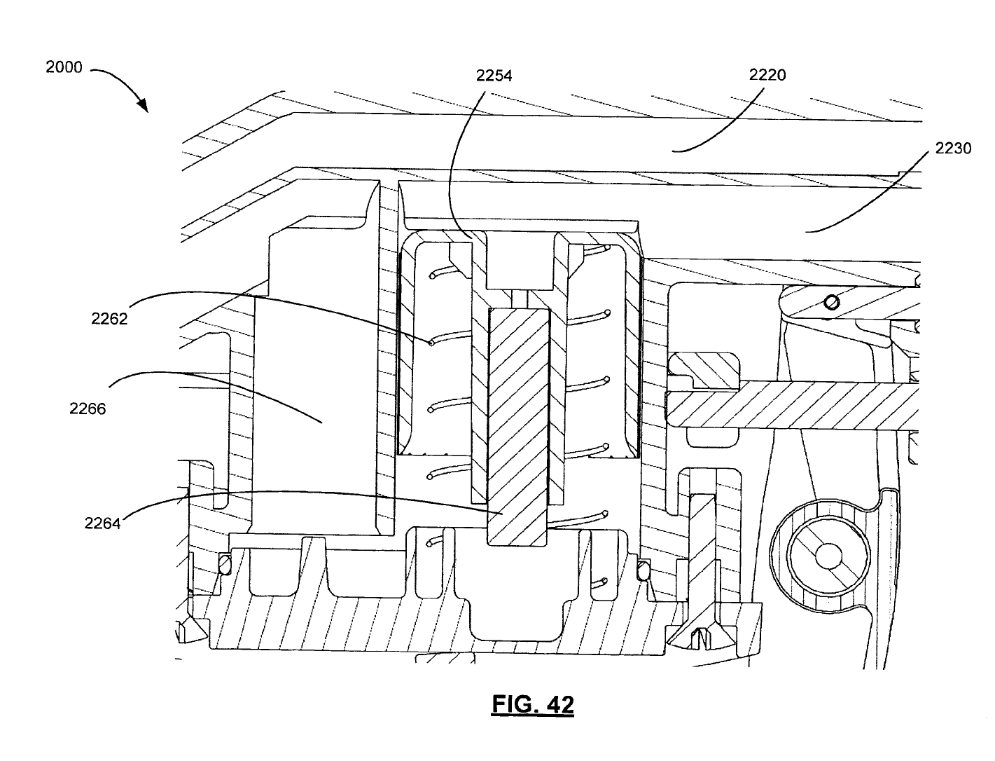

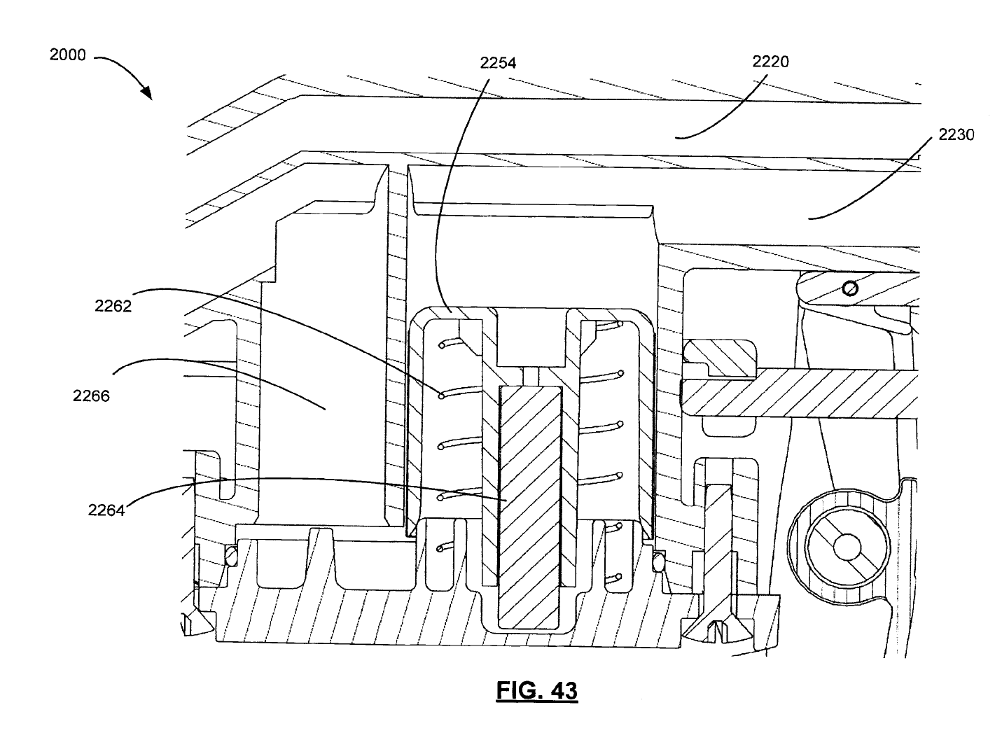

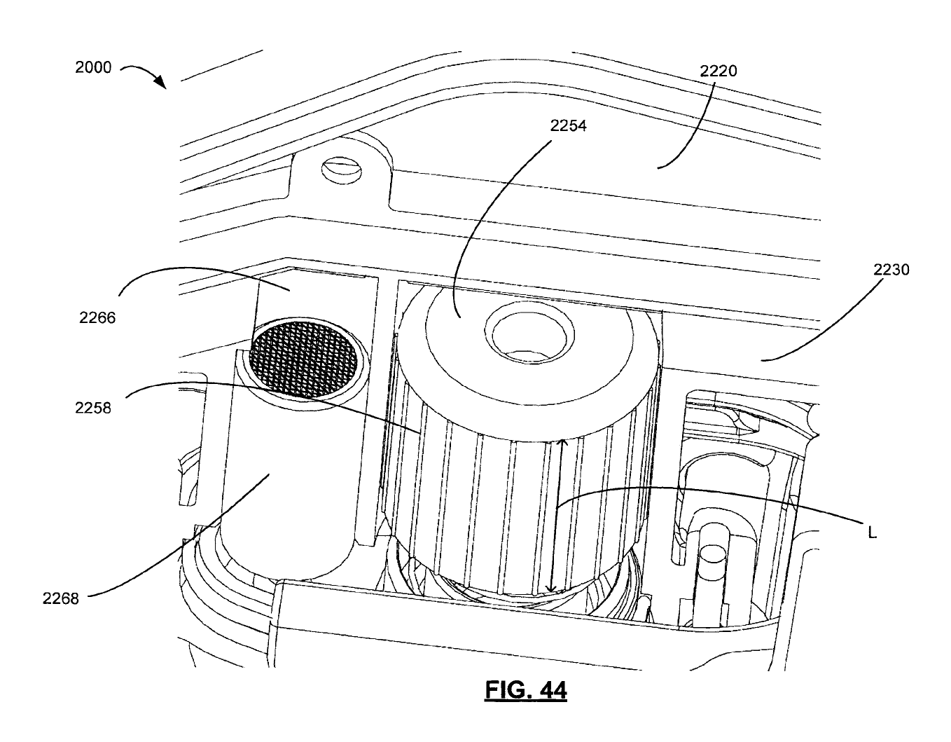

A cross-sectional view of the deactivation piston 2254 is shown in FIGS. 42 and 43. In FIG. 42, the deactivation piston 2254 is biased (e.g., by a biasing member 2262) in its initial position, in which a magnetic member 2264 in the deactivation piston 2254 is biased away and kept from repelling the magnetic member 2256 of the linkage 2252. In the event that a flame enters the fluid recovery inlet 2232 (e.g., due to ignition of fuel vapors), the deactivation piston 2254 may be moved to the deactivation position (as shown in FIG. 43) due to the pressure wave created by the advancing flame in the fluid recovery passage 2230. This moves the magnetic member 2264 of the deactivation piston 2254 towards the magnetic member 2256 of the linkage 2252, repelling the magnetic member 2256 of the linkage 2252 and causing the linkage 2252 to be moved to the disabling configuration. This prevents further dispensing of fluid from the dispenser 2000. When the deactivation piston 2254 is moved from its initial position to its deactivation position, the length L of the fluid channel(s) 2260 is maintained, such that a flame is inhibited from advancing through the fluid channel(s) 2260.

In some examples, there may be a secondary flame arrester recess 2266 defined in the fluid recovery passage 2230 for holding a secondary flame arrester 2268 (which may be conventional off-the-shelf flame arrester that is sized to fit in the dispenser 2000, for example having a length of about 1 inch and a diameter of about 0.5 inch and having internal layers of corrugated material to create multiple air channels within the arrester). The secondary flame arrester 2268 may be placed in the secondary flame arrester recess 2266 such that recovered fluid may flow through the secondary flame arrester 2268 after passing through the fluid channel(s) 2260. The use of a secondary flame arrester 2268 may provide redundancy (e.g., for additional safety) and may also allow the deactivation piston 2254 to be designed to not provide flame arresting features or for the deactivation piston 2254 to be removed (e.g., for redesign purposes).

While dispensing fluid from the dispenser 2000, the spout 2240 may be removed from the destination vessel 10 such that the safety trigger 2215 is no longer engaged against the destination vessel 10. The safety trigger 2215 may move towards the spout 2240 (e.g., due to a biasing force on the safety trigger 2215), causing the linkage 2252 to move to the disabling configuration. The valve(s) 2226, 2236 may thus be able to return to their respective closed positions (e.g., due to biasing forces on the valve(s) 2226, 2236) and dispensing of fluid from the dispenser 2000 may be stopped. This may help to prevent accidental spillage of fluid in the event that the dispenser 2000 is removed from the destination vessel 10 while the filling or refueling process is still in progress. Releasing the actuator 2250 may enable the linkage 2252 to return to its enabling configuration.

Dispensing of liquid from the system may be stopped when the user releases the dispenser actuator 2250, thereby closing the valve(s) 2226, 2236 of the dispenser 30, 2000. For example, where the dispenser 30, 2000 is capable of vapor recovery, both liquid and vapor valves may be closed.

Dispensing of fluid from the system may also be stopped when the user stops actuation of the actuator 220 of the pump 210, 1000, 22. One or more check valves of the pump 210, 1000, 22 may automatically close, thereby stopping flow of fluid from the pump 210, 1000, 22.

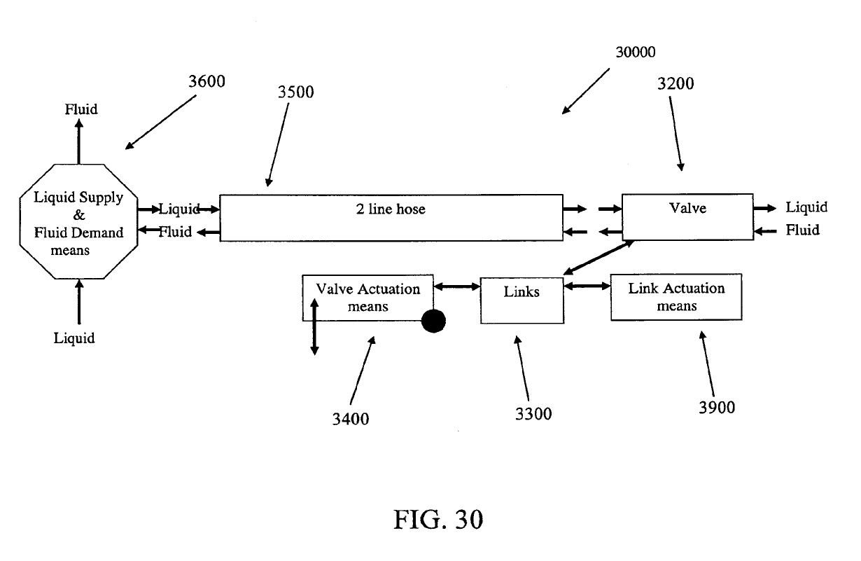

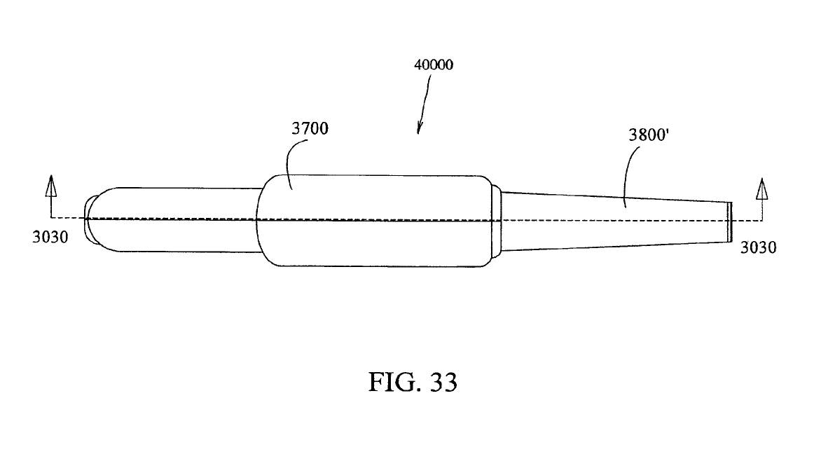

An example nozzle is described in U.S. patent applications Ser. Nos. 12/696,030, 12/696,045, 12/696,041, the entireties of which are hereby incorporated by reference. An example is illustrated in FIGS. 30-37.

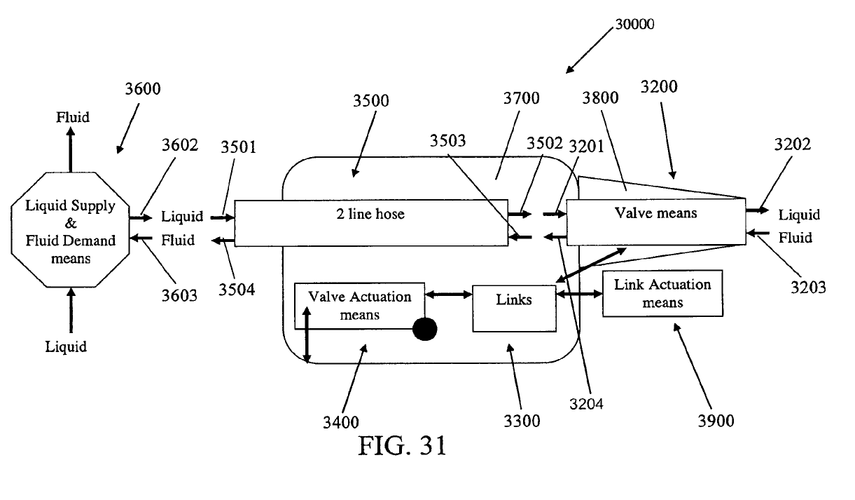

FIGS. 30 and 31 show a flow diagram of an example nozzle. The nozzle 30000 may be for delivering liquid from a liquid source to a destination container, recovering vapor from the destination container, recovering liquid from the destination container upon the liquid within the destination container having risen to cover the inlet of the nozzle's fluid recovery means. The spill-proof nozzle may comprise of an openable and closeable valve means 3200, a linkage means 3300, a linkage actuation means 3900 (or hook) and a valve actuation means 3400. The spill-proof nozzle may be connectable and for use with a two line hose means 3500 and a liquid supply and fluid demand means 3600.

The two line hose means 3500 may be for receiving liquid from the liquid supply and fluid demand means 3600 and delivering said liquid to the openable and closable valve means 3200. Also, the two line hose means 3500 may be for receiving fluid from the openable and closable valve means 3200 and delivering fluid to the liquid supply and fluid demand means 3600. The two line hose means 3500 may include a liquid-receiving inlet 3501, a liquid-delivery outlet 3502, a fluid-receiving inlet 3503, and a fluid-delivery outlet 3504. In use, the two line hose means 3500 may be in fluid communication with the openable and closable valve means 3200 and the liquid supply and fluid demand means 3600.

The openable and closable valve means 3200 may include a liquid-receiving inlet 3201, a liquid-delivery outlet 3202, a fluid-receiving inlet 3203 and a fluid-conveying outlet 3204. The openable and closable valve means 3200 may be connected in fluid communication at its liquid-receiving inlet 3201 to the liquid-delivery outlet 3502 of the two line hose means 3500 so as to receive liquid from the liquid supply and fluid demand means 3600. The openable and closable valve means 3200 may be for controlling the flow of fluid through the spill-proof nozzle 30000. The openable and closable valve means 3200 may include a liquid-delivery outlet 3202 so as to deliver liquid to the destination container (not specifically shown). A fluid-receiving inlet 3203 may receive fluid from the destination container. The openable and closable valve means 3200 may be connected in fluid communication at its fluid-conveying outlet 3204 to the fluid-receiving inlet 3503 of the two line hose means 3500 so as to convey fluid to the liquid supply and fluid demand means 3600. A basic form of the liquid delivery conduit may be the liquid delivery channel through the openable and closable valve means 3200 between the liquid-receiving inlet 3201 and liquid-delivery outlet 3202 as well, a basic form of the vapor and liquid recovery conduit may be the fluid recovery channel through the openable and closable valve means 3200 between the fluid-receiving inlet 3203 and fluid-conveying outlet 3204. Additionally, the vapor and liquid recovery conduit may be non-bifurcated although variations may be possible.

A manually operable valve actuation means 3400 may be for permitting selective operation of the openable and closable valve means 3200 between the valve-closed configuration and the valve-open configuration. The manually operable valve actuation means 3400 may be movable between a rest position and at least one in-use position. The in-use positions may be actually a continuum of in-use positions corresponding to the openable and closable valve means 3200 being open to a lesser or greater degree.

The linkage means 3300 may operatively connect the manually operable valve actuation means 3400 and the openable and closable valve means 3200. The linkage means 3300 may be configurable between a disabled configuration and a bias enabled configuration such that when the linkage means 3300 is in the enabled configuration, the manually operable valve actuation means 3400 may control the openable and closable valve means 3200 and when the linkage means 3300 is in the disabled configuration the manually operable valve actuation means 3400 may be precluded from controlling the openable and closable valve means 3200, until the linkage means 3300 is reset to its enable configuration.

The linkage actuation means 3900 may also control the openable and closable valve means 3200 by closing the openable and closable valve means 3200. The linkage actuation means 3900 may be operatively connected to the linkage means 3300 such that the linkage actuation means 3900 may be for configuring the linkage means 3300 between the disabled configuration and the enabled configuration. The linkage actuation means 3900 may configure the linkage means 3300 from the disabled configuration to the enabled configuration in response to the nozzle being position in the proper filling orientation, wherein the proper filling orientation may be such that the liquid-dispensing outlet 3202 and the fluid-receiving inlet 3203 are disposed within the inlet opening of the destination container. As well, the linkage actuation means 3900 may configure the linkage means 3300 from the enabled configuration to the disabled configuration in response to the nozzle being removed from the proper filling orientation thus closing the openable and closable valve means 3200. Disabling the linkage means 3300 may allow the openable and closable valve means 3200 to return to its biased valve-closed configuration and the manually operable valve actuation means 3400 may be precluded from controlling the openable and closable valve means 3200 until the linkage means 3300 is reset to its enable configuration.

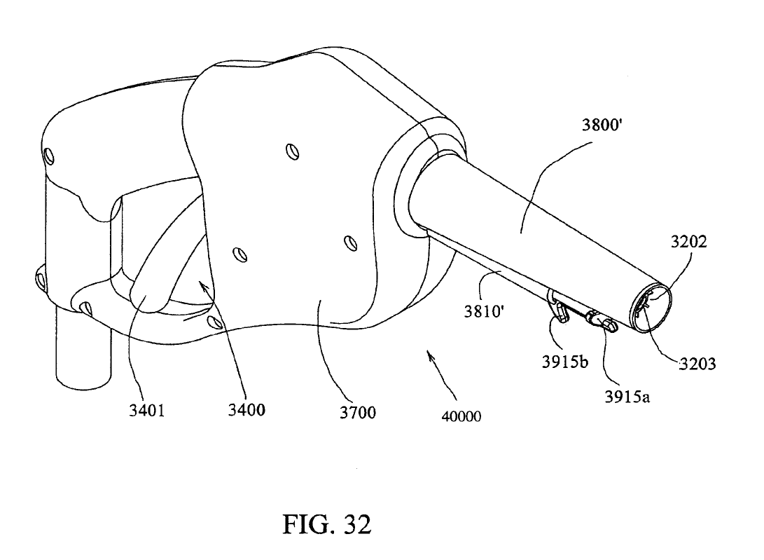

FIGS. 32-37 show an example nozzle 40000 for delivering liquid from a liquid source to a destination container, recovering vapor from the destination container and recovering liquid from the destination container upon the liquid within the destination container having risen to cover the inlet of the nozzle's fluid recovery means. The spill-proof nozzle 40000 may comprise of a manifold means 3050, an openable and closable valve means 3200, a linkage means 3300, a linkage actuation means 3900 and a trigger means 3400. The spill-proof nozzle may be connectable with a two-line hose means 3500 and a liquid-supply and fluid-demand means 3600.

The two line hose means 3500 may be for receiving liquid from the liquid-supply and fluid-demand means 3600 and delivering liquid to the manifold means 3050. Also, the two line hose means 3500 may be for receiving fluid from the manifold means 3050 and delivering fluid to the liquid-supply and fluid-demand means 3600. The two line hose means 3500 may include a liquid-receiving inlet 3501, a liquid-delivery outlet 3502, a fluid-receiving inlet 3503, and a fluid-delivery outlet 3504. In use, the two line hose means 3500 may be in fluid communication with the manifold means 3050 and the liquid-supply and fluid-demand means 3600.

The openable and closable valve means 3200 may include a liquid-receiving inlet 3201, a liquid-delivery outlet 3202, a fluid-receiving inlet 3203 and a fluid-conveying outlet 3204. The openable and closable valve means 3200 may be connected in fluid communication at its liquid-receiving inlet 3201 to the liquid-delivery outlet of the manifold means 3050 so as to receive liquid from the liquid supply and fluid demand means 3600. The openable and closable valve means 3200 may be for controlling the flow of fluid through the spill-proof nozzle 40000. The openable and closable valve means 3200 may include a liquid-delivery outlet 3202 so as to deliver liquid to the destination container (not specifically shown). A fluid-receiving inlet 3203 may receive fluid from the destination container. The openable and closable valve means 3200 may be connected in fluid communication at its fluid-conveying outlet 3204 to the fluid-receiving inlet of the manifold means 3050 so as to convey fluid to the manifold means 3050.

In the example shown, a manually operable trigger means 3400 is operatively connected to the openable and closable valve means 3200 via a linkage means 3300 and is for permitting selective operation of the openable and closable valve means 3200 between the valve-closed configuration and the valve-open configuration. The manually operable trigger means 3400 is movable between a rest position and at least one in-use position. The in-use positions are actually a continuum of in-use positions corresponding to the openable and closable valve means 3200 being open to a lesser or greater degree. The manually operable trigger means 3400 is operatively connected to the openable and closable valve means 3200 via linkage means 3300 such that when the linkage means 3300 is in the enable configuration, the manually operable trigger means 3400 can control the openable and closable valve means 3200 and when the linkage means 3300 is in the disable configuration the manually operable trigger means 3400 is precluded from controlling the openable and closable valve means 3200, until the linkage means 3300 is reset to its enable configuration.

The linkage actuation means 3900 is operatively connected to the linkage means 3300 and is movable between a bias disengaged position or start position and an engaged position or actuation position wherein when the linkage actuation means 3900 is in the disengaged position, the linkage means 3300 is disabled such that the manually operable trigger means 3400 is precluded from controlling the openable and closable valve means 3200 and wherein when in the linkage actuation means 3900 is the engaged position, the linkage means is enabled such that the manually operable trigger means 3400 is permitted to control the openable and closable valve means 3200.

In this example, the spill-proof nozzle 40000 is shown to comprise a nozzle body 3700, spout 3800′, two line hose 3500, trigger 3400 and the linkage actuation means 3900. The spout 3800′ has a proximal end 3801′ and a distal end 3802′, and is operatively mounted at its proximal end 3801′ to the distal end of the nozzle body 3700 so as to extend outwardly from the nozzle body 3700. The spout 3800′ is shaped and dimensioned for insertion into the inlet of a destination container and the linkage actuation means 3900 is mounted there to within a co-operating cylindrical guide 3810′ integrally molded to the spout 3800′.

The linkage actuation means 3900 comprises a movable shaft member 3910 and linkage enabler 3920. Where shaft member 3910 has a distal end 3911 and a proximal end 3912 wherein the linkage enabler 3920 is operatively connected to the proximal end 3912. The shaft member 3910 is shown to comprise two engaging means 315a & 3915b on the distal end 3911; a blunt faced engaging means 3915a and a hook shaped engaging means 3915b. The shaft member 3910 is movable within the spouts co-operating cylindrical guide 3810′ between the disengaged position and an engaged position as indicated by arrow “C”

In use, the user would engage one of the linkage actuation means 3900 engaging means 3915a & 3915b on the rim or lip of the destination container's inlet opening, such that the liquid-delivery outlet 3202 and fluid-receiving inlet 3203 are within the destination container (not specifically shown). The user would then push the nozzle towards the destination container so as to move the linkage actuation means 3900 to its engaged position wherein this motion would be directly transferred to a linkage enabler 3920.

The linkage enabler 3920 is mounted in sliding relation on the manifold means 3050 via a tongue and groove arrangement where the tongue 3070 or is an integral feature of the manifold means 3050 and wherein the groove (not specifically shown) is an integral feature of the linkage enabler 3920. The linkage enabler 3920 comprises an angled interface 3930 which interacts with the linkage elbow 3304 so as to alter the configuration of the linkage means 3300 between a disabled configuration and an enabled configuration.

In use, movement of the linkage actuation means 3900 to the engaged position would enable the linkage means 3300 and in turn allow the trigger to control the valve means 3200. Conversely, when the linkage actuation means 3900 is moved to the disengaged configuration, the linkage means 3300 will be configure to the disable configuration and in turn the trigger would be precluded from controlling the valve means 3200.

In this way the spill-proof nozzle 40000 will require the user to position the nozzle in the proper filling orientation such that the spout of the nozzle is inside the inlet opening of the destination container before liquid can be dispensed and if the user did not maintain that proper filling orientation, liquid would be prevented from being dispensed.

In the example shown, there is a liquid-delivery conduit 3706 having a liquid-receiving inlet 3201 and a liquid-dispensing outlet 3202. The liquid-delivery conduit 3706 comprises a liquid-delivery channel through the manifold means 3050 and a liquid-delivery channel 3205 through the openable and closable valve means 3200. The liquid-delivery channel of the manifold means 3050 has a liquid-receiving inlet and a liquid-delivery outlet, which is in fluid communication with the liquid-receiving inlet 3201 of the liquid-delivery channel 3205 of the openable and closable valve means 3200. The openable and closable valve means 3200 controls the conveyance of liquid to the liquid-delivery outlet 3202 of the liquid-delivery conduit 3706. The liquid-delivery conduit 3706 is disposed within the spill-proof nozzle 40000. The spill-proof nozzle 40000 is for use with a two line hose means 3500 with a liquid-delivery outlet 3502 securely connected to the liquid-receiving inlet of the liquid delivery conduit 3706. In use, the two line hose means 3500 is in fluid communication with the liquid delivery conduit 3706, which conveys the liquid from the liquid-supply and fluid-demand means 3600 to the destination container.

There is also a vapor and liquid recovery conduit 3707 for receiving vapor, liquid and/or both vapor and liquid wherein the vapor and liquid recovery conduit 3707 has a fluid-receiving inlet 3203 and a fluid-delivery outlet 3204. The vapor and liquid recovery conduit 3707 comprises a vapor and liquid recovery channel or fluid recovery channel through the openable and closable valve means 3200 and a fluid recovery channel through the manifold means 3050. The openable and closable valve means 3200 controls the conveyance of fluid between the fluid-receiving inlet 3203 and the fluid-conveying outlet 3204, which is in fluid communication with the fluid-receiving inlet of the manifold means 3050. The fluid recovery channel of the manifold means 3050 conveys the recovered fluid to the fluid-delivery outlet which is in fluid communication with the fluid-receiving inlet 3503 of the two line hose means 3500.

In the example shown, the effective area through which the liquid passes through the liquid-delivery conduit 3706 and the effective area through which fluid passes through the vapor and liquid recovery conduit 3707 are substantially equal so as to be capable of conveying substantially equal volumes of liquid and fluid, wherein once the liquid level in the receiving container reaches the fluid-receiving inlet 3203, the liquid level in the receiving container would reach a steady state where the volume of liquid in the receiving container would not increase due to the fact that the liquid being dispensed is being recovered at a substantially equal rate by the fluid the demand means of the liquid supply and fluid demand means 3600. As well if the liquid-delivery conduit 3706 and the vapor and liquid recovery conduit 3707 were separate and distinct the liquid-delivery conduit 3706 and the vapor and liquid recovery conduit 3707 would preferably be substantially equal in cross-sectional area. This is also true of the two line hose means 3500 but the similarity between liquid-delivery conduit 3706 and the vapor and liquid recovery conduit 3707 may not be entirely necessary to the overall embodiment(s) and that a range of varying sizes for both the liquid-delivery conduit 3706 and the vapor and liquid recovery conduit 3707 would allow the spill-proof nozzle 40000 to adequately perform this function.

The cross-sectional area of the liquid delivery conduit may be larger than the cross-sectional area of the liquid and vapor recovery conduit; however, since the liquid and vapor recovery conduit may be disposed within the liquid delivery conduit in the present embodiment, the liquid delivery conduit and the liquid and vapor recovery conduit may be each chosen to have a diameter such that the minimum functional cross-sectional area of the liquid delivery conduit is substantially equal to the minimum functional cross-sectional area of the liquid and vapor recovery conduit.

Alternatively, the openable and closeable valve means 3200 could be positioned between the two line hose means 3500 and the manifold means 3050. The connection location for the liquid-delivery outlet 3502 and fluid-receiving inlet 3503 of the two line hose means 3500 maybe located on the exterior of the nozzle body 3700 in the form of hose connection means or appropriate fittings which would be in fluid communication with the liquid-receiving inlet and fluid-delivery outlet of the manifold means 3050 within the spill-proof nozzle 40000.

In the example shown, the vapor and liquid recovery conduit 3707 is disposed within the liquid delivery conduit 3706. The fluid recovery channel 3206 of the openable and closable valve means 3200 is situated within the liquid delivery channel 3205 while the fluid recovery channel of the manifold means 3050 is also situated within the liquid delivery channel. Further, the two line hose means 3500 comprises a hose within a hose wherein an elongated flexible fluid recovery hose 3506 is situated inside an elongated flexible liquid delivery hose 3505. The fluid-receiving inlet 3203 of the vapor and liquid recovery conduit 3707 is disposed adjacent the liquid-dispensing outlet 3202 of the liquid-delivery conduit 3706 at the distal end 3802′ of the spout 3800′.

Alternatively, the liquid-delivery conduit 3706 and vapor and liquid recovery conduit 3707 as well as the elongated flexible liquid-delivery hose 3505 and the elongated flexible fluid-recovery hose 3506 could be run side by side or in parallel to one another integrally formed or separate individual conduit or hoses respectively. Further, the two line hose means 3500 could comprise a hose within a hose wherein an elongated flexible liquid-recovery hose is situated inside an elongated flexible fluid-delivery hose. Further, the two line hose means 3500 could comprise multiple hoses within hoses. Further, the liquid-delivery conduit 3706 could be situated within the vapor and liquid recovery conduit 3707. Further, the two line hose means 3500 could comprise solid conduit, pipes and like to convey fluids.

In the example shown, openable and closeable valve means 3200 is operatively mounted in the spout 3800 wherein the spout 3800′ acts as the valve body and is an integral part of the openable and closable valve means 3200 wherein a movable flow control means or valve core 3207 is movable and positioned within the spout 3800′. The movable valve core 3207 is tubular in shape and moves independently of the manifold means 3050 wherein the movable valve core 3207 is sealed at its liquid-receiving inlet 3201 in sliding relation within the cylindrical liquid-dispensing outlet of manifold means 3050 by the o-ring 3208 creating a leak proof seal. The openable and closable valve means 3200 is for simultaneously controlling both the flow of liquid through the liquid delivery conduit and the flow of vapor and liquid through the vapor and liquid recovery conduit of the spill-proof nozzle 40000. The openable and closeable valve means 3200 as illustrated is a telescopic style axial flow type openable and closeable valve, which is shown to be biased in a valve-closed configuration by biasing means 3209. The flow of liquid through the liquid delivery channel 3205 is controlled by o-rings which provide a leak proof seal with the interior wall 3810′ and 3820′ of the spout 3800′ and valve core 3207. Alternatively it is conceived that an openable and closeable valve which controlled either just liquid or controlled both vapor and liquid could be configure to be mounted on a spout sealing at the tip of the spout.

The linkage means 3300 operatively connects the manually operable trigger means 3400 to the openable and closable valve means 3200. In the example shown, the linkage means 3300 comprises a first linkage arm 3301, a second linkage arm 3302 and a pusher linkage arm 3303. Linkage arms 3301 and 3302 are connected together in angularly variable relation at a linkage elbow 3304. More specifically, the pivot post 3305 on the centralized end of the second linkage arm 3302 is received into the clasp 3306 on the centralized end of the first linkage arm 3301.

Further, the first linkage arm 3301 of the linkage means 3300 is connected in angularly variable relation to the trigger handle 3401. More specifically, the first linkage arm 3301 is pivotally connected at its outer end by a linkage clasp 3307 to a first linkage pivot post 3403 on the trigger handle 3401. Additionally, the second linkage arm 3302 of the linkage means 3300 is operatively connected to the valve core 3207 of the openable and closable valve means 3200 via the pusher linkage arm 3303. More specifically, the pivot post 3308 of the second linkage arm 3302 is connected in a slider/pivotal slot connection 3309 on the pusher linkage arm 3303. Additionally, the pusher linkage arm 3303 is operatively connected at its upper end via pushing post 3310 to the movable valve core 3207 via abutting contact with rearward annular flange 3221, so as to transfer the movement of the trigger handle 3401 to the movable valve core 3207. The pusher linkage arm 3303 is pivotally connected to the nozzle body 3700 via the pivot post 3720.

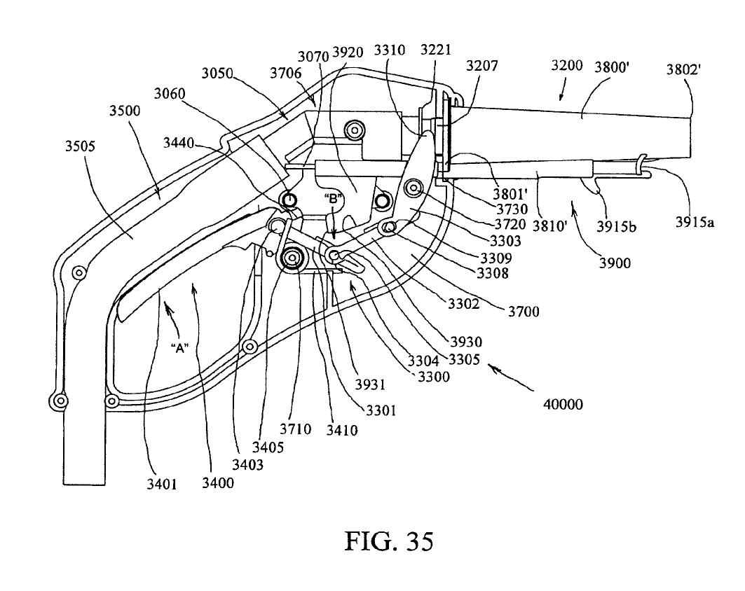

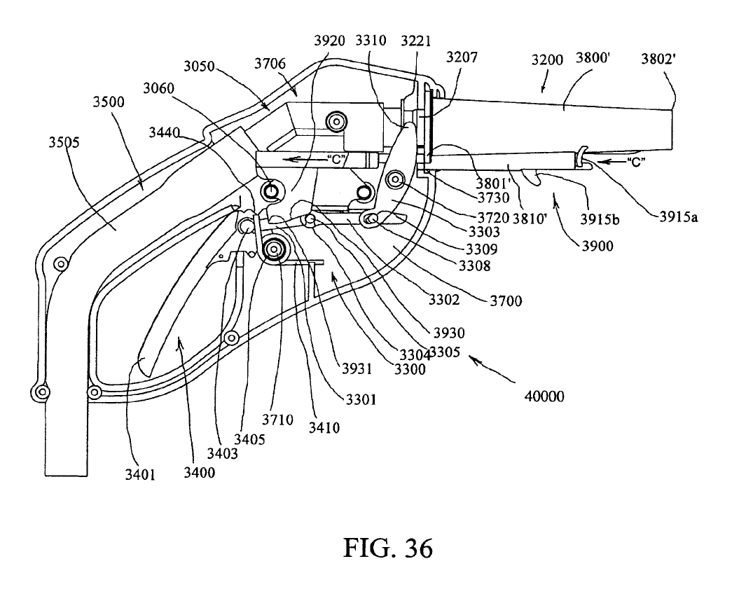

The linkage means 3300 is re-configurable by the linkage actuation means 3900 between a disable configuration, as is shown in FIG. 35, and an enable configuration, as is shown in FIG. 36, as will be discussed in greater detail subsequently.

In the enable configuration, the movable valve core 3207 is controllable via the manually operable trigger means 3400, such that the rest position of the manually operable trigger means 3400 corresponds to the valve-closed configuration of the openable and closable valve means 3200. The in-use position of the manually operable trigger means 3400 corresponds to the valve-open configuration of the openable and closable valve means 3200.

In the disable configuration, the first linkage arm 3301 and the second linkage arm 3302 can move angularly with respect to each other. Accordingly, if the trigger handle 3401 is moved into an in use position, the motion of the trigger handle 3401 will move the first linkage arm 3301 and the second linkage arm 3302 angularly with respect to each other. This motion is not passed on to the pusher linkage arm 3303 and to the rearward annular flange 3206 of the movable valve core 3207. Therefore, the manually operable trigger means 3400 is precluded from controlling the openable and closable valve means 3200. The openable and closable valve means 3200 therefore remains biased to the valve-closed configuration.

The linkage actuation means 3900 is for configuring the linkage means 3300 between the disable configuration and the enable configuration so as to allow the manually operable trigger means 3400 to operate the openable and closable valve means 3200 and the linkage actuation means 3900 is for configuring the linkage means 3300 between the enable configuration and the disable configuration to thereby precluding the openable and closable valve means 3200 from being controlled by the manually operable trigger means 3400 to its open configuration until the linkage actuation means 3900 has allowed the linkage means 3300 to be configured to its biased enable configuration.

The movable shaft member 3910 is cylindrical in shape and moves axially within the spouts co-operating cylindrical guide 3810′ between the disengaged position and the engaged position as indicated by arrow “C” wherein a biasing means 3940 in the form of a compression spring that biases the shaft member 3910 to the disengaged position such that when the shaft member 3910 is in the disengaged position, the coil spring is in compression and when the shaft member 3910 is in the engaged position, the coil spring is in greater compression.

The spill-proof nozzle 40000 may be a fluid-recovery nozzle and/or an auto-shutoff nozzle where the spout includes shaft member 3910 and linkage 3301′.

In use, spilling may result if a user inadvertently pulls the trigger on a dispensing nozzle before it has been positioned into the proper filling orientation such that the spout of the nozzle is inside the inlet opening of the destination container and yet another way in which spilling can occur is if the nozzle happens to be removed from the proper filling orientation or becomes accidentally dislodged from the proper filling orientation while the nozzle was still dispensing liquid. The linkage actuation means 3900 may provide a means wherein the user must position the nozzle in the proper filling orientation such that the spout of the nozzle is inside the inlet opening of the destination container before liquid can be dispensed and wherein the user must maintain the proper filling orientation such that the spout of the nozzle is inside the inlet opening of the destination container in order to continue dispensing liquid.

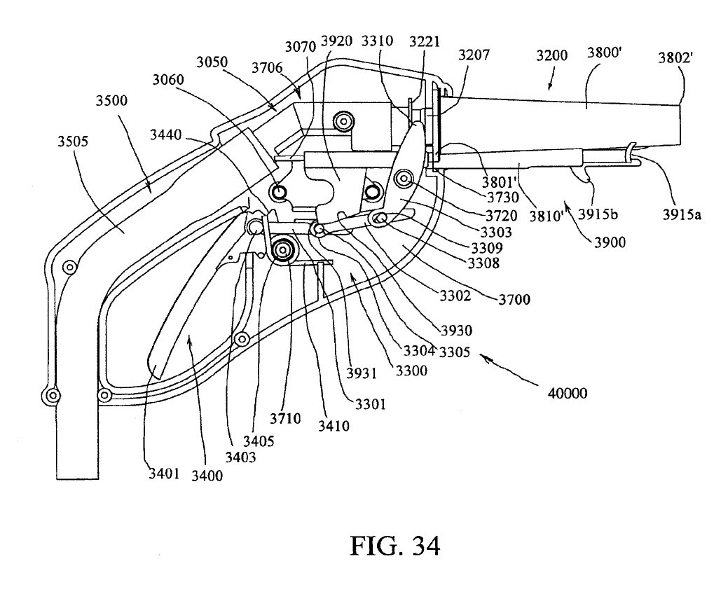

FIG. 34 shows the spill-proof nozzle 40000 at rest in its disabled configuration as the spill-proof nozzle 40000 would be when the linkage actuation means 3900 is in the disengaged state. The linkages means 3300 is disabled such that movement of the manually operable trigger 3400 would have no effect on the openable and closable valve means 3200 which would remain in its valve-closed configuration.

FIG. 35 shows the spill-proof nozzle 40000 in its disabled configuration as the spill-proof nozzle 40000 would be when the linkage actuation means 3900 is in the disengaged state except in this figure the trigger means 3400 has been moved upwardly to an in-use position, as indicated by arrow “A”. However, because the linkage actuation means 3900 is in the bias unengaged position, the linkage means 3300 is also in its disable configuration wherein this movement of the trigger means 300 will cause linkage arm 3301 and linkage arm 3302 to move angularly with respect to each other as indicated by arrow “B”. Thereby the openable and closable valve means 3200 remains in its valve-closed configuration and is precluded from being controlled by the manually operable trigger means 3400 to its valve-open configuration while the linkage means 3300 remains in its disable configuration.

FIG. 36 shows the spill-proof nozzle 40000 in its enabled configuration wherein the linkage actuation means 3900 and the engaging means 3915a & 3915b has been actuated to the engaged position, as indicated by arrow “C” allowing the linkage means 3300 to be oriented to its bias enable configuration. The linkage means 3300 is properly configured for the manually operable trigger 3400 to control the openable and closable valve means 3200 but because the manually operable trigger 3400 remains in the rest position the openable and closable valve means 3200 remains in its valve-closed configuration.

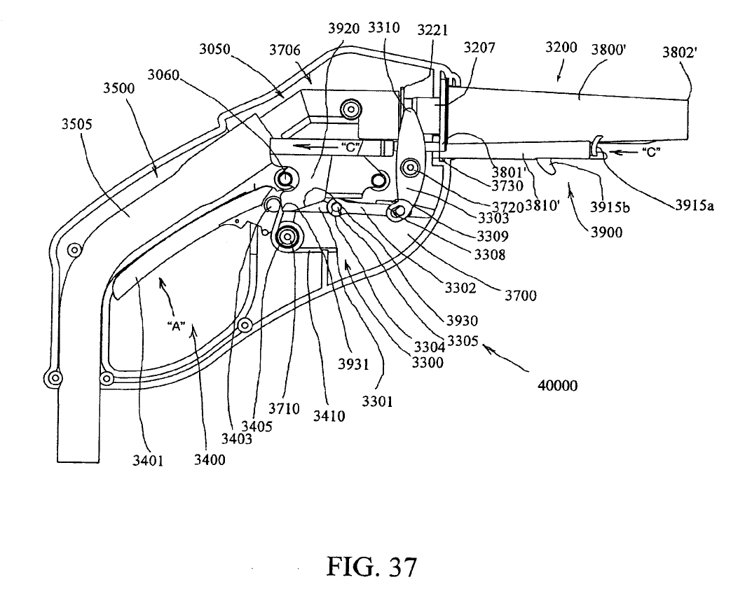

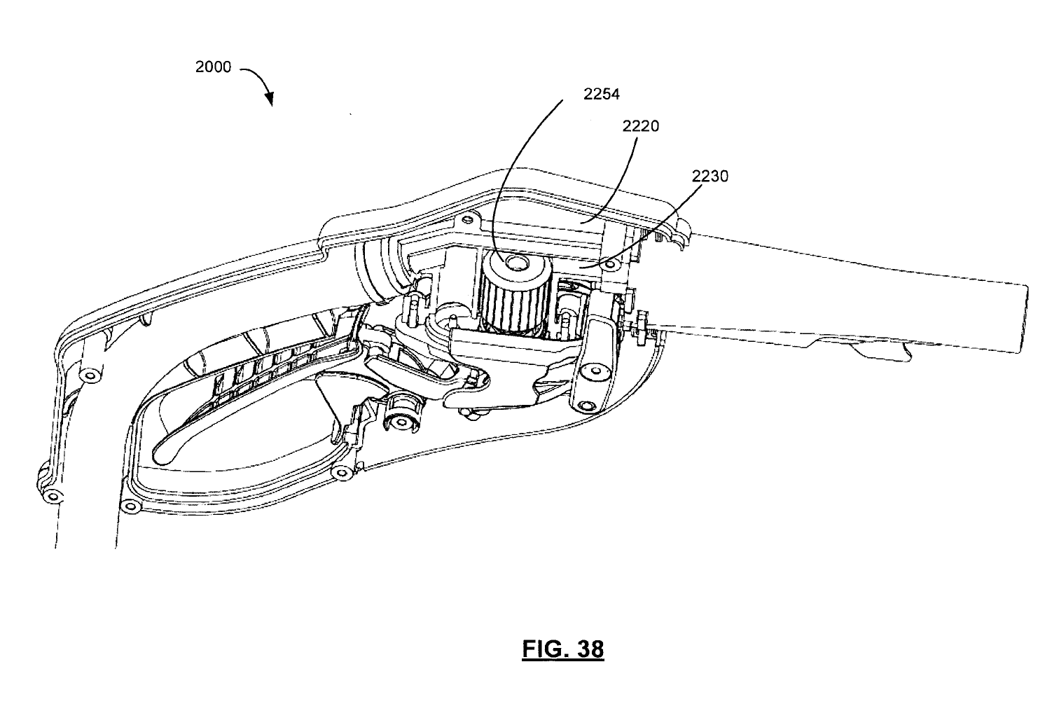

FIG. 37 shows the spill-proof nozzle 40000 in its enabled configuration wherein the openable and closable valve means 3200 is in its valve-open configuration. Here the engaging means 3915a & 3915b has been actuated to its engaged position, as indicated by arrow “C”, and the trigger handle 3401 has been moved upwardly to an in-use position, as indicated by arrow “A”. The shaft member 3910 had conveyed the movement to the linkage enabler 3920, which through its interactions with the linkage elbow 3304 had configured the linkage means 3300 to the enabled configuration thus allowing the first linkage arm 3301 to conveyed the movement of the trigger handle 3401 to the second linkage arm 3402 and on to the openable and closable valve means 3200 via the pusher linkage arm 3303 to configure the valve means 3200 to the valve-open configuration. Wherein this valve-open configuration allows liquid to pass through the liquid-delivery conduit 3706 so as to be dispensed from the liquid-dispensing outlet 3202, and therefore to be dispensed from the spill-proof nozzle 40000 to the destination container. Concurrently, fluid from the destination container would be allowed to enter the fluid-receiving inlet 3203, pass through the vapor and liquid recovery conduit 3707 to be conveyed on to the source container (not specifically shown).

Furthermore, in use, if the spill-proof nozzle 40000 was removed from the proper filling orientation, as defined above, the spill-proof nozzle 40000 would take on the overall configuration shown in FIG. 35. When the spill-proof nozzle 40000 is removed from the proper filling orientation the engaging means 3915a & 3915b will be allowed to move back to its biased unengaged position. In doing so, the angled interface 3930 on the linkage enabler 3920 will interact with the linkage elbow 3304 to configured the linkage means 3300 to the disabled configuration thus allowing linkage arm 3301 and linkage arm 3302 to moved angularly with respect to each other as indicated by arrow “B” thereby allowing the openable and closable valve means 3200 to return to its biased valve-closed configuration which precludes the manually operable trigger means 3400 from controlling the openable and closable valve means 3200 to its valve-open configuration while the linkage means 300 remains in its disable configuration.

While the present disclosure refers to positive pressure as acting on the first frontal area 352, 452, 552 for over coming the cracking pressure and unseating check valves 300, 400, 500, negative pressure in the downstream portion 306, 406, 506 may also act to unseat check valves 300, 400, 500 and maintain the plug 350, 450, 550 unseated from the seat by acting on the second frontal area 354, 454, 554. For example if check valves 300, 400, 500 were positioned between the container 20 and pump 22, 210 in fluid communication with the dispensing outlet of the container (e.g., acting in place of dispensing inlet valve 1110)

While the present disclosure refers to fuel as an example fluid, the check valve 300, 400, 500 may be used to control flow of other fluids from a pump 22, 210 including, for example, water, air, compressed gasses, or any other suitable fluid. Although certain values have been described as being suitable cracking pressures, other suitable pressure thresholds may be used as the cracking pressure, which may depend, for example, on the fluid(s) of interest and/or the condition(s) of pump operation. The present disclosure may be useful for fluid pumps, for example portable pumps, such as those used for transporting and pumping volatile fluids, where unintentional free flow of the fluid may be particularly undesirable.

In some examples, a container 200, 20 may include plastic components. For example, a major portion of the container 200, 20 may be made of plastic. This may allow the container 200, 20 to be manufactured relatively quickly and/or inexpensively, and/or may decrease the mass of the container 200, 20. This may be useful where a container 200, 20 is intended for sale to and/or use by the broad consumer market. It should be understood that a container 200, 20 may be manufacturing using a wide variety of materials including, for example, plastics, metals or any other suitable materials. The selection of suitable materials, based on such factors as desired durability, corrosion resistance, tolerances, fluid absorbance, etc., may be determined, in the context of the present disclosure.

Although the present disclosure refers to manual operation (e.g., by hand or by foot) of the actuator 220, it should be understood that other means of operating the actuator 220 may be used. For example, a mechanical or electrical device may be used to operate the actuator 220.

While the present disclosure refers to fuel as an example fluid, other fluids may be contained and pumped by a container 200, 20 including, for example, water, air, compressed or uncompressed gasses, including fuel or other vapors produced by liquid contained or pumped by the container 200, 20, or any other suitable fluid. The present disclosure may be useful for containers, for example portable containers, such as those used for transporting and pumping volatile, poisonous and/or hazardous fluids, where spilling of the fluid may be particularly undesirable.

In some examples, the present disclosure may provide for one or more of the following advantages:

Little or no manual lifting of the fluid container may be required to dispense fluid. This may lessen the physical burden on the user and allow physically impaired users or those with less strength to easily dispense fluid. Further, accidental spillage of fluid, for example due to mishandling of the container, may be reduced or prevented.

In some examples, the system may include an automated deactivation mechanism (e.g., an automatic deactivation mechanism provided in the dispenser), which may stop or prevent dispensing of fluid when a destination vessel is full or nearly full. Again, this may help to prevent or reduce accidental spillage or overflow of fluid.

In some examples, the system may provide recovery of vapors and other emissions, such as fuel vapors from the destination vessel, during dispensing of fluid. This may enable the system to be more environmentally friendly, more cost effective and/or in compliance with environmental and/or safety regulations.

The disclosed system may provide the user with at least two mechanisms for controlling (e.g., starting and stopping) the flow of fluid, for example operation of the pump using a manual actuator (e.g., a foot- or hand-operated pedal) and operation of the dispenser using a manual actuator (e.g., a trigger).

The disclosed system may provide a number of ways to stop dispensing of fluid. For example, dispensing of fluid may be stopped when a user stops actuating an actuator on the pump and/or the dispenser. The disclosed system may also include a dispenser with an auto-deactivation mechanism that is responsive to a nearly full condition in the destination vessel, which stops fluid flow in order to prevent overflow of the destination vessel. The dispenser may also include a safety mechanism that stops fluid flow when the dispenser is removed from the destination vessel.

The disclosed system may provide a number of ways to reduce or prevent unintentional dispensing or spillage of fluid. For example, the dispenser may include an auto-deactivation mechanism to help avoid spillage due to overflow of the destination vessel. The dispenser may also have fluid recovery capabilities, such that any overflow is prevented, since any excess fluid that would otherwise be dispensed into the destination vessel (and thus causing overflow of the destination vessel) is re-captured into the source container. The dispenser may also include a safety mechanism that prevents fluid flow when the dispenser is not properly inserted into the destination vessel. The pump may include check valve(s) that automatically close, to avoid unintentional free flow of fluid from the container, for example due to build up of pressure in the container (e.g., at increased temperatures) or severing of the hose.

The disclosed system may help to reduce or eliminate pollution and other hazards related to emissions of fuel vapors or other harmful chemicals. For example, the disclosed system may have vapor recovery capabilities, to help reduce vapor emissions during dispensing of fluid. The auto-deactivation mechanism, safety mechanism and fluid recovery capabilities described above may also help to reduce or eliminate overflow and/or spillage of fluid. Check valve(s) in the pump may serve to maintain most or all vapors contained within the container, and help to reduce free flow and spillage in cases of mishandling or damage to the system. The container may also serve as a vapor-tight vessel (e.g., made of materials impermeable to or resistant to permeation by liquid and vapor fuel) when not in use. For example, a barrier treatment process (e.g., fluorination, use of Hyperier™ treatment, multilayer blow molding, among others) may be used to inhibit or prevent vapor permeation through the entire system, the container and/or other system components.

The system may be designed to comply with safety and emission regulations for portable fuel containers. For example, because the check valve(s) of the container serve to keep vapors mostly or entirely contained, the container, whether coupled to the hose and dispenser or without the hose and dispenser, may emit or permeate fuel vapors at a rate in compliance with safety regulations, for example in the US current PFC's (Portable Fuel Containers) are regulated to emit or permeate fuel vapor at a rate less than or equal to 0.3 g of vapor/gallon-day (including zero, 0.1, 0.2 and values and/or ranges therebetween; which complies with 2012 California Air Resources Board (CARB) and Environmental Protection Agency (EPA) regulations) and other countries such as Canada regulations may be less strict, for example CSA (Canadian Standards Association) may regulate PFC's to emit or permeate fuel vapor at a rate less than or equal to 3.0 g/g/d which complies with 2012 Canadian regulations. Hence the subject system may comply with one or more of these regulatory requirements, including complying with intermediate values within the regulatory range (e.g., 1 g/g/d, 2 g/g/d, and values and/or ranges therebetween for Canada). A system may be required to comply with safety and emission regulations based on alternative test methods or future environmental standards for PRS's (Portable Refueling Systems that may include a container, pump(s), hose(s) and a dispenser). These regulations may permitted systems to emit or permeate more than the regulate rate as required for PFC's (e.g., more than the US requirement of 0.3 g/g/d) due to additional pollution control features and prevention measures that a PRS may include. Countries may regulate PRS's differently and may require that a system emit or permeate fuel vapor at a rate less than or equal to 5.0 g/g/d to 3.0 g/g/d such as may be required by Canada or may require a rate less than or equal to 1.0 g/g/d to 0.3 g/g/d such as may be required in the USA with similar future goals of driving requirements down over time as is done with PFC's. The container 200, 20 may be in compliance with emission and safety regulations for manually portable containers (e.g., governing containers having a volume of 10 gallons or less). The system may also comply with other regulations (e.g., those related to safety and/or ergonomics), for example the system may weigh a total of 50 lbs or less when filled with fuel.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1.-101. (canceled)

102. A portable dispensing container comprising:
a container for containing liquid, the container including at least one opening;
a device in fluid communication with the at least one opening for controlling the flow of liquid through the at least one opening, the device comprising:
a body with at least one through passage including an upstream portion for receiving liquid and a downstream portion for delivering liquid;
a plug biased against a seat in the body, the plug precluding the flow of liquid from the upstream portion to the downstream portion when the plug is seated against the seat, the plug including a first frontal area and a second frontal area, the first frontal area being smaller than the second frontal area;
wherein, when the plug is seated against the seat, force caused by pressure in the body acts on the first frontal area;
wherein, when the plug is unseated from the seat, forces caused by pressures in the body act on the second frontal area; and
wherein a first pressure applied to the first frontal area sufficient to unseat the plug from the seat is greater than a second pressure applied to the second frontal area sufficient to maintain the plug unseated from the seat.

103. The portable dispensing container of claim 102, wherein when the container contains a volatile liquid and the first pressure required to unseat the plug from the seat is equal to or greater than the vapor pressure caused by the volatile liquid contained within the container.

104. The portable dispensing container of claim 102, wherein the first pressure required to unseat the plug from the seat is between 5 psi and 20 psi.

105. The portable dispensing container of claim 102, comprising at least one hose with at least one through passage in fluid communication with the device for conveying liquid from the container.

106. The portable dispensing container of claim 105, wherein the hose comprises a second through passage in fluid communication with the container for conveying a recovered fluid to the container.

107. The portable dispensing container of claim 105, comprising a second hose in fluid communication with the container for conveying a recovered fluid to the container.

108. The portable dispensing container of claim 102, comprising a pump for pumping at least one fluid wherein the pump is in fluid communication with the device wherein the pump affects the pressure within the body to unseat the plug from its seat when the pump is pumping.

109. The portable dispensing container of claim 108, comprising at least one hose with at least one through passage in fluid communication with the device for conveying liquid from the container.

110. The portable dispensing container of claim 109, comprising a dispenser for at least one of dispensing liquid and recovering fluid wherein the dispenser is in fluid communication with the at least one hose for receiving liquid from the at least one hose and conveying the liquid to a destination.

111. The portable dispensing container of claim 110, wherein the at least one hose comprises a second through passage in fluid communication with the container for conveying recovered fluid to the container wherein the dispenser receives recovered fluid from the destination and conveys the recovered fluid to the second through passage.

112. The portable dispensing container of claim 110, comprising a second hose in fluid communication with the container for conveying recovered fluid to the container wherein the dispenser receives recovered fluid from the destination and conveys the recovered fluid to the second hose.

113. The portable dispensing container of claim 110, wherein, when the container is filled with liquid, the container, the pump, the hose and the dispenser have a total weight equal to or less than 50 lbs.

114. The portable dispensing container of claim 110, wherein the dispenser further comprises a fluid delivery valve in fluid communication with the hose for controlling the flow of fluid through the hose.

115. The portable dispensing container of claim 112, wherein the dispenser further comprises a fluid recovery valve in fluid communication with the second hose for controlling the flow of recovered fluid through the second hose.

116. A portable dispensing container comprising:
a container for containing liquid, the container including at least one opening;
a liquid delivery hose in fluid communication with the container for conveying liquid from the container;
a fluid recovery hose in fluid communication with the container for conveying recovered fluid to the container; and
at least one device in fluid communication with at least one of the liquid delivery hose and the fluid recovery hose, the device comprising a plurality of fluid channels wherein each fluid channel is sized to inhibit propagation of a flame through the fluid channel.

117. The portable dispensing container of claim 116, comprising a dispenser for dispensing liquid and recovering fluid wherein:
the dispenser is in fluid communication with the liquid delivery hose for receiving liquid from the liquid delivery hose and conveying the liquid to a destination; and
the dispenser is in fluid communication with the fluid recovery hose for conveying fluid from the destination to the fluid recovery hose.

118. The portable dispensing container of claim 117, wherein the dispenser comprises a fluid delivery valve in fluid communication with the liquid delivery hose for controlling the flow of liquid through the liquid delivery hose.

119. The portable dispensing container of claim 118, wherein the dispenser comprises a fluid recovery valve in fluid communication with the fluid recovery hose for controlling the flow of recovered fluid through the fluid recovery hose.

120. The portable dispensing container of claim 116, comprising a pump for pumping at least one of liquid from the container and recovered fluid to the container wherein the pump is in fluid communication with the liquid delivery hose to pump liquid out of the container when the pump is pumping.

121. The portable dispensing container of claim 120, wherein the pump is in fluid communication with the fluid recovery hose to pump recovered fluid to the container when the pump is pumping.
